(19) United States
(12) Patent Application Publication
(10) Pub. No.: US 2023/0096817 A1
(43) Pub. Date: Mar. 30, 2023

(54) MIST DEVICE, AND WATER SECTION EQUIPMENT PROVIDED WITH THE SAME

(71) Applicant: TOTO LTD., Kitakyushu-shi (JP)

(72) Inventors: Keita SAITO, Kitakyushu-shi (JP); Toshiharu OE, Kitakyushu-shi (JP); Tatsunari HARASHIMA, Kitakyushu-shi (JP); Genta KAWASE, Kitakyushu-shi (JP); Yohei IKARI, Kitakyushu-shi (JP); Aiko MAKI, Kitakyushu-shi (JP)

(21) Appl. No.: 17/954,499

(22) Filed: Sep. 28, 2022

(30) Foreign Application Priority Data
Sep. 30, 2021 (JP) 2021-160613
Sep. 30, 2021 (JP) 2021-160614

(51) Int. Cl. A47K 3/00; B05B 17/06

(52) U.S. Cl. CPC A47K 3/001; B05B 17/0615

(57) ABSTRACT

Provided is a mist device capable of suppressing a decrease in amount of mist generated to be retained in a retaining space. A mist device 1 of the present invention includes a mist generation unit 8 that generates mist from stored water, and a mist supply unit 10 that supplies the mist generated by the mist generation unit to a retaining part that forms a retaining space having an upper part opened, the mist device is configured so that the mist supplied from the mist supply unit is retained in a retaining space 4, and the mist generation unit 8 includes a mist supply flow rate decrease suppression part 40 that suppresses a decrease in amount of mist generated.

### BACKGROUND OF THE INVENTION

### Field of the Invention

The present invention relates to a mist device, and in particular to a mist device for use in water section equipment.

### Description of the Related Art

Conventionally, as described in Patent Literature 1, a bathtub sauna apparatus for providing a sauna bath has been known. Such a bathtub sauna apparatus includes a bathtub lid provided at a top of a bathtub body to form a sauna space with mist.

### CITATION LIST

### Patent Literature

[Patent Literature 1] Japanese Patent Laid-Open No. 2008-018130

However, a problem with such a bathtub sauna apparatus as described in Patent Literature 1 is that, since the bathtub lid is necessary for forming the sauna space, the position of a user is so constrained that user comfort is impaired and it is less convenient for the user.

In this connection, the inventors of the present invention have made intensive research to remove the bathtub lid and to retain mist in the bathtub body having an upper part opened.

However, even if mist can be retained in the bathtub body, another problem is that the bathtub body cannot be maintained in a state where mist is retained therein, due to a decrease in amount of mist supplied to the bathtub body.

Therefore, an object of the present invention, which has been made to solve the above-described conventional technical problems, is to provide a mist device capable of suppressing a decrease in amount of mist generated to be retained in a retaining space.

### SUMMARY OF THE INVENTION

To achieve the above-described object, one embodiment of the present invention provides a mist device for use in water section equipment, the mist device including a mist generation unit that generates mist from stored water, and a mist supply unit that supplies the mist generated by the mist generation unit to a retaining part that forms a retaining space having an upper part opened, the mist device is configured so that the mist supplied from the mist supply unit is retained in the retaining space, and the mist generation unit includes a mist supply flow rate decrease suppression part that suppresses a decrease in amount of mist generated.

In the embodiment of the present invention including this configuration, the mist generation unit includes the mist supply flow rate decrease suppression part that suppresses the decrease in amount of mist generated. Thereby, the decrease in amount of mist generated to be retained in the retaining space can be suppressed, and the retaining space can be easily maintained in a state where the mist is retained therein.

In one embodiment of the present invention, preferably, the mist generation unit includes a water storage part that stores water, and an ultrasonic vibrator that oscillates ultrasonic waves to the water in the water storage part, to generate mist, and the mist generation unit further includes a heater that functions as the mist supply flow rate decrease suppression part to suppress a drop in temperature of the water in the water storage part.

In the embodiment of the present invention including this configuration, the mist generation unit includes, as the mist supply flow rate decrease suppression part, the heater that suppresses the drop in temperature of the water in the water storage part. Thereby, the drop in temperature of water in the water storage part can be suppressed, and the decrease in amount of mist generated from water in the water storage part can be suppressed. Therefore, the decrease in amount of mist generated can be suppressed, and the decrease in amount of mist supplied can be suppressed, so that the retaining space can be easily maintained in the state where mist is retained therein. If the temperature of water in the water storage part drops, for the same output of the ultrasonic vibrator, the amount of mist generated from water in the water storage part decreases, and the amount of mist supplied to the retaining space decreases, which makes it difficult to maintain the retaining space in the state where mist is retained therein. This situation can be suppressed according to the configuration of the present embodiment.

In one embodiment of the present invention, preferably, the mist generation unit includes a wall part provided between a mist generation side part in which the ultrasonic vibrator is disposed in the water storage part and a water supply side part to which a water supply passage that supplies water into the water storage part is connected, the wall part being configured to communicate water between the mist generation side part and the water supply side part, the wall part functioning as the mist supply flow rate decrease suppression part, the wall part being formed so that rippling due to the water supplied to the water supply side part is less likely to be transmitted to the mist generation side part.

In the embodiment of the present invention including this configuration, the wall part is formed so that the rippling due to the water supplied to the water supply side part is less likely to be transmitted to the mist generation side part. Thereby, the rippling due to the water supplied to the water supply side part can be less likely to be transmitted to the mist generation side part, and it is possible to suppress the decrease in amount of mist generated from water in the mist generation side part due to disturbance of a water surface in the mist generation side part. Also, the wall part can inhibit the rippling from being easily transmitted to the mist generation side part and inhibit the temperature of water supplied to the water supply side part from being easily transmitted to the mist generation side part, and hence the wall part can suppress the drop in temperature of water in the mist generation side part and further suppress the decrease in amount of mist generated from water in the water storage part. Therefore, the decrease in amount of mist generated can be further suppressed, and the decrease in amount of mist supplied can be further suppressed, so that the retaining space can be easily maintained in the state where mist is retained therein.

In one embodiment of the present invention, preferably, the wall part of the mist generation unit is provided at a position at which a volume of water in the mist generation side part is larger than a volume of water in the water supply side part, when the water level in the water storage part is at a water supply prescribed water level.

In the embodiment of the present invention including this configuration, the volume of the water up to the water supply prescribed water level in the mist generation side part is larger than the volume of the water up to the water supply prescribed water level in the water supply side part. Consequently, the water in the mist generation side part can be hardly affected by the drop in temperature of the water in the mist generation side part due to cooling of the water in the mist generation side part with the generation of the mist in the mist generation side part. Also, if water at a relatively low temperature is supplied to the water supply side part during the water supply, the water in the mist generation side part can be hardly cooled, and the water in the mist generation side part can be hardly affected by the drop in temperature.

In one embodiment of the present invention, preferably, the heater of the mist generation unit is provided in at least the mist generation side part.

In the embodiment of the present invention including this configuration, the heater of the mist generation unit is provided in at least the mist generation side part. Thereby, it is possible to easily suppress the drop in temperature of the water in the mist generation side part due to the cooling of the water in the mist generation side part with the generation of the mist in the mist generation side part.

In one embodiment of the present invention, preferably, the heater of the mist generation unit extends from the mist generation side part to the water supply side part.

In the embodiment of the present invention including this configuration, the heater of the mist generation unit extends from the mist generation side part to the water supply side part. Thereby, the water supplied to the water supply side part during the water supply can be heated from the water supply side part by the heater. Therefore, the water in the mist generation side part can be hardly cooled by the water supplied to the water supply side part during the water supply, and the water in the mist generation side part can be hardly affected by the drop in temperature.

In one embodiment of the present invention, preferably, a plurality of ultrasonic vibrators are arranged, and the heater extends in an arrangement direction of the plurality of ultrasonic vibrators.

In the embodiment of the present invention including this configuration, the plurality of ultrasonic vibrators are arranged, and the heater extends in the arrangement direction of the plurality of ultrasonic vibrators. This can reduce unevenness in temperature of water around the plurality of ultrasonic vibrators in the mist generation side part. Therefore, the temperature of the water in the mist generation side part can be entirely raised, and a mist generation efficiency can be increased.

In one embodiment of the present invention, preferably, the mist generation unit includes a wall part provided between a mist generation side part in which an ultrasonic vibrator is disposed in a water storage part and a water supply side part in which a water supply device that supplies water into the water storage part is disposed, the wall part being configured to communicate water between the mist generation side part and the water supply side part, the wall part functioning as the mist supply flow rate decrease suppression part, the wall part being formed so that rippling due to water supplied to the water supply side part is less likely to be transmitted to the mist generation side part.

In the embodiment of the present invention including this configuration, the wall part is formed so that the rippling due to the water supplied to the water supply side part is less likely to be transmitted to the mist generation side part. Thereby, the rippling due to the water supplied to the water supply side part can be less likely to be transmitted to the mist generation side part, and it is possible to suppress the decrease in amount of the mist generated from the water in the mist generation side part due to disturbance of a water surface in the mist generation side part. Therefore, the decrease in amount of the mist generated can be further suppressed, and the decrease in amount of the mist supplied can be further suppressed, so that the retaining space can be easily maintained in the state where the mist is retained therein.

One embodiment of the present invention provides water section equipment, and the equipment includes the mist device of the embodiment of the present invention, and the retaining part that forms the retaining space accepting mist supplied from the mist supply unit of the mist device.

In one embodiment of the present invention, preferably, the mist device includes a water storage part provided in the mist generation unit, to store water to be misted, a water supply valve that controls supply and stop of water to the water storage part, an ultrasonic vibrator provided in the water storage part, the ultrasonic vibrator irradiating, with ultrasonic waves, a water surface of water stored in the water storage part, to generate mist, and a controller that controls the water supply valve and the ultrasonic vibrator, the mist generation unit includes an overflow portion, the overflow portion further functions as the mist supply flow rate decrease suppression part, and the controller controls the water supply valve so that water introduced through the water supply valve flows out from the overflow portion, to thereby set a water level in the water storage part to an overflow water level.

In one embodiment of the present invention, preferably, the controller maintains the water level in the water storage part at the overflow water level for a predetermined period of time, by keeping water flowing out from the overflow portion for the predetermined period of time, in a state where the ultrasonic vibrator is operated to generate mist in the mist generation unit.

In one embodiment of the present invention, preferably, the controller opens the water supply valve, to control water to flow out from the overflow portion, at a time of activation of the ultrasonic vibrator, or before the activation of the ultrasonic vibrator.

In one embodiment of the present invention, preferably, the controller is configured to execute overflow control to keep water flowing out from the overflow portion, and maintenance control to maintain the water level in the water storage part in a predetermined range from the overflow water level to a water level less than the overflow level, and the controller executes the overflow control for a predetermined period of time in a state where the ultrasonic vibrator is operated, and then executes the maintenance control.

In one embodiment of the present invention, preferably, the mist device further includes a water level sensor that detects a water level in the water storage part, and in the maintenance control, the controller opens the water supply valve for a predetermined time, to raise the water level in the water storage part, when the water level sensor detects that the water level in the water storage part lowers to a predetermined water level.

In one embodiment of the present invention, preferably, the controller is configured to set a preparation mode, and when the preparation mode is set, the controller opens the water supply valve in a state where the ultrasonic vibrator is not operated, controls water to flow out from the overflow portion and sets the water level in the water storage part to an overflow water level.

One embodiment of the present invention preferably includes water section equipment including a retaining space in which mist discharged from this mist device is retained.

According to the mist device of the present invention, a decrease in amount of mist generated to be retained in a retaining space can be suppressed.

### BRIEF DESCRIPTION OF THE DRAWINGS

FIG. 1 is a schematic perspective view of a mist system including a mist device according to a first embodiment of the present invention;

FIG. 2 is a schematic configuration diagram of the mist system including the mist device according to the first embodiment of the present invention;

FIG. 3 is a schematic cross-sectional view of the mist system including the mist device according to the first embodiment of the present invention, cut along a long side direction of a bathtub body;

FIG. 4 is a schematic configuration diagram showing an internal configuration of the mist device according to the first embodiment of the present invention;

FIG. 5 is a block diagram showing the internal configuration of the mist device according to the first embodiment of the present invention;

FIG. 6 is a perspective view showing a mist generation unit, a water supply passage and the like of the mist device according to the first embodiment of the present invention;

FIG. 7 is a perspective view of an internal structure on an inner side of a cross section cut along the VII-VII line in FIG. 6 as seen obliquely from above;

FIG. 8 is a cross-sectional view along the VII-VII line of FIG. 6;

FIG. 9 is a cross-sectional view along the IX-IX line of FIG. 6;

FIG. 10 is a perspective view of an internal structure on an inner side of a cross section cut along the X-X line in FIG. 8 as seen obliquely from above;

FIG. 11 is a picture for explaining an operation of supplying mist from the mist device according to the first embodiment of the present invention;

FIG. 12 is a picture for explaining the operation of supplying mist from the mist device according to the first embodiment of the present invention;

FIG. 13 is a picture for explaining the operation of supplying mist from the mist device according to the first embodiment of the present invention;

FIG. 14 is a picture for explaining the operation of supplying mist from the mist device according to the first embodiment of the present invention;

FIG. 15 is a picture for explaining the operation of supplying mist from the mist device according to the first embodiment of the present invention;

FIG. 16 is a view for explaining an operation of a mist generation unit of the mist device according to the first embodiment of the present invention;

FIG. 17 is a view for explaining the operation of the mist generation unit of the mist device according to the first embodiment of the present invention;

FIG. 18 is a view for explaining the operation of the mist generation unit of the mist device according to the first embodiment of the present invention;

FIG. 19 is a view for explaining the operation of the mist generation unit of the mist device according to the first embodiment of the present invention;

FIG. 20 is a view for explaining the operation of the mist generation unit of the mist device according to the first embodiment of the present invention;

FIG. 21 is a view for explaining the operation of the mist generation unit of the mist device according to the first embodiment of the present invention;

FIG. 22 is a view for explaining the operation of the mist generation unit of the mist device according to the first embodiment of the present invention;

FIG. 23 is a graph showing whether or not a retained state is formed in a retaining space, related to a temperature difference between a water temperature in a bathtub body and a room temperature in a bathroom and a supply flow rate of mist, in the mist system including the mist device according to the first embodiment of the present invention;

FIG. 24 is a graph showing whether or not the retained state is formed in the retaining space, related to the temperature difference between the water temperature in the bathtub body and the room temperature in the bathroom and the supply flow rate of mist, in the mist system including the mist device according to the first embodiment of the present invention;

FIG. 25 is a view for explaining a method of measuring an ambient temperature of mist in the mist system including the mist device according to the first embodiment of the present invention, a method of measuring a water temperature and a method of measuring a room temperature in the bathroom;

FIG. 26 is a view for explaining a measuring device and a measuring method of a flow rate of mist in the mist system including the mist device according to the first embodiment of the present invention;

FIG. 27 is a perspective view of a measuring device of a particle size of mist in the mist system including the mist device according to the first embodiment of the present invention;

FIG. 28 is a top view of the measuring device of the particle size of the mist supplied from a mist supply unit of the mist device according to the first embodiment of the present invention;

FIG. 29 is a graph showing an example of particle size distribution data obtained by measuring, with a particle size distribution measuring device, particle sizes of the mist supplied from the mist supply unit of the mist device according to the first embodiment of the present invention;

FIG. 30 is a view showing a measuring device of a transmittance for use in determining whether or not the mist supplied from the mist supply unit of the mist device according to the first embodiment of the present invention is retained in the bathtub body;

FIG. 31 is a perspective view of a wash place floor apparatus including a mist device according to a second embodiment of the present invention;

FIG. 32 is a perspective view of a shower room apparatus including a mist device according to a third embodiment of the present invention;

FIG. 33 is a perspective view of a washbasin apparatus including a mist device according to a fourth embodiment of the present invention;

FIG. 34 is a perspective view of a kitchen sink apparatus including a mist device according to a fifth embodiment of the present invention;

FIG. 35 is a picture showing a behavior after start of discharge of mist until the mist is retained in an entire mist retaining space in the mist device according to the first embodiment of the present invention;

FIG. 36 is a diagram showing a method of measuring a mist temperature and a room temperature before start of mist supply in the mist device according to the first embodiment of the present invention;

FIG. 37 is a diagram showing a method of measuring the mist temperature and the room temperature before the start of mist supply in the mist device according to the first embodiment of the present invention;

FIG. 38 is a diagram showing a method of measuring the mist temperature and the room temperature before the start of mist supply in the mist device according to the first embodiment of the present invention;

FIG. 39 is a graph showing an example of measurement results of the mist temperature according to the mist device of the first embodiment of the present invention;

FIG. 40 is a graph showing a range of a temperature difference between the temperature of mist supplied from the mist supply unit to the mist retaining space and a temperature in a room where water section equipment is used before the start of the mist supply in the mist device according to the first embodiment of the present invention;

FIG. 41 is a graph for explaining a relation between the temperature difference and the particle size in the mist device according to the first embodiment of the present invention;

FIG. 42 is a view showing a box-shaped observation device for observing a state in a virtual retaining space in the mist device according to the first embodiment of the present invention;

FIG. 43 shows, by comparison, states of the mist in the virtual retaining space, as to a combination of the temperature difference in the mist device according to the first embodiment of the present invention and Sauter mean particle size;

FIG. 44 is a longitudinal cross-sectional view of a mist generation unit and a mist discharge passage in a mist device according to a sixth embodiment of the present invention;

FIG. 45 is a perspective cross-sectional view of the mist generation unit and the mist discharge passage in the mist device according to the sixth embodiment of the present invention;

FIG. 46 is a perspective view showing the mist generation unit in a state where a mist supply unit is removed from the mist device according to the sixth embodiment of the present invention;

FIG. 47 is a perspective cross-sectional view showing an internal structure of the mist generation unit of the mist device according to the sixth embodiment of the present invention;

FIG. 48 is a perspective cross-sectional view of the mist generation unit and the mist discharge passage in the mist device according to the sixth embodiment of the present invention as seen obliquely from below;

FIG. 49 is a flowchart showing a control procedure by a controller in the mist device according to the sixth embodiment of the present invention; and

FIG. 50 shows states in a tank in time series in the mist device according to the sixth embodiment of the present invention.

### DETAILED DESCRIPTION OF THE PREFERRED EMBODIMENTS

Hereinafter, embodiments of the present invention disclosed herein will be described in detail with reference to the drawings. From the following description, many improvements and other embodiments of the present invention will be apparent to those skilled in the art. Accordingly, the following description should be construed only as illustrative and is provided for a purpose of teaching those skilled in the art the best mode to execute the present invention. Details of a structure and/or a function of the present invention can be substantially changed without departing from the spirit of the present invention.

Hereinafter, description will be made as to a mist system that is water receiving equipment including a mist device according to a first embodiment of the present invention with reference to the attached drawings.

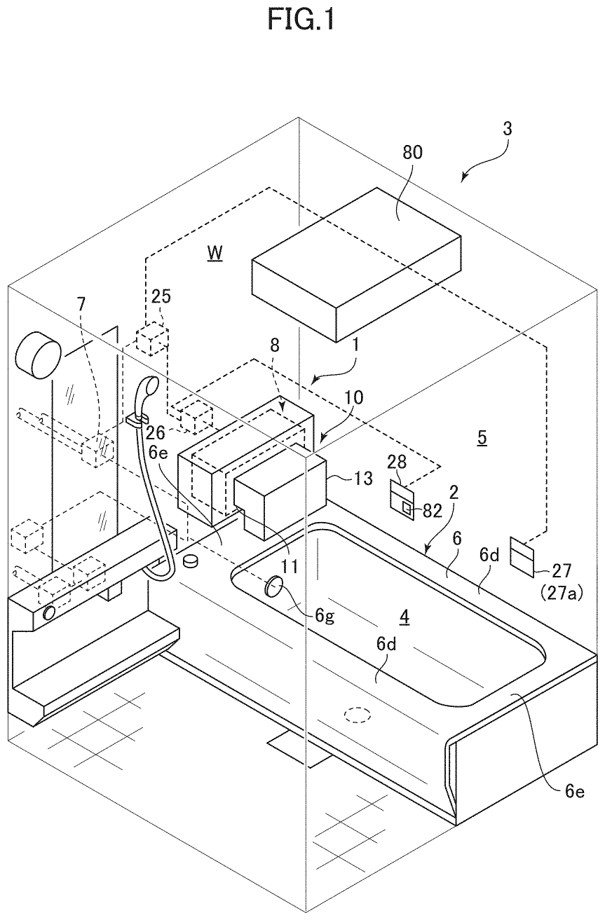

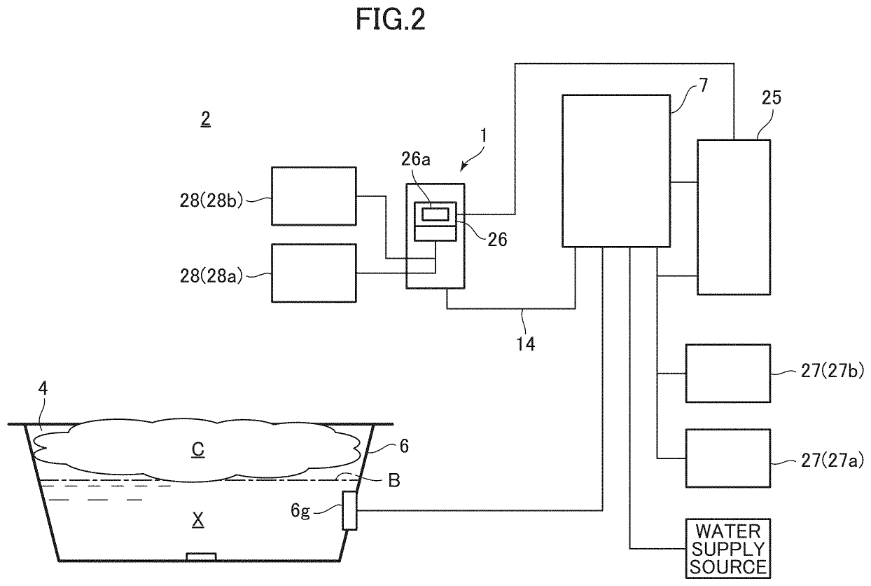

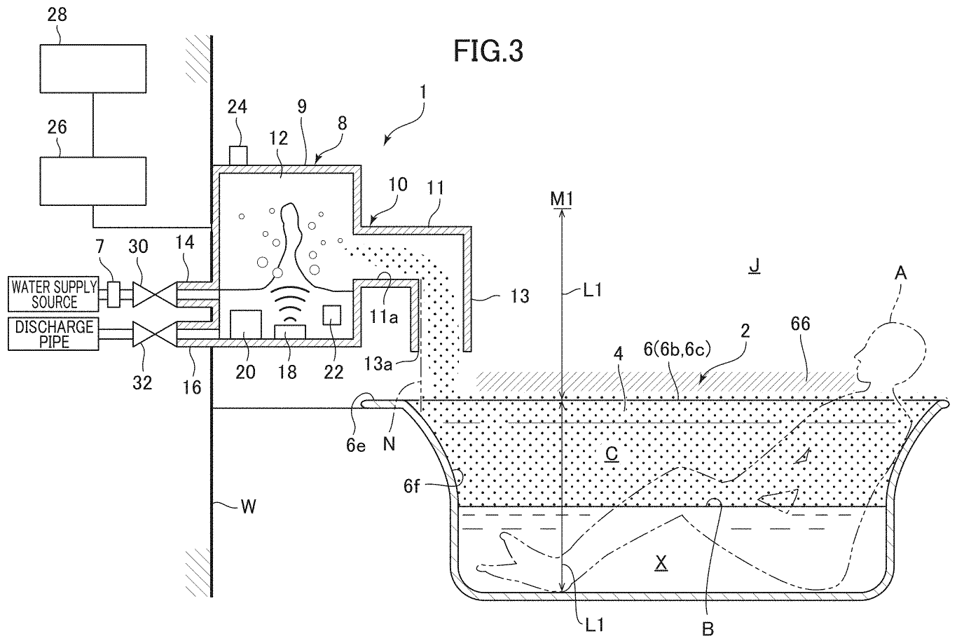

FIG. 1 is a schematic perspective view of the mist system including the mist device according to the first embodiment of the present invention, FIG. 2 is a schematic configuration diagram of the mist system including the mist device according to the first embodiment of the present invention, and FIG. 3 is a schematic cross-sectional view of the mist system including the mist device according to the first embodiment of the present invention, cut along a long side direction of a bathtub body.

As shown in FIGS. 1 and 2, a mist system 2 that is water section equipment including a mist device 1 according to the first embodiment of the present invention is provided in a bathroom 3. The mist system 2 functions as the water receiving equipment including a water receiving part that receives discharged water. Also, the mist system 2 is so-called water section equipment for use as equipment in a place where water is used. The water section equipment (water receiving equipment) is equipment including the water receiving part that receives the discharged water in the bathroom, a wash place floor in the bathroom, a shower room, a toilet, handwash equipment, a washstand, a kitchen or the like. Note that in the present embodiment, a combination of the mist device 1 and the mist system 2 functions as a mist generation system.

The mist device 1 is a mist device for use in a bathtub body of the water receiving equipment, the wash place floor in the bathroom, the shower room, a handwash bowl, a washstand bowl, a kitchen sink or the like. The bathroom 3 is a box-shaped space and forms a room space 5 that is sealed to a certain extent to use water inside. Water includes water having a temperature higher than an outside temperature (normal temperature) and heated water (so-called hot water). The mist system 2 includes a bathtub body 6 that forms a retaining space 4 accepting mist supplied from an after-mentioned mist supply unit in the mist device 1. The mist system 2 includes a supply device 7 that supplies water. As described later, the mist system 2 includes a configuration in the bathtub body 6 in which a hot water layer X (see FIG. 2) heated above room temperature is formed, and a mist retention layer C including heated mist is formed above the hot water layer in the retaining space 4. The bathroom 3 is not limited to a room where only the bathtub body 6 is disposed, and may include the toilet, the handwash equipment, the washstand or a combination thereof.

The bathtub body 6 forms the retaining space 4 having an upper part opened toward the room space 5 in which the bathtub body 6 of the mist system 2 is disposed. The bathtub body 6 is a bathtub and can store water in the retaining space 4 inside. The bathtub body 6 is formed into a rectangular shape in a top view and includes a long side part 6d formed on a long side of the rectangular shape, and a short side part 6e formed on a short side. In the short side part 6e, a width of the bathtub is shorter than in the long side part 6d. A short side wall 6f (see FIG. 3) facing a mist supply unit 10 of the bathtub body 6 is formed with an upper part inclined outward. The bathtub body 6 has a volume in a range of, for example, 200 L to 500 L. For example, the bathtub body 6 has a volume of 300 L, the hot water layer X of the bathtub body 6 has a volume of 130 L, and the retaining space 4 has a volume of 170 L (for example, 300 L when water is not stored).

The retaining space 4 is a space formed into a generally rectangular parallelepiped shape inside the bathtub body 6. As shown in FIG. 3, when a user A takes a bath, water at 34° C. to 45° C. is stored on a lower side in the retaining space 4 (hot water layer X is formed), and the user A can soak in bath in a seated state. As will be described later, in FIG. 3, mist is retained above water B in the retaining space 4 (in a state where the mist retention layer C is formed). The retaining space 4 is formed up to an upper end portion 6a of the bathtub body 6 and has a top surface side opened. In the bathtub body 6, mist is retained in the retaining space 4 as described later, in a state where such a lid as covering a top surface of the retaining space 4 is not disposed. Alternatively, mist may be retained without storing the water B in the retaining space 4. A shape of the bathtub body 6 is not limited to the box shape as in the embodiment and may be any shape that can form the retaining space. For example, the bathtub body 6 may be formed into a circular or elliptic shape in a top view, and inside the bathtub body, a bowl-shaped retaining space may be formed. The bathtub body 6 may have a bottom surface formed obliquely so that the user can take a posture close to a sleeping posture or a seated posture, and a stepped portion or no stepped portion may be formed in the bottom surface. The bathtub body 6 has a top portion of a wall part that does not have to be formed horizontally at a certain height and that may be formed to change in height. For example, the top portion of the wall part of the bathtub body 6 may be formed into a shape extending diagonally upward or downward in a side view, an arcuately extending shape partially recessed downward, or an uneven shape that forms an almost right angle. The mist system 2 is configured to retain, in the retaining space 4, the mist supplied from the mist supply unit.

The supply device 7 is a supply device that supplies water to the bathtub body 6, a faucet apparatus on a wash place side and the like. The supply device 7 is, for example, a water heater and can supply unheated water supplied from a supply source such as a water supply, or heated water (so-called hot water). The supply device 7 is connected to a water supply port 6g formed in the bathtub body 6 and is configured to supply water through the water supply port 6g into the bathtub body 6. The supply device 7 is also connected to the mist device 1 via a water supply channel 14 and can supply water also to the mist device 1. Alternatively, the mist device 1 may be connected directly to a water supply source such as the water supply via no supply device 7. Furthermore, the mist device 1 may be connected to both the supply device 7 and the water supply source. To the supply device 7, water is supplied from a water supply source such as the water supply. The supply device 7 is electrically connected to a water supply controller 25. The supply device 7 of the present embodiment has a function of a reheating device that takes water from the bathtub body 6 through the water supply port 6g as a water intake, heats this water and returns the water into the bathtub body 6. The reheating device reheats water already stored in the bathtub body 6. Alternatively, the supply device 7 does not have to have the function of the reheating device. Although the supply device 7 supplies water through the water supply port 6g into the bathtub body 6, as a modification, the supply device 7 may be connected to the faucet apparatus provided in the bathtub body 6 for supplying water into the bathtub body, and this faucet apparatus may supply water into the bathtub body 6. Alternatively, the faucet apparatus for supplying water into the bathtub body 6 may be connected directly to the water supply source via no supply device 7. Furthermore, the faucet apparatus may be connected to both the supply device 7 and the water supply source.

Next, the mist device according to the first embodiment of the present invention described above will be described in more detail with reference to FIGS. 1 to 5.

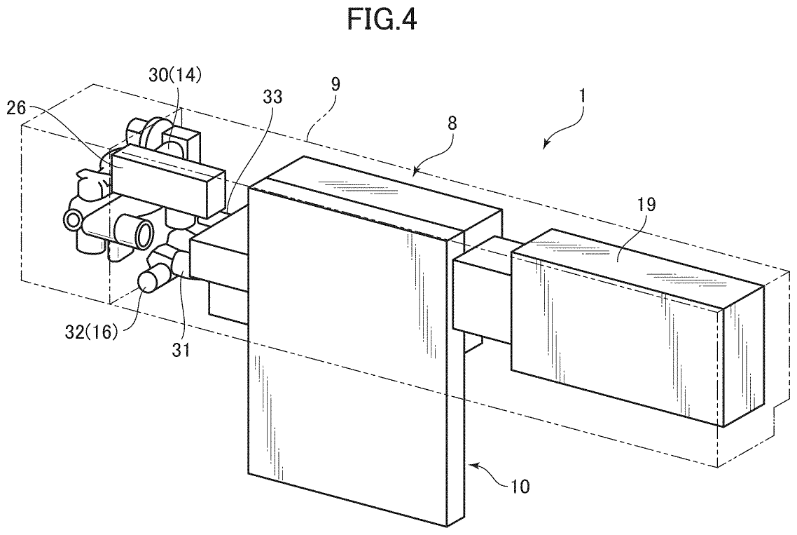

The mist system 2 includes the mist device 1. As shown in FIG. 3, the mist device 1 includes a mist generation unit 8 that generates mist from stored water, the mist supply unit 10 that supplies mist into the bathtub body 6, a bathroom air conditioner 80 (see FIG. 1) capable of sending out hot or cold air so as to adjust the room temperature in the bathroom 3, a mist device operation unit 28 that accepts an operation input of the user, and a mist device controller 26 that controls the generation of mist in the mist generation unit 8 and the supply of mist by the mist supply unit 10. The mist device 1 includes an oblong box-shaped casing 9 (see FIG. 4) in which the mist generation unit 8 is provided, and the mist supply unit 10 connected to the mist generation unit 8 is formed to extend downward from a front side of the casing 9.

The mist generation unit 8 generates warmed mist from heated water or generates warmed mist by heating mist generated from water. Therefore, the mist generation unit 8 generates mist warmed at a temperature higher than the room temperature in the bathroom. The mist generation unit 8 is mounted on a wall W above the short side part 6e on the short side of the bathtub body 6. Therefore, the warmed mist includes mist warmed after generated.

As shown in FIG. 5, the mist generation unit 8 includes a water storage part (tank) 12 that stores water inside, the water supply channel 14 that supplies water from the water supply source to the water storage part 12, a discharge passage 16 that discharges water from the water storage part 12 to a discharge pipe, an ultrasonic vibrator 18 provided in a bottom portion inside the water storage part 12, a heater 20 provided in the bottom portion inside the water storage part 12, a water temperature measuring instrument 22 that is water temperature detection means provided inside the water storage part 12, a room temperature measuring instrument 24 that is temperature detection means provided outside the water storage part 12 (see FIG. 3), a float switch 29 (water level sensor) that transmits a water supply stop signal when a float rises above a shaft to a water supply prescribed water level due to a rise in the water level of the water in the water storage part 12, an overflow pipe 31 configured to discharge water from an upper end opening to a discharge pipe side, when the water level of the water in the water storage part 12 further rises above a water supply prescribed water level Q1 and overflows above a height position of the upper end opening; and a mist supply flow rate decrease suppression part 40 that suppresses a decrease in amount of mist generated.

The water storage part 12 is formed as a water storage space inside the mist generation unit 8 having a rectangular parallelepiped shape. The water supply channel 14 is connected to an upper portion of the water storage part 12, and the discharge passage 16 is connected to a lower portion of the water storage part 12. The mist supply unit 10 is connected to a side wall in the vicinity of a center of the water storage part 12. In the water supply channel 14, a water supply channel solenoid valve 30 that opens and closes the water supply channel 14 is provided. The water supply channel 14 is connected to the supply device 7. The water supply channel solenoid valve 30 has a function of a water supply part for supplying, to the mist generation unit 8, water at a temperature lower than a temperature of water in the mist generation unit 8. In addition, the supply device 7 supplies, to the mist generation unit 8, water at a temperature (for example, about 38° C.) lower than the temperature (for example, about 60° C.) of the water in the mist generation unit 8. Along the discharge passage 16, a discharge passage solenoid valve 32 that opens and closes the discharge passage 16 is provided. Also, along the discharge passage 16, a discharge pump 33 for discharging water from the water storage part 12 is provided. The overflow pipe 31 is provided in a water supply side part (concave portion) 12a in the water storage part 12. An upper end of the overflow pipe 31 is located slightly above the water supply prescribed water level Q1, and the pipe is configured so that the water in the water storage part 12 does not overflow. In the lower portion of the water storage part 12, a discharge valve 41 for discharging leak water due to failure or the like is provided.

The ultrasonic vibrator 18 oscillates ultrasonic waves to the water in the water storage part 12, vibrates the water on a liquid surface, and separates water as fine particles from a water column generated on the liquid surface, so that mist (fog) having a predetermined particle size can be generated. The ultrasonic vibrator 18 is electrically connected to the mist device controller 26 and adjusts an oscillation output, frequency or the like of ultrasonic waves of the ultrasonic vibrator 18, so that the particle size of the mist to be generated can be changed. The ultrasonic vibrator 18 uses a predetermined oscillation output to generate mist having Sauter mean particle size of 3.1 μm or more and 10 μm or less. The ultrasonic vibrator 18 may be changed to another device that generates the mist having the predetermined particle size, for example, a mist device by steam, a mist device by pressure spraying, a mist device by arc discharge or the like. Also, in the present embodiment, a plurality of ultrasonic vibrators 18 are arranged in the water storage part 12. The ultrasonic vibrator 18 is connected to an oscillator 19 (see FIG. 4) that drives the ultrasonic vibrator 18 in the casing of the mist device 1.

The water temperature measuring instrument 22 detects the water temperature of the water in the water storage part 12. The mist device controller 26 is electrically connected to the water temperature measuring instrument 22, and the mist device controller 26 can recognize the water temperature of the water in the water storage part 12. The water temperature measuring instrument 22 is, for example, a thermistor. The room temperature measuring instrument 24 detects a temperature of air outside the water storage part 12 of the room space 5 in which the bathtub body 6 is disposed. The mist device controller 26 is electrically connected to the room temperature measuring instrument 24, and the mist device controller 26 can recognize the temperature of air in the room space 5. In addition, it is assumed that in a state before the start of mist supply (before the mist generation unit 8 is driven), the temperature of the air in the room space 5 and the temperature of the air in the retaining space 4 are almost equal or relatively close, and hence the mist device controller 26 can estimate the temperature of the air in the room space 5 measured with the room temperature measuring instrument 24 as the temperature of the air in the retaining space 4.

The float switch 29 includes the float that can move up and down in conjunction with the water level. The float switch 29 can detect that the water level reaches the water supply prescribed water level Q1 at an upper end of the float. Also, the float switch 29 can detect that the water level reaches a lower end water level of a lower end of the float. The detection of the water supply prescribed water level and the detection of the lower end water level may be performed by separate floats. The float switch 29 is electrically connected to the mist device controller 26.

The mist supply unit 10 supplies the mist generated by the mist generation unit 8 into the bathtub body 6 that is the retaining part forming the retaining space 4 having the upper part opened toward the room where the bathtub body 6 is disposed. The mist supply unit 10 is disposed above the short side part 6e of the bathtub body 6 on the short side. The mist supply unit 10 is disposed above the water overflow portion in the bathtub body 6. As shown by a cross section of a flow channel shown in FIG. 3, the mist supply unit 10 includes a mist supply flow channel 11 laterally extending from the mist generation unit 8 to an upper part of one end of the retaining space 4, and a mist supply port portion 13 that is an outlet connected to a downstream end of the mist supply flow channel 11, the outlet being opened downward. The mist supply flow channel 11 forms an oblong rectangular flow channel (for example, a flow channel cross section) as seen from a front surface (from a retaining space 4 side). The mist supply port portion 13 extends downward from the downstream end of the mist supply flow channel 11. The mist supply port portion 13 forms a duct-shaped flow channel extending downward. The mist supply port portion 13 forms an opening opened downward. The mist supply port portion 13 forms an oblong rectangular flow channel (for example, a flow channel cross section) as seen from a front surface of the opening (when seen upward from below the mist supply port portion 13). A lower end 13a of the mist supply port portion 13 is disposed above a water overflow portion 6c in the bathtub body 6. Therefore, the water in the bathtub body 6 can be inhibited from entering an upstream side as a sewage stream from the mist supply port portion 13. As a modification, the overflow portion 6c may be an overflow port provided in the bathtub body 6.

The mist supply unit 10 can supply mist in a supply amount per unit time, for example, in a range of 0.03 mL/min·L to 1.5 mL/min·L. The mist supply unit 10 can supply, for example, mist in a supply amount per unit time of 11 mL/min to the retaining space 4 having a volume of 330 L in the bathtub body 6. Further, for example, the mist supply unit 10 can supply mist in a supply amount per unit time of 6 mL/min to the retaining space 4 having a volume of 4.32 L in another water receiving equipment unit or the like.

The mist device 1 of the mist system 2 supplies, into the retaining space 4, mist that forms a retained state in the retaining space 4. The mist device 1 is configured to form a rising cloud-shaped body of mist having a density state close to the retained state while using a force of an ascending air current of the mist supplied from the mist supply unit 10, which rises upward from the bathtub body 6 (a collection of mist having a predetermined density and further rising beyond an overflow surface 6b that is a top edge of the bathtub body 6, for example, as shown in FIG. 30) so that the rising cloud-shaped body rises above the overflow portion of the bathtub body 6. Afterward, the supplied mist forms the mist retention layer C in the retaining space 4 of the bathtub body 6. The mist retention layer C does not have to be a complete layer and may be present at a certain height so that the mist cloud-shaped body forms a layer. The mist device 1 supplies mist that rises to such an extent to form the mist rising cloud-shaped body and that can return to the retained state. The mist device 1 may form the mist retention layer C without forming any rising cloud-shaped body of the mist.

The bathroom air conditioner 80 can send out warm air at a temperature higher than a temperature in the space in which the bathtub body 6 is provided, cold air at a temperature higher than the temperature in the space and blowing air at about the same temperature as the temperature in the space. The bathroom air conditioner 80 is provided on a ceiling of the bathroom. The mist system 2 can control the bathroom air conditioner 80 to adjust the temperature in the bathroom and can control strength of an ascending air current rising upward from the bathtub body 6 with a temperature difference between the temperature of the water stored in the bathtub body 6 and the temperature in the bathroom where the bathtub body 6 is used before the start of the mist supply. Alternatively, when the temperature in the bathroom is an appropriate temperature, the mist device 1 may not operate the bathroom air conditioner 80 in adjusting the ascending air current. Specifically, the mist system 2 does not necessarily have to include the bathroom air conditioner 80.

The water supply controller 25 controls supply of water to the bathtub body 6 or the faucet apparatus on a side of a wash place. The water supply controller 25 contains a CPU, a memory and the like and controls the equipment connected to execute the water supply, an after-mentioned predetermined mode or the like based on a predetermined control program recorded in the memory or the like. The water supply controller 25 is electrically connected to the supply device 7, an operation unit 27, the mist device controller 26, the bathroom air conditioner 80 and the like. These electrical connections may be performed by wireless communication or the like. The electrical connection of the water supply controller 25 to the mist device controller 26 and/or the operation unit 27 or the like may be performed by wireless communication or the like. For example, the water supply controller 25 with the mist device controller 26 and/or the operation unit 27 or the like may be controlled by wireless communication.

The water supply controller 25 can operate to supply water to the bathtub body 6 independently of the operation of the mist device 1. In addition, the water supply controller 25 may cooperate with the mist device controller 26 to operate in relation to the operation of the mist device 1. The water supply controller 25 and the mist device controller 26 function, as one controller, in communication with each other. Thus, it is described in the present embodiment that the water supply controller 25 and the mist device controller 26 are separate controllers, and the controllers may exist as one integrated controller or further subdivided or otherwise different controllers.

The operation unit 27 includes a bathroom operation part 27a provided on the wall surface around the bathtub body 6 in the bathroom, and a bathroom outside operation part 27b provided on a wall surface outside the bathroom. The bathroom outside operation part 27b is provided, for example, in a kitchen, a corridor or the like. The operation unit 27 may include an operation unit that can be remotely operated by wireless communication or the like. For example, the operation unit 27 may be constituted of a user's smartphone or the like by use of a predetermined program.

The mist device operation unit 28 transmits a user's operation input to the mist device controller 26. The mist device operation unit 28 includes a bathroom operation part 28a provided on the wall surface around the bathtub body 6 in the bathroom, and a bathroom outside operation part 28b provided on the wall surface outside the bathroom. The bathroom outside operation part 28b is provided, for example, in a room, a corridor or the like in front of the bathroom. The mist device operation unit 28 may include an operation unit that can be remotely operated by wireless communication or the like. For example, the mist device operation unit 28 may be constituted of the user's smartphone or the like by use of a predetermined program and connected to the mist device controller 26 via the Internet. The mist device operation unit 28 may perform an operation of storing water in the mist system 2 when supplying mist, setting of the water temperature or the like. The mist device operation unit 28 may have an operating function of setting the temperature of the supplied mist, an operating function of setting the particle size of the supplied mist and the like.

The mist device controller 26 contains a CPU, a memory and the like and controls the equipment connected to execute mist generation based on a predetermined control program recorded in the memory or the like, an after-mentioned predetermined mode or the like. The mist device controller 26 is electrically connected to the ultrasonic vibrator 18, the heater 20, the water temperature measuring instrument 22, the room temperature measuring instrument 24, the mist device operation unit 28, the bathroom air conditioner 80 and the like. Furthermore, the mist device controller 26 is electrically connected also to the water supply channel solenoid valve 30 provided along the water supply channel 14 and the discharge passage solenoid valve 32 provided along the discharge passage and can control these valves.

The mist device controller 26 has a function of controlling the mist generation unit as the controller. The mist device controller 26 includes a mist generation mode 26a in which mist is generated by the mist generation unit 8. The mist device controller 26 can execute the mist generation mode with a program stored in a storage device. In the mist generation mode, all operations of the mist generation unit 8 disclosed in the present embodiment do not have to be executed, and among the operations, at least an operation of generating mist may only be executed.

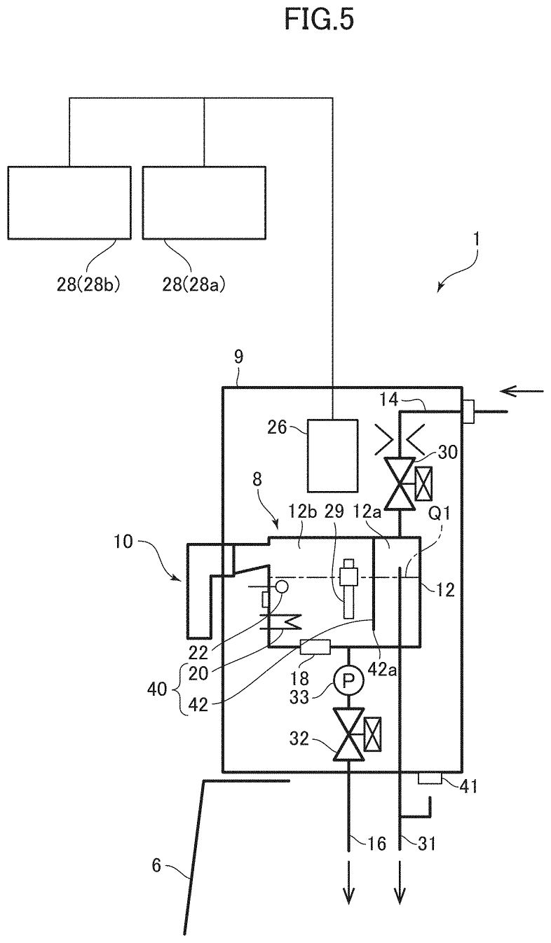

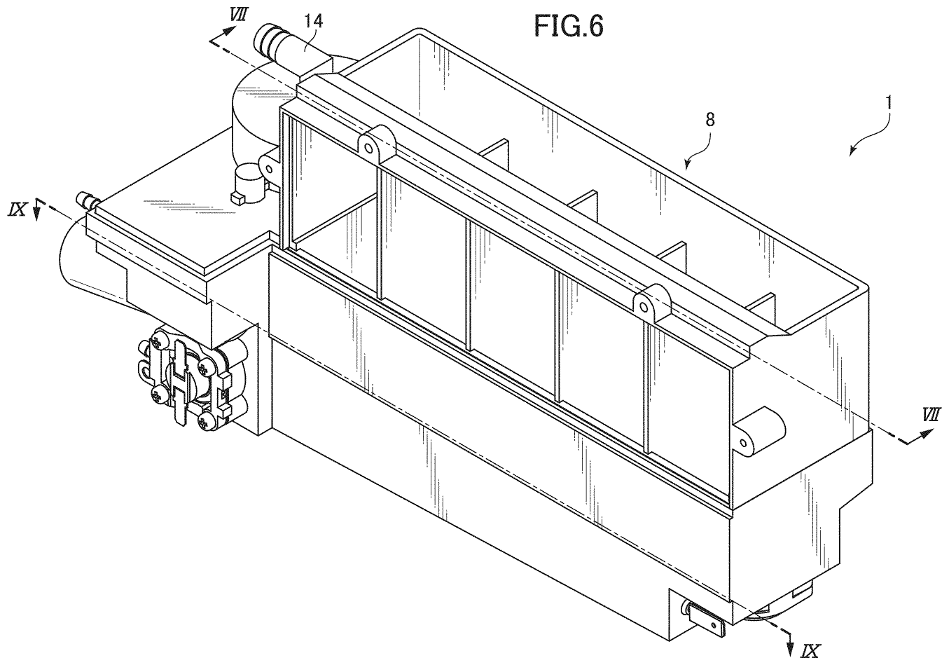

Next, the mist supply flow rate decrease suppression part 40 of the mist generation unit in the mist device according to the first embodiment of the present invention described above will be described in detail with reference to FIGS. 3 to 10.

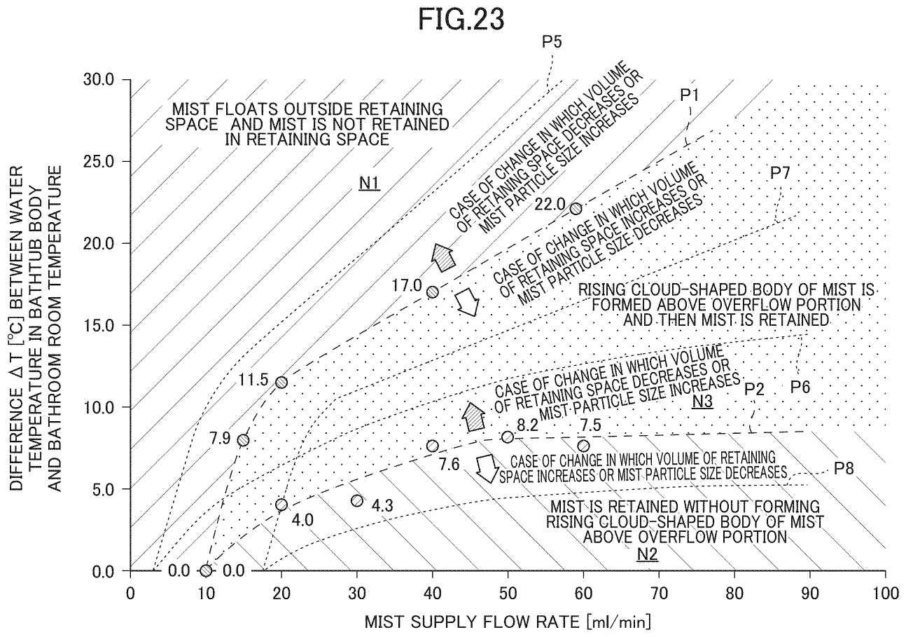

The mist supply flow rate decrease suppression part 40 suppresses a decrease in amount of mist generated. As described later with reference to FIG. 23 and the like, if the amount of mist generated and a supply flow rate of mist decrease, an amount of mist lost from the retaining space 4 is larger than the supply flow rate of the mist, which might cause a state where retention is not formed. The mist supply flow rate decrease suppression part 40 suppresses decreases in amounts of mist generated and mist supplied, so that the retaining space can be easily placed into and maintained in a state where mist is retained therein. Since the mist supply flow rate decrease suppression part 40 can suppress the decrease in amount of mist supplied, the mist device 1 can easily maintain the supply flow rate of the mist to be retained in the retaining space 4.

The heater 20 of the mist generation unit 8 functions as the mist supply flow rate decrease suppression part 40 and suppresses drop in water temperature in the water storage part 12. The mist generation unit 8 further includes a wall part 42 provided between a mist generation side part 12b in which the ultrasonic vibrator 18 is disposed in the water storage part 12 and the water supply side part 12a in which a water supply device that supplies water into the water storage part 12 is disposed.

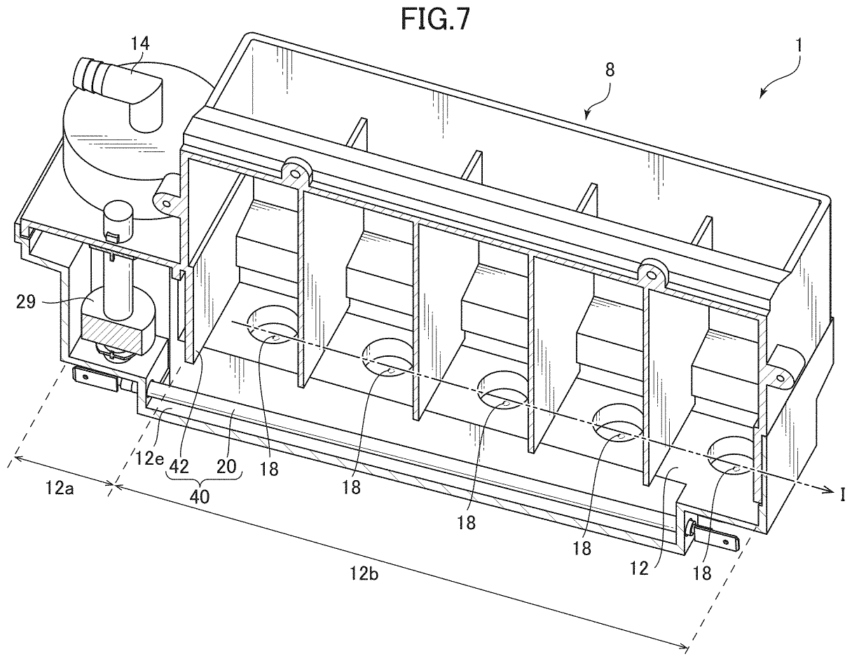

As shown in FIG. 7, the heater 20 of the mist generation unit 8 is provided in at least the mist generation side part 12b. The heater 20 extends from the mist generation side part 12b to the water supply side part 12a. The heater 20 extends in an arrangement direction I of a plurality of ultrasonic vibrators 18. The arrangement direction I of the ultrasonic vibrators 18 is a direction in which the plurality of ultrasonic vibrators 18 are arranged and is, for example, a direction in which a line connecting center points of the plurality of ultrasonic vibrators 18 extends. When the line connecting the center points of the plurality of ultrasonic vibrators 18 cannot be drawn, the arrangement direction I is an orientation in which an approximate line passing near the center points of the plurality of ultrasonic vibrators 18 extends.

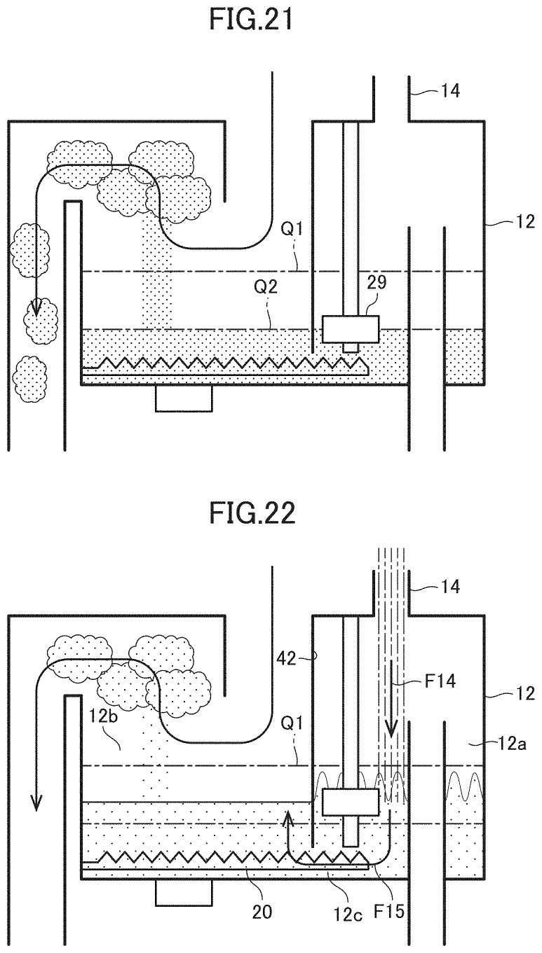

The wall part 42 of the mist generation unit 8 functions as the mist supply flow rate decrease suppression part 40 and is formed so that rippling due to water supplied to the water supply side part 12a is less likely to be transmitted to the mist generation side part 12b. The wall part 42 is configured to communicate water between the mist generation side part 12b and the water supply side part 12a. The wall part 42 is a plate-shaped member. The wall part 42 extends from the upper portion of the water storage part 12 to a position below a half of a height of the water storage part 12. A lower end 42a of the wall part 42 is located at the position below the half of the height of the water storage part 12. The lower end 42a of the wall part 42 is located below the water supply prescribed water level Q1. Thus, the wall part 42 is formed so that the rippling due to the water supplied to the water supply side part 12a hits at least a part of the wall part 42 and is less likely to be transmitted to the mist generation side part 12b. In addition, it is preferable that the lower end 42a of the wall part 42 is located below a lower end water level Q2 (see FIG. 21) that is a lower end of water level change. Thereby, the rippling due to the water supplied to the water supply side part 12a is less likely to be transmitted to the mist generation side part 12b. The mist generation unit 8 includes at least one of the heater 20 and the wall part 42 and can therefore function as the mist supply flow rate decrease suppression part 40.

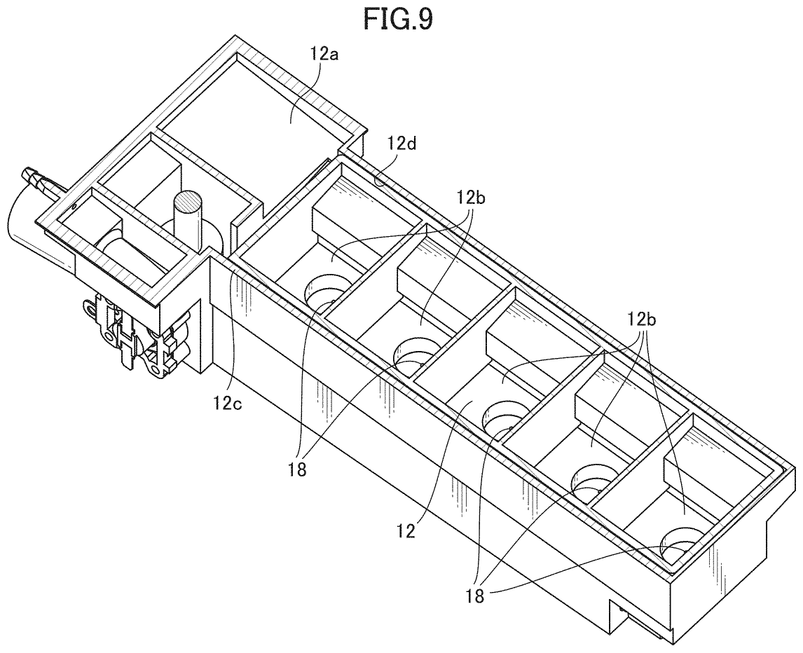

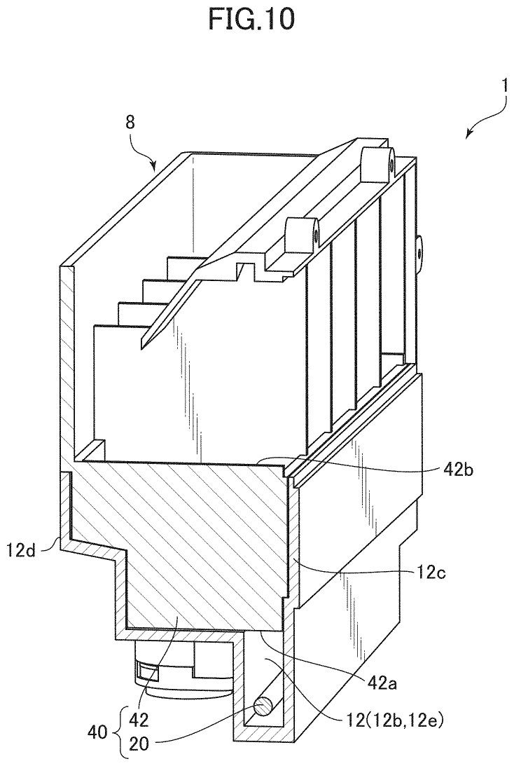

As shown in FIG. 10, the wall part 42 forms a wall surface extending from an upper end 42b to the lower end 42a in a height direction and from a front surface side wall 12c to a rear surface side wall 12d of the water storage part 12 in a front-rear direction. The wall part 42 does not have to be formed from the front surface side wall 12c to the rear surface side wall 12d in the front-rear direction. Also, the wall part 42 does not have to be formed from the upper end 42b to the lower end 42a at all positions in the front-rear direction. For example, the wall part 42 may be formed into a concave shape in which a part of the lower end 42a is cut upward. Also, for example, the wall part may be formed into a convex shape in which a part of the lower end 42a protrudes downward.

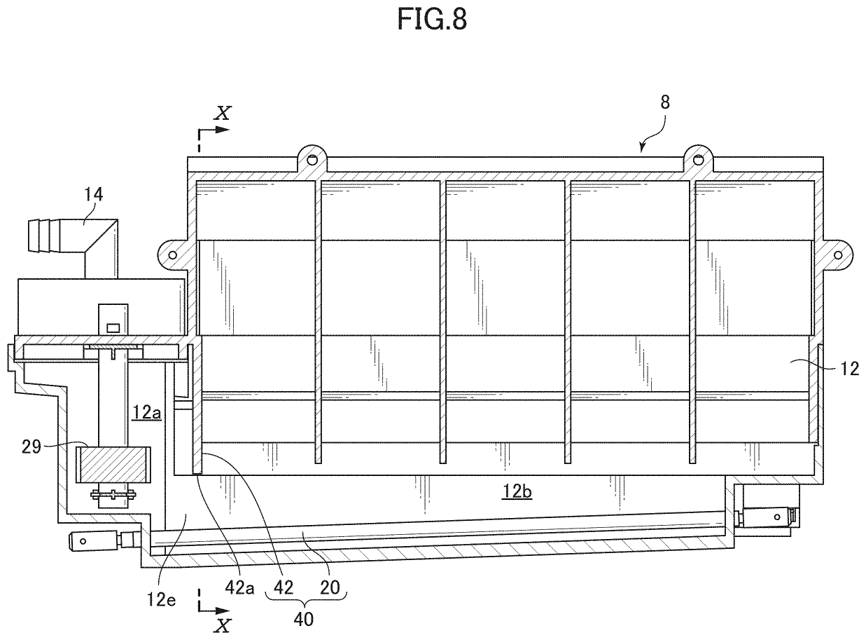

The wall part 42 is disposed to divide between the water supply side part 12a and the mist generation side part 12b in a top view. The wall part 42 is provided at a position at which a volume of water up to the water supply prescribed water level Q1 (volume of water stored from a bottom portion to the water supply prescribed water level Q1) in the mist generation side part 12b is larger than a volume of water up to the water supply prescribed water level Q1 (volume of water stored from the bottom portion to the water supply prescribed water level Q1) in the water supply side part 12a. As shown in FIGS. 8 and 10, the wall part 42 is disposed in an upper part of the heater 20. In the top view, the wall part 42 extends to cross the heater 20 in a left-right direction above the heater 20.

Next, the operation of the mist device according to the first embodiment of the present invention described above will be described with reference to FIGS. 3, 11 to 15 and 35.

As shown in FIG. 3, in a standby state before start of the operation of the mist device 1, water at about 38° C. is stored in a lower half of the retaining space 4 of the bathtub body 6. The temperature of air in the room space 5 of the bathroom 3 and the temperature of air in the retaining space 4 are almost equal. The water supply channel solenoid valve 30 and the discharge passage solenoid valve 32 are closed. There is no water in the water storage part 12. The ultrasonic vibrator 18 and the heater 20 are stopped.

The user operates the mist device operation unit 28 and starts supply control of the mist of the mist device 1. Before start of the mist supply, the room temperature measuring instrument 24 measures the temperature of the air in the room space 5, and the mist device controller 26 recognizes the temperature of the air in the room space 5. The mist device controller 26 opens the water supply channel solenoid valve 30, to supply water from the water supply channel 14 into the water storage part 12. The discharge passage solenoid valve 32 remains closed. When a predetermined amount of water is stored in the water storage part 12, the water supply channel solenoid valve 30 is closed. Next, the mist device controller 26 operates the heater 20, and heats water from the temperature of the supplied water to 60° C. or more. After water is heated to 60° C. or more, the mist device controller 26 adjusts a mist temperature to supply mist at a predetermined temperature. Subsequently, the mist device controller 26 executes the mist generation mode and operates the ultrasonic vibrator 18, to generate mist in the water storage part 12.

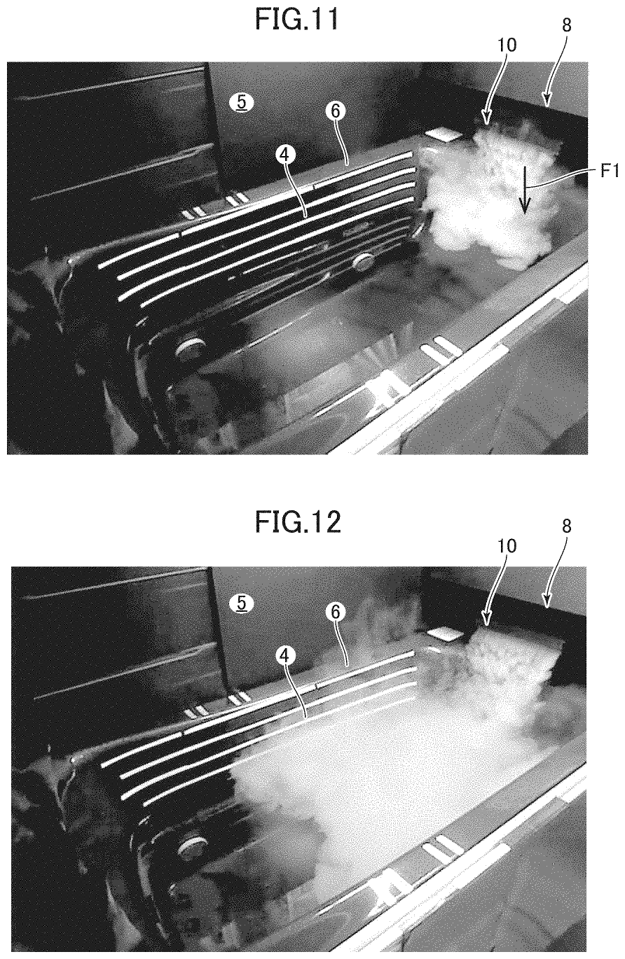

FIG. 11 shows a state immediately after the supply of mist from the mist supply unit 10 into the retaining space 4 is started. The mist generated in the water storage part 12 is supplied from the mist supply unit 10 into the retaining space 4 of the bathtub body 6. As shown with an arrow F1, mist is supplied from the mist supply unit 10 into the retaining space 4 while falling freely by a deadweight of the mist. Thus, mist is inhibited from having a moving speed in a direction other than a moving speed in a downward direction. Thus, the mist is less likely to perform movement such as stirring, diffusion, rising or the like in the retaining space 4.

FIG. 12 shows a state after elapse of about several seconds from the start of the mist supply.

The supply of mist from the mist supply unit 10 to retaining space 4 continues. The supplied mist starts to be retained above a water surface of the water B and in a lower part in the retaining space 4. The mist is easily retained in the retaining space 4, because a force to raise the mist with the ascending air current is not in excess of the weight of the mist supplied from the mist supply unit 10. Therefore, the mist is retained in a relatively low part of the retaining space 4. The mist is gradually supplied and added from a mist supply unit 10 side and gradually advances from the mist supply unit 10 side toward an opposite short side on the water surface or the bottom portion in the retaining space 4.

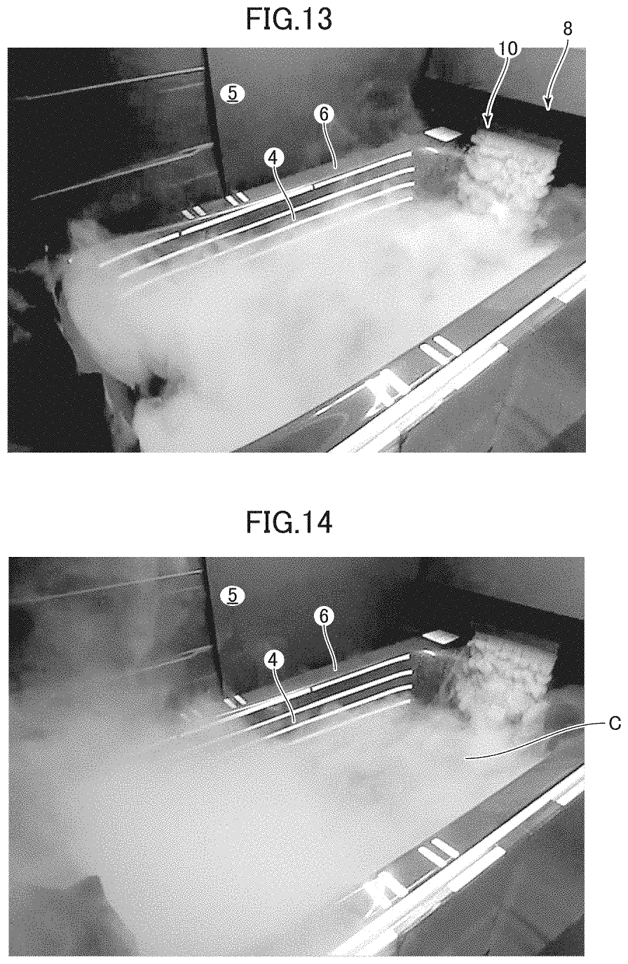

FIG. 13 shows the mist reaching the opposite short side of the bathtub body 6 from the state of FIG. 12. The supply of mist from the mist supply unit 10 to the retaining space 4 continues.

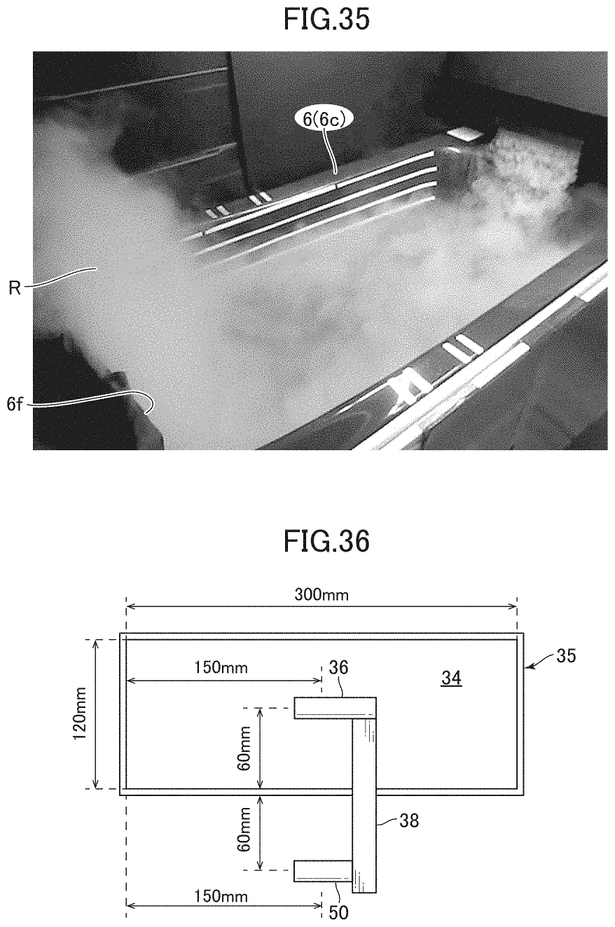

FIG. 35 shows a state after elapse of about ten seconds from the start of the mist supply.

As shown in FIG. 35, a rising cloud-shaped body R (for example, a collection of mist having a predetermined density and rising further above the overflow surface 6b that is an upper edge of the bathtub body 6) rises to a height in a range of about 5 cm to about 30 cm from the overflow surface 6b. Then, some mist floats and dissipates, most mist receives a gravity larger than a force received by the mist from the ascending air current and then gradually lowers again to return toward the retaining space 4 in the bathtub body 6, and some mist vaporizes and disappears during the movement.

As shown in FIG. 14, from the state of FIG. 13 where the mist reaches the opposite short side of the bathtub body 6, mist is further supplied, to fill the retaining space 4 with the mist. When the mist reaches the short side part 6e opposite to the mist supply unit, the mist temporarily rises above the water overflow portion 6c to rise on a short side part 6e side. Therefore, if the user's face is at a position close to this short side part 6e side, a mist region can be raised to a region in the vicinity of the user's face. On the other hand, even if part of the mist temporarily rises above the overflow surface 6b, flow of mist mainly continuing to rise while diffusing from the bathtub body 6 is not formed, and even if the mist rises to a certain extent, flow of mist lowering toward the retaining space 4 is formed. The mist is mainly retained in the retaining space 4 (mainly in a region below the overflow surface 6b), and the mist retention layer C is formed in the retaining space 4. Also, during this formation, the supply of mist from the mist supply unit 10 to the retaining space 4 continues.

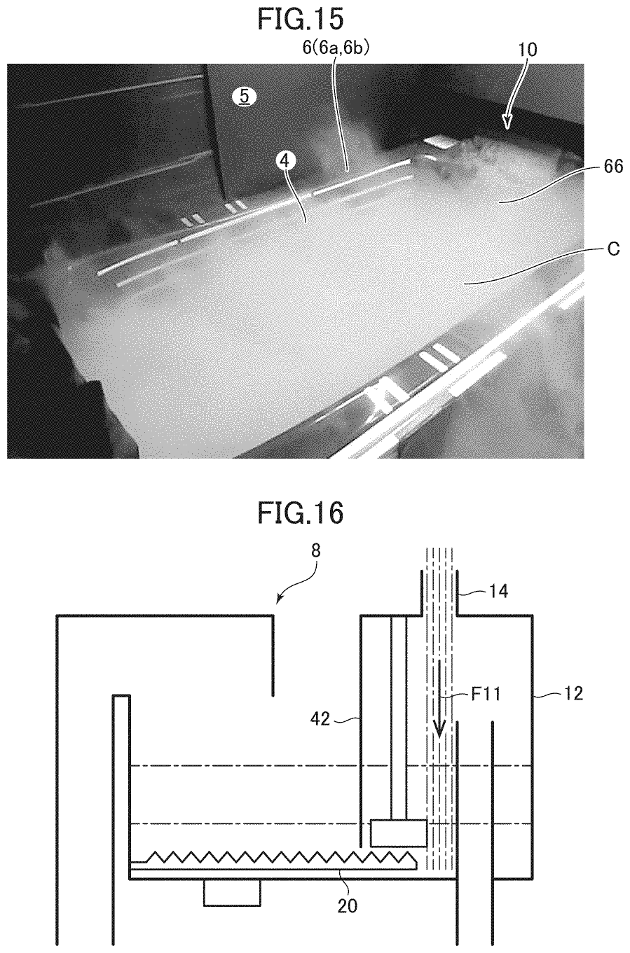

As shown in FIG. 15, when mist is further supplied, increased mist is gradually retained in a higher part in the retaining space 4. The supply of mist from the mist supply unit 10 to the retaining space 4 continues. The mist supplied into the retaining space 4 is further increased and retained to a portion close to a top portion in the retaining space 4 (the upper end portion 6a of the bathtub body 6). The mist is mainly retained in a region above the water surface of the water B in the retaining space 4 and below the top portion in the retaining space 4. The mist falls down into the water B and is absorbed to disappear, adheres as water droplets to the wall surface of the bathtub body 6 to disappear, or diffuses beyond an edge of the upper end portion 6a of the bathtub body 6. A time to disappear varies with the particle size of the mist. Although the mist disappears or diffuses, new mist is supplied before disappearing or diffusing, so that the mist retention layer can be formed in the retaining space 4. Specifically, the mist does not diffuse from the retaining space 4 while gently flowing in the retaining space 4, and the stable retention layer C is formed. The retention layer C is formed when the mist having a certain or more density exists in a unit space above the water surface of the water B. The retention layer is recognized in a white cloud form. The retention layer C is visible as if the retaining space 4 up to the top portion is filled with mist. The retention layer C is distinguished from the mist that dissipates from the retaining space 4 and spreads throughout the room space.

A retaining boundary surface 66 on an upper side of the retained mist is formed below a height position M1 at which a height corresponding to a depth L1 of the bathtub body 6 is added to a height of the overflow surface 6b of the bathtub body 6 (height position M0 (see FIG. 3). The retaining boundary surface 66 indicates a boundary region between the retention layer C in which mist has a certain or more concentration in air and an air layer J in which mist has a concentration less than the certain concentration in air. The retaining boundary surface 66 is defined as a region having a slight height in an up-down direction, because the mist moves to a certain degree while being retained. Note that the overflow surface 6b that is an overflow portion of the bathtub body 6 is a portion having the lowest height in the side wall of the bathtub body 6, that is, a portion from which water stored to an upper limit of the bathtub body 6 first overflows.

For example, the retaining boundary surface 66 on the upper side of the retained mist is formed above the height position M0 of the overflow surface 6b of the bathtub body 6. At this time, for example, the retaining boundary surface 66 on the upper side of the retained mist may be formed below a height position 200 mm above a height (height position M0) of the overflow surface 6b of the bathtub body 6 or may be formed below a height position 100 mm above a height (height position M0) of the overflow surface 6b of the bathtub body 6. Thus, when the retaining boundary surface 66 is located at a position higher than the height of the overflow surface 6b of the bathtub body 6, the user can obtain a mist bath effect up to the position above the bathtub, that is, a hot bath effect up to a height higher than the bathtub. While driving (using) the mist generation unit 8, the mist is supplied into the bathtub body 6, and the retaining of the mist continues. The mist device 1 is configured to prescribe a temperature difference between the water temperature in the bathtub body 6 and the room temperature, the particle size of the mist, the amount of the mist supplied and the like to set the height position of the retaining boundary surface 66 to the above described predetermined height position.

Next, a mist generating operation in the mist generation unit of the mist device 1 will be described with reference to FIGS. 16 to 22.

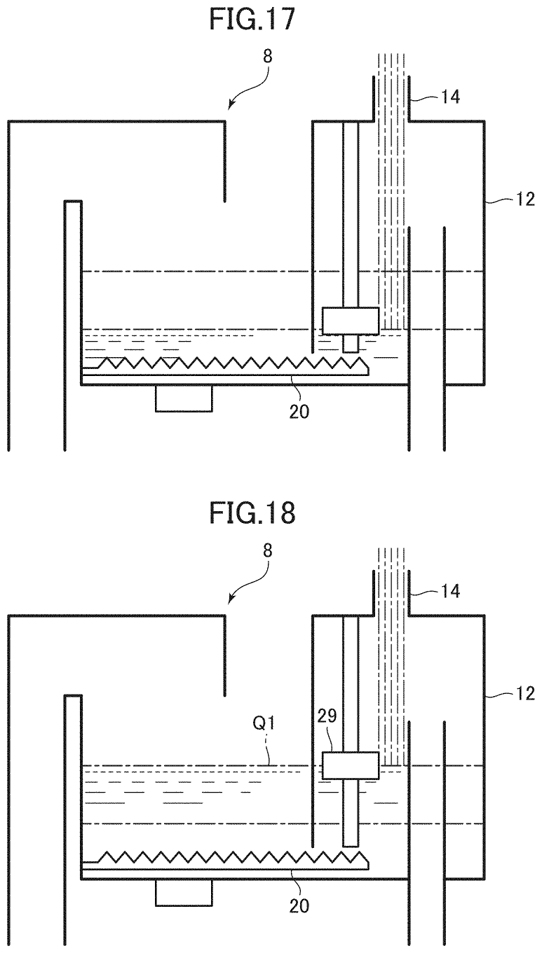

As shown in FIG. 16, in a standby state before start of the operation of the mist device 1, the water storage part 12 in the mist generation unit 8 is in an empty state where water is not stored. On starting a mist supply operation of the mist device 1, the mist device controller 26 opens the water supply channel solenoid valve 30 (see FIG. 5) and supplies water from the water supply channel 14 into the water storage part 12 as shown with an arrow F11. The discharge passage solenoid valve 32 remains closed. Then, as shown in FIG. 17, the mist device controller 26 operates the heater 20 during the water supply and starts heating the water. As shown in FIG. 18, when the water level in the water storage part 12 reaches the water supply prescribed water level Q1, the float switch 29 detects that the water level reaches the water supply prescribed water level and transmits the detection to the mist device controller 26. The mist device controller 26 closes the water supply channel solenoid valve 30 and stops the water supply. Thereafter, the heater 20 continuously heats water, and the mist device controller 26 heats the water in the water storage part 12 to a predetermined temperature (for example, 60° C.).

As shown in FIG. 19, the mist device controller 26 operates the ultrasonic vibrator 18 and generates mist in the water storage part 12. Ultrasonic waves generated by the ultrasonic vibrator 18 generate mist from the water surface. In more detail, ultrasonic waves intermittently form a liquid column that rises on the water surface, and the mist of water is separated from this liquid into fine particles, to generate the mist. The mist thus generated is supplied from the mist generation unit 8 to the mist supply unit 10 and supplied from the mist supply unit 10 into the retaining space 4 on a lower side, as shown with an arrow F12.

At this time, the mist is relatively warm at a temperature near 60° C., and the water surface on which the mist is generated is also relatively warm at a temperature near 60° C. Therefore, an ascending air current occurs from the water surface, and a flow of air is generated due to a shape in the water storage part 12 as shown with an arrow F13. The air flow F13 can easily supply mist from the mist generation unit 8 to the mist supply unit 10 and the retaining space 4. On the other hand, with the air flow F13, the temperature of the water in the water storage part 12 gradually decreases. In the present embodiment, since the heater 20 heats water, drop in water temperature can be suppressed, and it is possible to suppress occurrence of an event in which the mist is difficult to separate from the liquid column due to the drop in water temperature and in which the amount of mist generated decreases.

The mist generated has a predetermined temperature at about 60° C. Since the temperature of the mist is about 60° C., the ascending air current or mist upward movement is easily generated. While maintaining the relatively high temperature, the mist rises toward the upper part of the mist generation unit, moves from the upper part of the mist generation unit to the mist supply unit 10, and lowers from the mist supply unit 10 toward the retaining space 4. Further, the generated mist has the predetermined particle size.

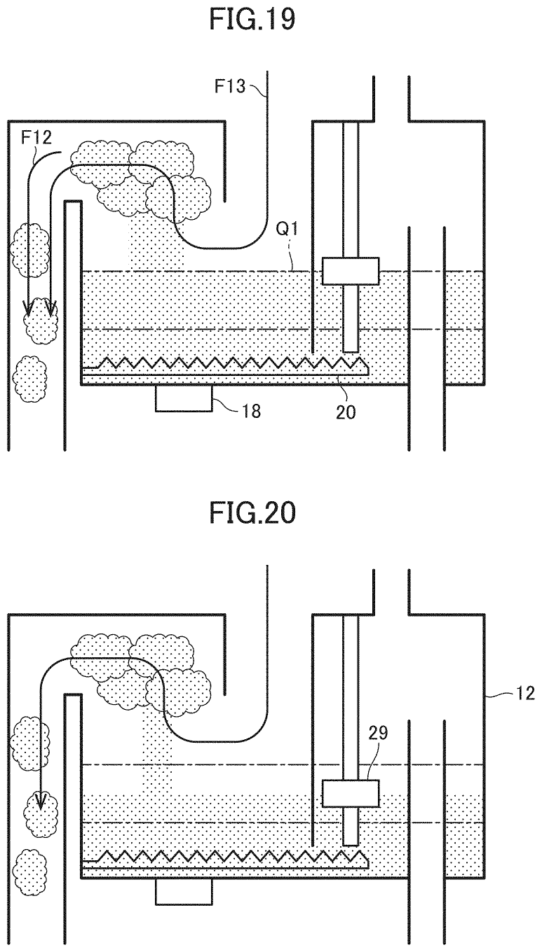

As shown in FIG. 20, when mist generation continues, the water in the water storage part 12 gradually reduces, and the water level lowers. The float switch 29 detects that the water level reaches the lower end water level Q2 (see FIG. 21), and the mist device controller 26 opens the water supply channel solenoid valve 30 and starts water supply from the water supply channel 14. Even while the water level lowers, the ultrasonic resonator 18 is driven, and the mist generation continues.

In FIG. 22, as shown with an arrow F14, the water from the water supply channel 14 flows into the water supply side part 12a of the water storage part 12. As shown with an arrow F15, the water flowing into the water supply side part 12a of the water storage part 12 moves from below the wall part 42 into the mist generation side part 12b of the water storage part 12. The water supply from the water supply channel 14 continues until the water level rises again to the water supply prescribed water level Q1.

The mist device controller 26 heats water with the heater 20 even during the water supply. The water flowing into the water supply side part 12a has a temperature lower than a predetermined water temperature, and hence as shown with the arrow F15, the water is heated with the heater 20 from middle of moving to the mist generation side part 12b from below the wall part 42. The heater 20 heats water in the vicinity of the wall part 42 or from an inlet 12e of the mist generation side part 12b. Therefore, drop in water temperature on a mist generation side part 12b side can be suppressed. The heater 20 is disposed to cross almost the whole mist generation side part 12b side, and hence the water on the mist generation side part 12b side can be entirely warmed.

If the water temperature drops, a separation efficiency of mist from a water column generated on the water surface by the ultrasonic vibrator 18 (mist generation efficiency) is lower than a separation efficiency of the mist from the water column in a case where the water temperature is relatively high. A water viscosity rises as the temperature drops. Therefore, the water viscosity rises in a part in which the water temperature drops, and mist is difficult to separate and generate. On the other hand, in the present embodiment, since the drop in water temperature is suppressed, decrease in separation efficiency of mist from water column can be suppressed, and decrease in the amount of the mist generated as well as decrease in generation efficiency can be suppressed.

Since a lower end portion of majority of the wall part 42 is in water, rippling due to the water supplied to the water supply side part 12a is blocked by the wall part 42 and can be less likely to be transmitted to the mist generation side part 12b.

If the rippling caused by the water supply is transmitted to the mist generation side part 12b, the water column generated on the water surface is disturbed by the ultrasonic vibrator 18, the water column is not formed well, or the mist generated from the water column reduces due to the disturbance in orientation and length or the like. Therefore, an event occurs in which the amount of mist generated decreases. In the present embodiment, the rippling is less likely to be transmitted to the mist generation side part 12b, and hence the decrease in amount of the mist generated and the decrease in generation efficiency in the mist generation side part 12b can be suppressed. When the water level in the water storage part 12 is at the water supply prescribed water level Q1, energy of ultrasonic waves emitted from the ultrasonic vibrator 18 is likely to act on the water surface, and the amount of the mist generated from the water column and the mist generation efficiency can be increased most.

When the water level in the water storage part 12 reaches the water supply prescribed water level Q1, the float switch 29 detects the water supply prescribed water level Q1, and the mist device controller 26 stops the water supply (see FIG. 19). Thereafter, the mist continues to be generated. The mist device controller 26 controls respective parts to repeat the operation shown in FIGS. 19 to 22. When the user operates the mist device operation unit 28 to input mist generation end, the mist device controller 26 stops the ultrasonic vibrator 18 and the heater 20 and closes the water supply channel solenoid valve 30. Thereafter, the discharge passage solenoid valve 32 is driven to discharge the water in the water storage part 12 and to end the driving of the mist device 1.

As shown in FIGS. 15, 23 and 24, the mist supplied by the mist device 1 of the mist system 2 can form the retained state in the retaining space 4. This mechanism will be described.

As a basic mechanism, the force to raise the mist with the ascending air current generated by a temperature difference ΔT between the water temperature in the bathtub body 6 and the room temperature in the bathroom is not in excess of the weight of the mist supplied from the mist supply unit 10, and the mist is retained in the retaining space 4. Specifically, since the mist weight is larger than the force to raise the mist, the mist forms the retained state. Therefore, the mist device 1 of the mist system 2 supplies the mist that satisfies such conditions, and the retained state of the mist can be easily formed in the retaining space 4. The ascending air current is generated by the temperature difference ΔT between the water temperature in the bathtub body 6 and the room temperature in the bathroom and may be generated by a temperature difference between the mist temperature (ambient temperature of the mist) and the room temperature in the bathroom in a state where the mist retention layer is formed. The weight of the mist is affected by the particle size of the mist and the density of the mist. As the amount of the mist supplied increases, the density of the mist increases and/or mist particles are combined to increase the particle size of the mist, and for these and other reasons, a weight of the collection of mist increases. Therefore, when the amount of the mist supplied increases, the mist tends to form the retained state. On the other hand, as the amount of the mist supplied decreases, the mist is less likely to form the retained state. In addition, when the particle size of the mist supplied increases, the mist is likely to form the retained state. Furthermore, to form the retained state of the mist in the retaining space 4, the larger the retaining space 4 is, the larger amount of the mist supplied is required. When the retaining space 4 is relatively small and even when the amount of the mist supplied is small, the space is more likely to be filled with a smaller amount of mist supplied, the mist density is more likely to increase, and hence the retained state of the mist can be formed in the retaining space 4 with the smaller amount of mist supplied. When kinetic energy the mist has during the mist supply is large, the mist easily dissipates, and hence the mist is less likely to form the retained state. When the amount of mist supplied is relatively small, the mist is easily vaporized, and hence the mist is less likely to form the retained state. Based on such findings, the inventors of the present invention have obtained a finding how the mist is likely to be retained in the retaining space 4 as follows.

Next, how the mist is likely to be retained in the retaining space 4 will be described with reference to FIG. 23.

As shown in FIG. 23, a mist supply flow rate [ml/min] is changed for the temperature difference ΔT [° C.] between the water temperature in the bathtub body 6 and the room temperature in the bathroom, and then it is evaluated whether the rising cloud-shaped body of the mist is formed above the overflow portion of the bathtub body and the mist is then retained in the retaining space 4, whether the mist is retained in the retaining space 4 without forming the rising cloud-shaped body of the mist above the overflow portion of the bathtub body or whether the mist floats outside the retaining space 4 and is not retained in the retaining space 4. At this time, a height from the overflow surface 6b (upper rim) at the lower end of the mist supply unit 10 is 50 mm, and the mist Sauter mean particle size is 3.1 μm or more and 10 μm or less. When water is not stored in the bathtub body 6, the water temperature in the bathtub body 6 is evaluated as the temperature of the bathtub body 6, that is, the room temperature.

In FIG. 23, it is found that when the temperature difference ΔT [° C.] between the water temperature in the bathtub body 6 and the room temperature in the bathroom is changed for the mist supply flow rate [ml/min], points of the temperature difference ΔT [° C.] that is a boundary between a state where the mist floats outside the retaining space 4 and the mist is not retained in the retaining space 4 and a state where the rising cloud-shaped body of the mist is formed above the overflow portion of the bathtub body and then the mist is retained in the retaining space 4 include 0 [° C.], 7.9 [° C.], 11.5 [° C.], 17.0 [° C.], and 22.0 [° C.]. A virtual boundary line P1 passing through this plurality of temperatures indicates a boundary between a region in the state where the mist floats outside the retaining space 4 and the mist is not retained in the retaining space 4 and a region in the state where the rising cloud-shaped body of the mist is formed above the overflow portion of the bathtub body and then the mist is retained in the retaining space 4. Similarly, it is found that points of the temperature difference ΔT [° C.] that is a boundary between the state where the rising cloud-shaped body of the mist is formed above the overflow portion of the bathtub body 6 and then the mist is retained in the retaining space 4 and a state where the mist is retained in the retaining space 4 without forming the rising cloud-shaped body of the mist above the overflow portion of the bathtub body include 0 [° C.], 4.0 [° C.], 4.3 [° C.], 7.6 [° C.], 8.2 [° C.], and 7.5 [° C.]. A virtual boundary line P2 passing through this plurality of temperatures indicates a boundary between a region in the state where the rising cloud-shaped body of the mist is formed above the overflow portion of the bathtub body and then the mist is retained in the retaining space 4 and a region in the state where the mist is retained in the retaining space 4 without forming the rising cloud-shaped body of the mist above the overflow portion of the bathtub body.

In FIG. 23, a region N1 in the state where the mist floats outside the retaining space 4 and the mist is not retained in the retaining space 4 is a region where the ascending air current resulting from the difference between the water temperature and the room temperature is relatively strong, the weight (gravity) of the mist is smaller than the force of the ascending air current that acts on the mist in the retaining space 4, and hence the mist floats and dissipates above the retaining space 4 due to the ascending air current.

A region N2 in the state where the mist is retained in the retaining space 4 without forming the rising cloud-shaped body of the mist above the overflow portion of the bathtub body is a region where the ascending air current resulting from the difference between the water temperature and the room temperature is relatively weak, and the weight (gravity) of the mist in the retaining space 4 is larger than the force of the ascending air current that acts on the mist, so that the mist is less likely to be raised by the ascending air current, and the mist is in the retained state in the retaining space 4 and at a position below the overflow surface 6b.

A region N3 in the state where the rising cloud-shaped body of the mist is formed above the overflow portion of the bathtub body 6 and then the mist is retained in the retaining space 4 is a region where the ascending air current results to a certain degree from the difference between the water temperature and the room temperature, and the weight (gravity) of the mist in the retaining space 4 is larger than the force of the ascending air current that acts on the mist. However, the weight of the mist is relatively close to the force of the ascending air current that acts. Therefore, the mist is once raised by the ascending air current to rise at a position above the overflow surface 6b, the rising cloud-shaped body is formed, then the mist gradually lowers toward the retaining space 4, and the mist forms the retained state in the retaining space 4 and at the position below the overflow surface 6b.

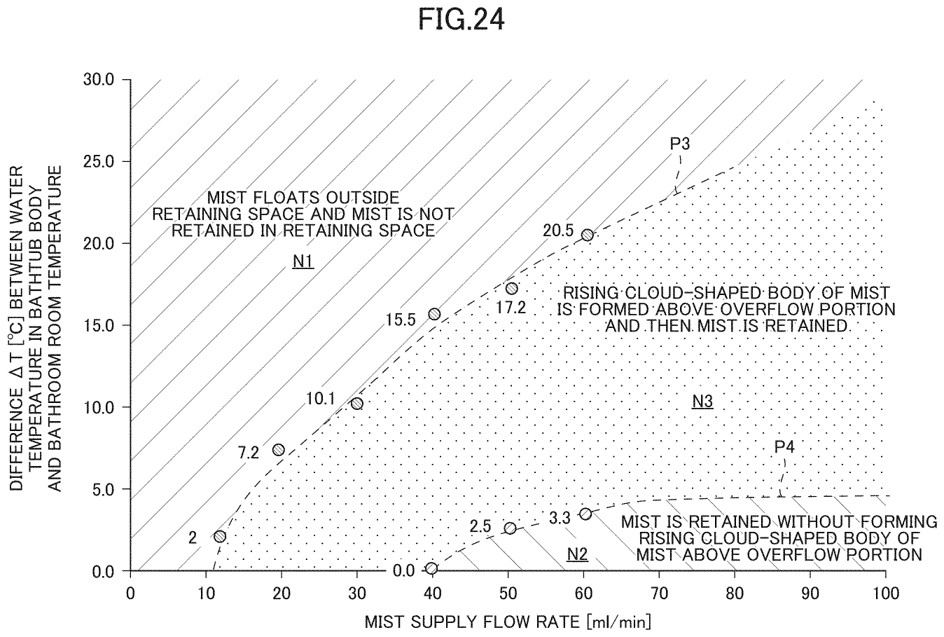

As shown in FIG. 24, the height from the overflow surface 6b (upper rim) at the lower end of the mist supply unit 10 is changed to 110 mm, and the same measurement as in FIG. 23 is performed. Specifically, the height from the overflow surface 6b at the lower end of the mist supply unit 10 in FIG. 24 is higher than the height in FIG. 23. In FIG. 24, parameters other than the height at the lower end of the mist supply unit 10 are set in the same manner as in FIG. 23.

In FIG. 24, it is found that when the temperature difference ΔT [° C.] between the water temperature in the bathtub body 6 and the room temperature in the bathroom is changed for the mist supply flow rate [ml/min], points of the temperature difference ΔT [° C.] that is a boundary between the state where the mist floats outside the retaining space 4 and the mist is not retained in the retaining space 4 and the state where the rising cloud-shaped body of the mist is formed above the overflow portion of the bathtub body 6 and then the mist is retained in the retaining space 4 include 0 [° C.], 2 [° C.], 7.2 [° C.], 10.1 [° C.], 15.5 [° C.], 17.2 [° C.] and 20.5 [° C.]. A virtual boundary line P3 is calculated to pass through this plurality of temperatures and indicates a boundary between the region in the state where the mist floats outside the retaining space 4 and the mist is not retained in the retaining space 4 and the region in the state where the rising cloud-shaped body of the mist is formed above the overflow portion of the bathtub body and then the mist is retained in the retaining space 4.

Also, it is found that points of the temperature difference ΔT [° C.] that is the boundary between the state where the rising cloud-shaped body of the mist is formed above the overflow portion of the bathtub body 6 and then the mist is retained in the retaining space 4 and the state where the mist is retained in the retaining space 4 without forming the rising cloud-shaped body of the mist above the overflow portion of the bathtub body include 0 [° C.], 2.5 [° C.], and 3.3 [° C.]. A virtual boundary line P4 is calculated to pass through this plurality of temperatures and indicates a boundary between the region in the state where the rising cloud-shaped body of the mist is formed above the overflow portion of the bathtub body and then the mist is retained in the retaining space 4 and the region in the state where the mist is retained in the retaining space 4 without forming the rising cloud-shaped body of the mist above the overflow portion of the bathtub body. Therefore, FIG. 24 shows the regions N1, N2 and N3 in the same manner as in FIG. 23.

In FIG. 24, a height at which the mist supplied from the mist supply unit 10 into the retaining space 4 falls down to the water surface is higher than the falling height in FIG. 23, and the mist density is likely to decrease due to the mist diffusing while lowering. Therefore, in the retaining space 4 or the like, the mist weight decreases and the mist is likely to float and dissipate. Also, in FIG. 24, the height at which the mist supplied from the mist supply unit 10 into the retaining space 4 falls down to the water surface is higher than the falling height in FIG. 23, and the mist has a faster speed. Therefore, in a case where the speed of the mist is relatively high, the mist kinetic energy increases and the mist is more likely to float and dissipate as compared with a case where the speed of the mist is low in advance. Further, when the mist reaches the short side part 6e on the side opposite to the mist supply side, the mist is likely to rise along the wall surface. Therefore, it is seen that the virtual boundary line P3 indicates the temperature lower than the temperature indicated by the virtual boundary line P1 and that even when the ascending air current resulting from the difference between the water temperature and the room temperature is weaker (when ΔT is small), the mist floats and dissipates above the retaining space 4 due to the ascending air current. Also, the virtual boundary line P4 indicates the temperature lower than the temperature indicated by the virtual boundary line P2 and indicates that even when the ascending air current resulting from the difference between the water temperature and the room temperature is weaker (when ΔT is small), the rising cloud-shaped body of the mist is formed above the overflow portion of the bathtub body 6 and then the mist is retained in the retaining space 4.

A relation between the mist supply flow rate [ml/min] and the temperature difference ΔT [° C.] between the water temperature in the bathtub body 6 and the room temperature in the bathroom shown in FIGS. 23 and 24 is shown with respect to the bathtub body 6. The present inventors have confirmed that a similar relation tendency is established not only in the bathtub body 6 but also in water receiving equipment, the equipment having a different volume of the retaining space 4 from the bathtub body 6, for example, a wash place floor of the bathroom, a shower room, a handwash bowl, a washstand bowl, a kitchen sink, a toilet or the like. For example, in these equipment units, the volume of the retaining space 4 is relatively smaller than the volume of the bathtub body 6.

When the volume of the retaining space is smaller than the volume in the retaining space 4 of the bathtub body 6 shown in FIG. 23, the mist density is likely to increase, the mist is likely to form the retained state, and hence a position of the virtual boundary line P1 in FIG. 23 is moved upward (for example, indicated by a virtual boundary line P5). A position of the virtual boundary line P2 in FIG. 23 is also moved upward (for example, indicated by a virtual boundary line P6). Conversely, when the volume of the retaining space is larger than the volume in the retaining space 4 of the bathtub body 6 shown in FIG. 23, the mist density is likely to decrease, the mist is less likely to form the retained state, and hence the position of the virtual boundary line P1 in FIG. 23 is moved downward (for example, indicated by a virtual boundary line P7). The position of the virtual boundary line P2 in FIG. 23 is also moved downward (for example, indicated by a virtual boundary line P8).

In FIGS. 23 and 24, the particle size of the mist generated by the ultrasonic vibrator 18 is the predetermined particle size, and the particle size of the mist can be changed by changing mist generation means (centrifuge or the like), the frequency of the ultrasonic vibrator or the like. When the particle size of the mist is larger than the particle size of the mist used in FIG. 23, the mist weight increases, the mist is likely to form the retained state, and hence the position of the virtual boundary line P1 in FIG. 23 is moved upward (for example, indicated by the virtual boundary line P5). Also, the position of the virtual boundary line P2 in FIG. 23 is also moved upward (for example, indicated by the virtual boundary P6). Conversely, when the particle size of the mist is smaller than the particle size of the mist used in FIG. 23, the mist weight decreases, the mist is less likely to form the retained state, and hence the position of the virtual boundary line P1 in FIG. 23 is moved downward (for example, indicated by the virtual boundary line P7). Also, the position of the virtual boundary line P2 in FIG. 23 is also moved downward (for example, indicated by the virtual boundary line P8). Thus, also when the volume of the retaining space 4 changes or when the particle size of the mist changes, the relation between the state where the mist is retained in the retaining space 4 and the state where the mist is not retained is understandable based on FIGS. 23, 24 and the like.

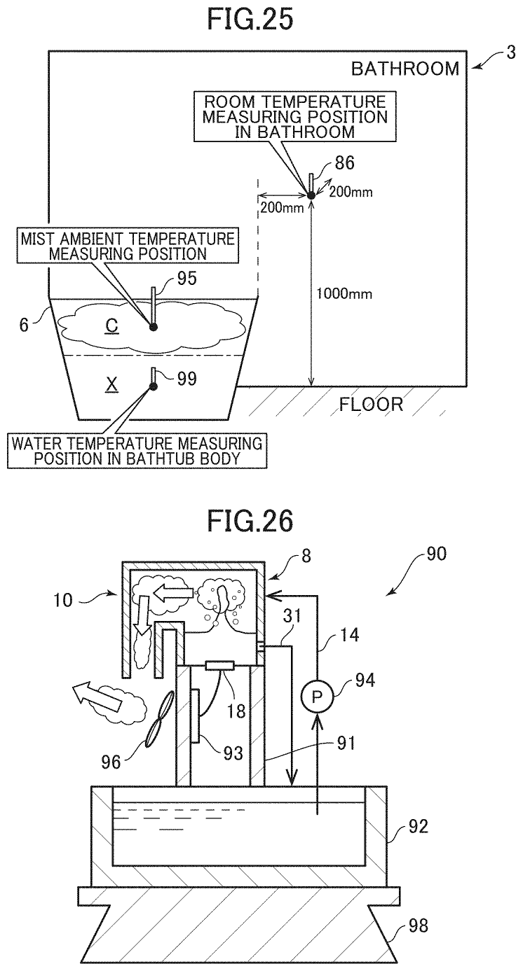

Next, a method of measuring the ambient temperature of the mist in the bathtub body 6 will be described with reference to FIG. 25. The ambient temperature [° C.] of the mist in the bathtub body 6 is measured using a temperature measuring device that can measure an air temperature, for example, a thermistor 95. To measure the ambient temperature of the mist in the bathtub body 6, the thermistor 95 is disposed to measure the temperature. A temperature measuring unit of the thermistor 95 is disposed in a central portion of the long side of the bathtub body 6, a central portion of the short side and a central portion of a height from the surface of the water stored in the bathtub body 6 to the overflow surface 6b, to measure the mist temperature. For example, the ambient temperature of the mist in the bathtub body 6 is measured, when a sufficient time (for example, 2500 [s]) elapses after the mist supply is started and temperature rise almost stops. At a time of measuring, care is taken to prevent an extreme gradient from occurring at a temperature of a measurement object.

Next, a method of measuring the water temperature (hot water temperature) in the bathtub body 6 will be described with reference to FIG. 25. The water temperature [° C.] in the bathtub body 6 is measured using the temperature measuring device that can measure the water temperature, for example, a thermistor 99. To measure the water temperature in the bathtub body 6, the thermistor 99 is disposed at a predetermined position in the bathtub body to measure the water temperature. A temperature measuring unit of the thermistor 99 is disposed in the central portion of the long side of the bathtub body 6, the central portion of the short side and the central portion of a depth of the water stored in the bathtub body 6, to measure the water temperature. At the time of measuring, care is taken to prevent the extreme gradient from occurring at the temperature of the measurement object.

Next, a method of measuring the room temperature in the bathroom provided with the bathtub body 6 will be described with reference to FIG. 25. Since the mist generation unit 8 includes the room temperature measuring instrument 24, the room temperature is basically measured with the room temperature measuring instrument 24.

When the mist generation unit 8 does not include the room temperature measuring instrument 24 or the room temperature cannot be measured (or is difficult to measure) with the room temperature measuring instrument 24, a thermistor 86 is disposed at a predetermined position in the vicinity of the bathtub body in a bathroom space to measure the room temperature. A temperature measurement unit of the thermistor 86 is disposed, for example, at a position of 200 mm from a side of the bathtub body 6, a position of 200 mm in front of an inner wall of a paper surface along a long side direction of the bathtub body, and a position of 1000 mm above a floor surface, to measure the room temperature. At the time of measuring, care is taken to prevent the extreme gradient from occurring at the temperature of the measurement object.

Next, a measuring device and a measuring method for the flow rate of the mist supplied from the mist supply unit 10 will be described with reference to FIG. 26.

A flow rate measuring device 90 of the mist flow rate includes the mist generation unit 8, the mist supply unit 10, a support structure 91 that supports, on a storage tank, the mist generation unit 8 and the mist supply unit 10, a storage tank 92 to store water, a water supply pump 94 that supplies water from the storage tank 92 to the mist generation unit 8, a fan 96 that sends the mist supplied from the mist supply unit 10 to outside of the flow rate measuring device 90, and an electronic balance 98 that measures a weight. The ultrasonic vibrator 18 of the mist generation unit 8 is driven by an oscillation circuit 93 mounted on the support structure 91. The water supply pump 94 and the fan 96 are supported on the support structure 91. Specifically, the flow rate measuring device 90 is configured in a state where water for use in mist generation, the mist generation unit 8 for use in the mist generation and the like are mounted on the electronic balance 98. As the electronic balance 98, GF-32K manufactured by A&D Company, Limited is used.

In the flow rate measuring device 90, in a state before the mist generation, a weight of the mist generation unit 8, the mist supply unit 10, the support structure 91, the storage tank 92 in which water is stored, the water supply pump 94 and the fan 96 that are mounted on the electronic balance 98 (hereinafter referred to as the weight of the mist generation unit 8 and others) is measured. Thereafter, the mist is generated in a state where the mist generation unit 8 and others remain mounted on the electronic balance 98. In the flow rate measuring device 90, water is supplied to the mist generation unit 8 with the water supply pump 94, and water is discharged from the overflow pipe 31 to almost fix the water level. The ultrasonic vibrator 18 is driven to generate mist, and the mist flowing out from the mist supply unit 10 is sent outward from the flow rate measuring device 90 with the fan 96. After start of the driving of the ultrasonic vibrator 18, at a point of time when one minute elapses, the driving of the ultrasonic vibrator 18 is stopped, and the weight of the mist generation unit 8 and others is measured with the electronic balance 98. Therefore, a mist generation time decrease amount can be measured with the following equation, “the mist generation time decrease amount=the weight of the mist generation unit 8 and others before the mist generation−the weight of the mist generation unit 8 and others after the mist generation”. In addition, the mist supply flow rate can be obtained with the following equation, “the mist supply flow rate [ml/min]=the mist generation time decrease amount−evaporation”. For the mist supply flow rate [ml/min] obtained in this manner, the mist supply flow rate [ml/min] is similarly measured three times in series, measurement results are averaged, and a final mist supply flow rate [ml/min] is determined. Also, as the evaporation, an own natural evaporation during the measuring is to be considered. Therefore, in the flow rate measuring device 90, the ultrasonic vibrator 18 is not driven, and a weight decrease amount after the elapse of one minute is measured. The weight decrease amount is similarly measured three times, measurement results are averaged, and a final weight decrease amount is determined as the evaporation, for use in calculation of the above-described mist supply flow rate.

In the flow rate measuring device 90, the measuring is performed so that water other than mist (for example, the water droplets of the water column generated by the ultrasonic vibrator) do not jump out to the outside of the flow rate measuring device 90. Also, the flow rate measuring device 90 is configured so that when the generated mist partially returns to water in the mist supply unit 10, this water returns to the storage tank 92 or the like. The fan 96 is set to an air volume and orientation to such an extent that the mist can flow outward without stagnating in the mist supply unit 10 and the mist generation unit 8.

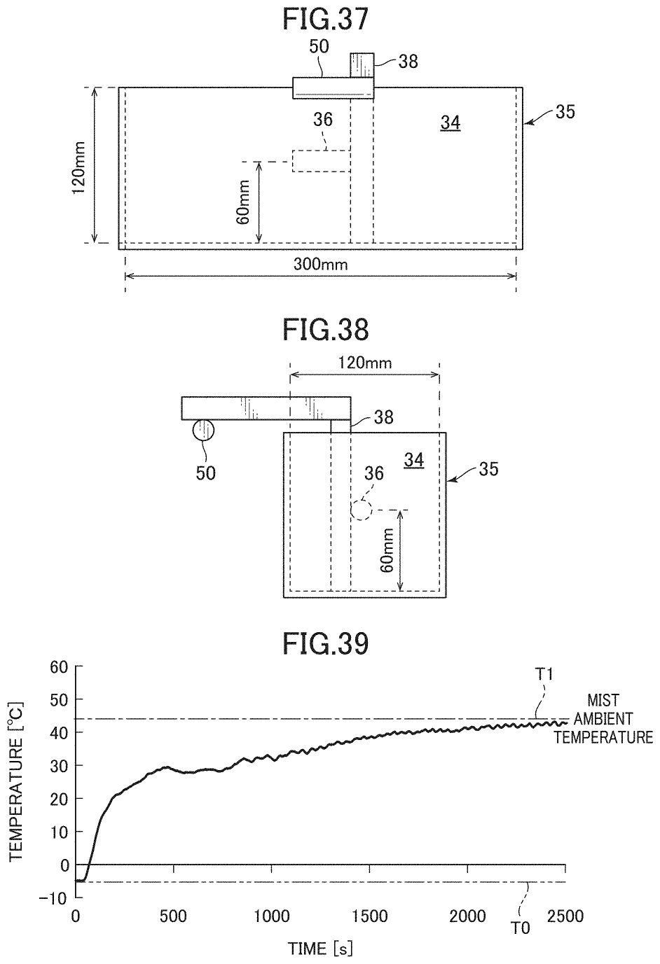

Next, with reference to FIGS. 36 to 38, description will be made as to a measuring method of each of the temperature of the mist supplied from the mist supply unit 10 to the retaining space 4 and the temperature in the room where the bathtub apparatus 2 is used before the start of the mist supply.

FIGS. 36 to 38 are diagrams showing the method of measuring the temperature of the mist and the temperature in the room before the start of the mist supply.

The temperature of the mist supplied from the mist supply unit 10 to the retaining space 4 is measured using a box-shaped device 35 corresponding to a shape of assumed water section equipment. The box-shaped device 35 includes a virtual retaining space 34 that simulates the shape of the mist retaining space of the assumed water section equipment, and a K thermocouple 36 that is provided in a center of the virtual retaining space 34 and that measures the temperature.

The virtual retaining space 34 is formed to reduce in size while simulating the actual shape of the retaining space 4. The size and shape of the virtual retaining space are determined depending on the assumed water section equipment and determined to correspond to a size and shape of a bathtub in case of the bathtub apparatus 2, the wash place floor of the bathroom, the shower room, a bathroom sink in case of the washstand, a kitchen sink in case of the kitchen or the like. The virtual retaining space 34 is, for example, formed into a rectangular shape with a short side of 120 mm and a long side of 300 mm in a top view, and a rectangular parallelepiped shape with a height of 120 mm and a long side of 300 mm in a front view. The virtual retaining space 34 of the box-shaped device 35 has a ceiling surface removed and is opened. At a center position of the virtual retaining space 34, a sensing part of the K thermocouple 36 is disposed, to measure a temperature of air in the virtual retaining space 34.

The K thermocouple 36 is, in the top view, located at a position of 60 mm inward from a side wall in a direction along a short side, a position of 150 mm inward from a side wall in a direction along a long side, and a position of 60 mm above a bottom portion in a height direction. For example, a size of the sensing part of the K thermocouple is set to φ4.5 mm×50 mm. The K thermocouple 36 is electrically connected to a temperature logger (not shown). For example, measurement data of the K thermocouple 36 (model No. L-TN-4-K manufactured by AS ONE Corporation) is measured and recorded with a temperature logger (NR-TH08 in NR-500 series manufactured by Keyence Corporation), and information of the temperature logger is recorded in a personal computer. In addition, water from which the mist is generated includes tap water, and a quality of the water from which the mist is generated is based on a quality of the tap water. Furthermore, in the room where each measuring method (measurement method) is performed, air such as air conditioning air that generates air flow in the room is not supplied.

Next, FIG. 39 shows an example of a measurement result of the mist temperature.

In FIG. 39, a vertical axis indicates the temperature (mist ambient temperature) [° C.] measured with the K thermocouple 36 in the virtual retaining space 34, and a horizontal axis indicates a time [s] elapsed from start of measurement. As shown in FIG. 39, when the supply of the mist from the mist device 1 into the virtual retaining space 34 of the box-shaped device 35 in the present embodiment is started, the temperature measured with the K thermocouple 36 starts rising, and when a sufficient time elapses (for example, 2500 [s] elapse), the temperature indicates an almost constant value. In the present embodiment, it is considered that a mist ambient temperature T1 that is the highest temperature when rise in measured temperature is almost stopped (43° C. in the example of FIG. 39) is the temperature of the mist supplied from the mist device 1 to the retaining space 4.

In a measurement example of the mist ambient temperature shown in FIG. 39, a room temperature at the start is T0=−5° C., and an initial temperature of the mist generated in the mist generation unit 8 is 60° C. The temperature of the mist supplied from the mist discharge passage 10 to the mist retaining space is a slightly lowered temperature, and this temperature is measured as the mist ambient temperature. After the mist supply is started, the temperature in the virtual retaining space 34 rises over time, and the temperature rise converges to an almost constant value T1. When the supply of the mist from the mist device 1 continues, a value at which the temperature measured in the virtual retaining space 34 converges indicates the temperature of the mist supplied from the mist supply unit 10 to the virtual retaining space 34. Therefore, it is assumed that the temperature of the mist actually supplied from the mist supply unit 10 to the retaining space 4 is the mist temperature (mist ambient temperature) measured in the virtual retaining space 34.

Next, description will be made as to a method of measuring a temperature in a room where the water section equipment is used before the start of the mist supply. The temperature in the room where the water section equipment is used before the start of the mist supply is measured with a K thermocouple for room temperature 50 (FIGS. 36 to 38) disposed outside the virtual retaining space 34 in the room where the water section equipment is used. The K thermocouple for room temperature 50 outside the virtual retaining space 34 is disposed in the same room space as for the box-shaped device 35 and simulates the room temperature measuring instrument 24. Therefore, the temperature measured with the K thermocouple for room temperature 50 corresponds to the room temperature measured with the room temperature measuring instrument 24. The temperature measured with the K thermocouple for room temperature 50 is used as the room temperature in the simulation or the like in which the virtual retaining space or the like is used. The K thermocouple for room temperature 50 is disposed at a height of a top portion of the virtual retaining space 34 and located, in a top view, at a position of 60 mm outward from a side wall in a direction along a short side and a position of 150 mm inward from a side wall of one end of the virtual retaining space 34 in a direction along a long side. The K thermocouple for room temperature 50 is fixed to an outer portion of the virtual retaining space 34 on a support portion 38 extending outside the virtual retaining space 34. The temperature in the room where the water section equipment is used is measured with the K thermocouple for room temperature 50 before the supply of the mist to the virtual retaining space 34 is started. As the K thermocouple for the room temperature, the same K thermocouple as the K thermocouple 36 in the virtual retaining space is used. The K thermocouple for room temperature 50 is not limited to such a location and may be disposed outside and in the vicinity of the mist generation unit 8. In addition, in place of the K thermocouple for room temperature 50, the air temperature in the virtual retaining space 34 before the start of the mist supply may be measured with the K thermocouple 36 disposed in the virtual retaining space 34, because the temperature in the room where the water section equipment is used before the start of the mist supply may only be measured.

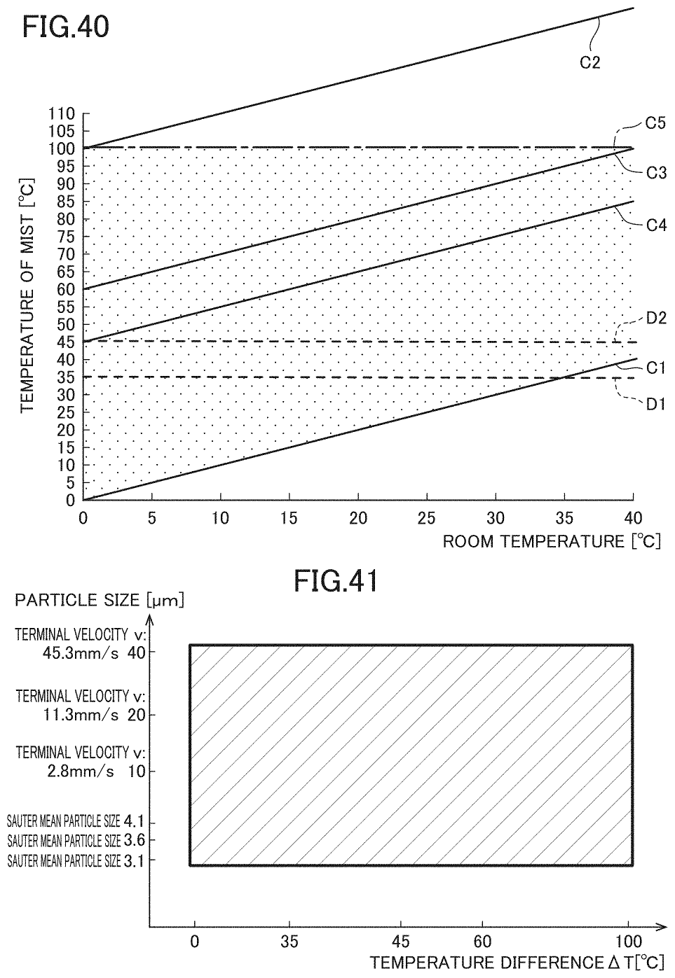

Next, with reference to FIG. 40, description will be made as to a range of a temperature difference between a temperature of the mist supplied from the mist supply unit 10 to the retaining space 4 and the temperature in the room where the water section equipment is used before the start of the mist supply (shown with a dotted region in FIG. 40).

As described above, the temperature of the mist supplied from the mist supply unit 10 to the retaining space 4 and the temperature in the room where the water section equipment is used before the start of the mist supply can be prescribed. Therefore, the temperature difference between the mist temperature and the room temperature can be prescribed. By setting this temperature difference to 0° C. or more, the temperature of the heated mist that is adjusted is set to the same temperature as or a temperature higher than the room temperature before the start of the mist supply.

In FIG. 40, a vertical axis shows the mist temperature [° C.] and a horizontal axis indicates the room temperature [° C.]. Further, in FIG. 40, a line C1 is a line along which the temperature difference between the mist temperature and the room temperature is 0° C. Therefore, a region above the line C1 is a range in which the temperature difference is 0° C. or more. Also, a line C2 is a line along which the temperature difference between the mist temperature and the room temperature is 100° C. The mist generation device 1 is configured so that the temperature difference is 0° C. or more and 100° C. or less. The mist temperature can be set to a relatively high temperature at which the temperature difference is 100° C., and accordingly when mist is used to clean the bathtub body 6 of the water section equipment, cleanability of mist and an ability of the mist to easily remove dirt can be improved. For example, a relatively high cleaning performance can be achieved using the mist at a high temperature close to a temperature at which water boils. In addition, when the mist reaches a boiling temperature (for example, 100° C.), the mist changes to a form of water vapor, mist fog particles disappear, and hence the temperature of the mist supplied from the mist supply unit 10 is set to 100° C. or less (shown by a region of and below a line C5).

The mist device 1 is configured so that the temperature difference is 0° C. or more and 60° C. or less. A line C3 is shown along which the temperature difference between the mist temperature and the room temperature is 60° C. The use of the mist having the relatively high temperature at which the temperature difference is up to 60° C. is suppressed, and hence when the mist is used to wash the bathtub body 6 of the water section equipment, the cleanability of the mist can be improved while further reducing possible burns.

The mist generation unit 8 and the mist supply unit 10 of the mist device 1 are configured so that the temperature difference is 0° C. or more and 45° C. or less. A line C4 is shown along which the temperature difference between the mist temperature and the room temperature is 45° C. When using mist having a relatively low temperature up to the temperature difference of 45° C., it is possible to almost eliminate a possibility that the user of the water section equipment may be burned by the mist.

Further, in FIG. 40, when the mist temperature is set to 35° C. or more (shown with a line D1) and 45° C. or less (shown with a line D2), the temperature can be set to be about a user's body temperature or a temperature warmer than the body temperature, and the possible burns on the user due to the mist can be almost eliminated.

Next, a relation between the temperature difference and the particle size will be described with reference to FIG. 41.

In FIG. 41, a vertical axis indicates the particle size [m], and a horizontal axis indicates a temperature difference ΔT [° C.]. FIG. 41 shows a preferable range of the particle size and the temperature difference ΔT in a dotted region. According to the mist device 1, a predetermined temperature difference can be set in a range in which the temperature difference between the mist temperature and the room temperature is 0° C. or more and 100° C. or less. As described above, the temperature difference can be changed to 0° C. or more and 60° C. or less, 0° C. or more and 45° C. or less, or the like.

The mist device 1 is configured so that a mist Sauter mean particle size is 40 μm or less. Therefore, the particle size of most of the mist is 40 μm or less.

If the particle size of the mist is 40 μm, a termination velocity v is obtained as 45.3 mm/s by the following calculation. A method of calculating the termination velocity v of water droplets can be represented as follows.

ρ=103 kg/m-3, g=9.8 m/s2, μ=1.8×10−5N•sec/m2(15° C.), wherein μ indicates a molecular viscosity coefficient of air, and r indicates a radius of a water droplet (half of the mist particle size), and these equations result in the following.

V (∞)=(2 ρgr2)/(9μ)=1.2×108r2, and the termination velocity v (∞) is proportional to a square of the radius of the water droplet. A range to which this equation is applicable is Re<1, that is, a range of r<0.1 mm.

When the mist particle size is 40 μm, thereby resulting in a mist termination velocity of 45.3 mm/s, it is assumed that the supplied mist reaches a bottom portion of the mist retaining space in approximately 10 seconds (for example, a height from the mist discharge passage 10 to the bottom portion of the retaining space 4 is 45 cm), and the mist disappears. Specifically, the mist is retained for at least 10 seconds from the supply of the mist to the disappearance of the mist. Thus, if the mist is retained for about 10 seconds, new mist can be added for this time, and the mist retention layer C of the mist is easily maintained. In FIG. 41, when the Sauter mean particle size is larger than 40 μm, an average time until the disappearance of the mist is shorter, and hence the disappearance of the mist makes it difficult to form the mist retention layer.

The mist device 1 may be configured so that the mist Sauter mean particle size is 20 or less. At this time, the particle size of most of the mist is 20 μm or less. If the mist particle size is 20 μm, the termination velocity v is determined to be 11.3 mm/s, it takes at least about 40 seconds for the supplied mist to reach the bottom portion of the retaining space, and a ratio of mist falling relatively early to a bottom of the retaining space 4 can be further reduced.

The mist device 1 may be configured so that the mist Sauter mean particle size is 10 μm or less. At this time, the particle size of most of the mist is 10 μm or less. If the mist particle size is 10 μm, the termination velocity v is determined to be 2.8 mm/s, it takes at least about 160 seconds for the supplied mist to reach the bottom portion of the retaining space 4, a duration of the mist that is retained in the retaining space 4 can be longer, and the ratio of the mist falling relatively early to the bottom of the mist retaining space 4 can be further reduced.

The mist device 1 may be configured so that the mist Sauter mean particle size is 3.1 μm or more. At this time, the particle size of most of the mist is 3.1 μm or more. A ratio of mist that diffuses to the outside of the mist retaining space 4 without being retained in the retaining space 4 in the mist supplied from the mist discharge passage 10 can be reduced, a ratio of the mist retained in the retaining space 4 can be increased, and the mist can be efficiently retained in the retaining space 4.

The mist device 1 may be configured so that the mist Sauter mean particle size is 3.6 μm or more. At this time, the particle size of most of the mist is 3.6 μm or more. The ratio of the mist that diffuses to the outside of the mist retaining space 4 without being retained in the retaining space 4 in the mist supplied from the mist discharge passage 10 can be reduced, the ratio of the mist retained in the retaining space 4 can be increased, and the mist can be efficiently retained in the retaining space 4.

The mist device 1 may be configured so that the mist Sauter mean particle size is 4.1 μm or more. At this time, the particle size of most of the mist is 4.1 μm or more. The ratio of the mist that diffuses to the outside of the mist retaining space 4 without being retained in the retaining space 4 in the mist supplied from the mist discharge passage 10 can be further reduced, the ratio of the mist retained in the retaining space 4 can be further increased, and the mist can be further efficiently retained in the retaining space 4.

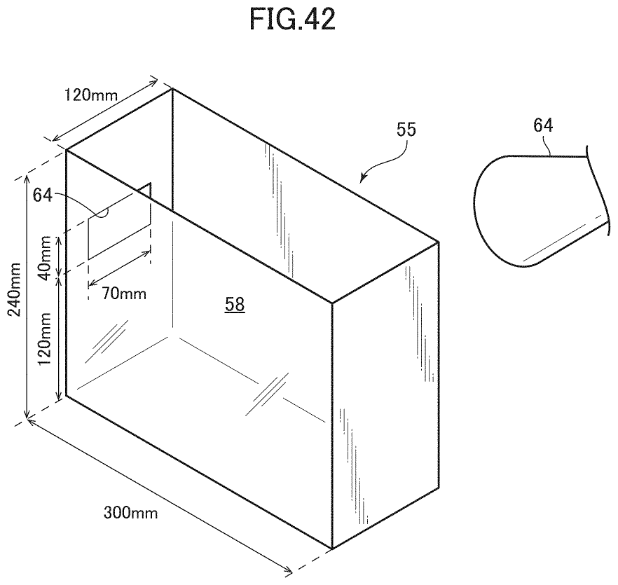

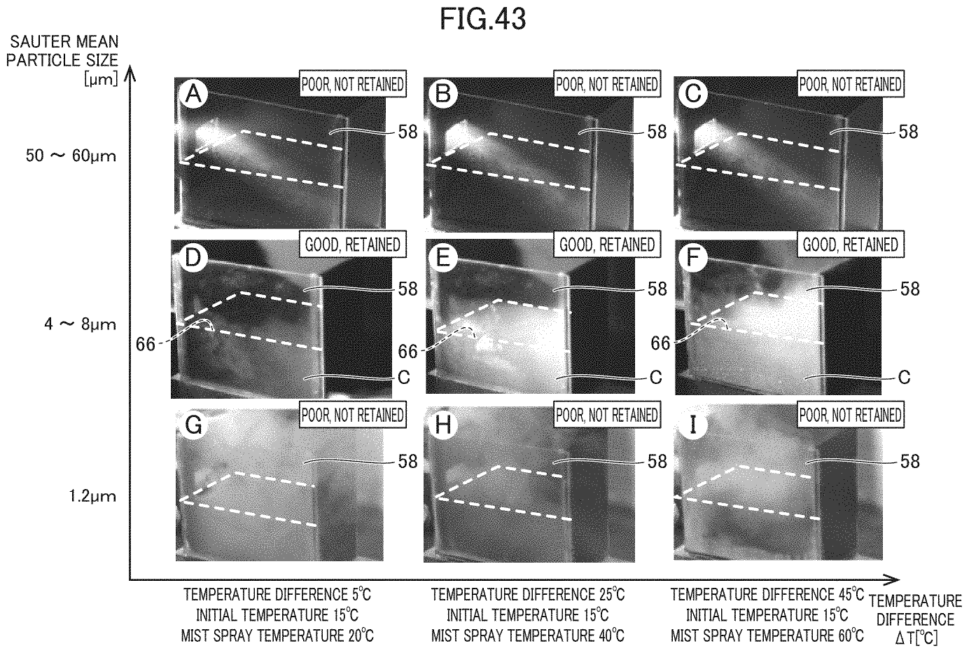

Next, a relation of the temperature difference, the particle size and a state of the mist in a virtual retaining space 58 will be further described with reference to FIGS. 42 and 43. FIG. 42 shows a box-shaped observation device for observing the state in the virtual retaining space. FIG. 43 shows, by comparison, states of the mist in the virtual retaining space 58, as to nine combinations of the temperature difference and the Sauter mean particle size.

As shown in FIG. 43, the mist state in the virtual retaining space 58 can be measured with a box-shaped observation device 55 corresponding to the shape of the assumed water section equipment. The box-shaped observation apparatus 55 includes the virtual retaining space 58 simulating the shape of the mist retaining space of the assumed water section equipment, and a camera 62 that observes and records a behavior of the mist in the virtual retaining space 58. As shown in FIG. 42, the virtual retaining space 58 of the box-shaped observation device 55 has a short side of 120 mm, a long side of 300 mm, and a height of 240 mm. The virtual retaining space 58 has a ceiling surface removed and has an upper part opened. One side wall of the virtual retaining space 58 of the box-shaped observation device 55 is formed of a transparent plate 60, and an interior of the virtual retaining space 58 can be observed and recorded with the camera 62 disposed diagonally above the box-shaped observation device 55. At a position of a height of 120 mm of a side wall of the virtual retaining space 58 of the box-shaped observation device 55 on a short side, a supply port 64 having a lateral width of 70 mm and a height of 40 mm is formed. The supply port 64 is connected to the mist supply unit 10.

FIG. 43 shows, in nine patterns by comparison, photographs of retained states of mist supplied from the mist supply unit 10, having a predetermined particle size and causing a temperature difference, the photographs being taken with the camera 62. A picture of each pattern shows, for reference, a position at which a retaining boundary surface is assumed to be generated, with a dotted line.

In FIG. 43, a vertical axis indicates Sauter mean particle size of the mist supplied from the mist supply unit 10, and a horizontal axis indicates the temperature difference ΔT between the mist temperature and the room temperature.

A pattern example A of FIG. 43 shows a mist state in a case where the mist Sauter mean particle size is from 50 μm to 60 μm, and the temperature difference is 5° C. (the mist temperature is 20° C. and the room temperature before the start of the mist supply is 15° C.). In the pattern example A, the mist supplied from the mist supply unit 10 falls toward the bottom portion relatively early in the virtual retaining space 58 and disappears, and hence the mist is not retained in the virtual retaining space 58. This photograph is taken at the timing at which two minutes elapse after the start of the mist supply. Therefore, in the pattern example A, the mist retention layer C that forms the retaining boundary surface 66 on an upper surface is not formed in the virtual retaining space 58.

A pattern example B of FIG. 43 shows a mist state in a case where the mist Sauter mean particle size is from 50 μm to 60 μm, and the temperature difference is 25° C. (the mist temperature is 40° C. and the room temperature before the start of the mist supply is 15° C.). In the pattern example B, the mist supplied from the mist supply unit 10 falls toward the bottom portion relatively early in the virtual retaining space 58 and disappears, and hence the mist is not retained in the virtual retaining space 58.

A pattern example C of FIG. 43 shows a mist state in a case where the mist Sauter mean particle size is from 50 μm to 60 μm, and the temperature difference is 45° C. (the mist temperature is 60° C. and the room temperature before the start of the mist supply is 15° C.). Also, in the pattern example C, the mist supplied from the mist supply unit 10 falls toward the bottom portion relatively early in the virtual retaining space 58 and disappears, and hence the mist is not retained in the virtual retaining space 58.

A pattern example D of FIG. 43 shows a mist state in a case where the mist Sauter mean particle size is from 4 μm to 8 μm, and the temperature difference is 5° C. (the mist temperature is 20° C. and the room temperature before the start of the mist supply is 15° C.). In the pattern example D, the mist supplied from the mist supply unit 10 forms the retention layer C in the virtual retaining space 58 although slightly thin in concentration. Since the particle size of the mist is relatively small, the termination velocity is also relatively small, and a falling speed is slow. On the other hand, the ascending air current generated due to the temperature difference is also small. Thereby, while the mist is retained, the mist retention layer that forms the retaining boundary surface 66 on the upper surface in the virtual retaining space 58 is formed.

A pattern example E of FIG. 43 shows a mist state in a case where the mist Sauter mean particle size is from 4 μm to 8 μm, and the temperature difference is 25° C. (the mist temperature is 40° C. and the room temperature before the start of the mist supply is 15° C.). In the pattern example E, the mist supplied from the mist supply unit 10 forms the mist retention layer C having a high concentration in the virtual retaining space 58. Since the particle size of the mist is relatively small, the termination velocity is also relatively small, and the falling speed is slow. The ascending air current generated due to the temperature difference is slightly generated. Here, the force of the ascending air current generated due to the temperature difference to raise the mist is not in excess of the weight of the mist, the falling of the mist is suppressed and the mist is retained relatively long. Therefore, the mist retention layer C that forms the retaining boundary surface 66 on the upper surface in the virtual retaining space 58 is formed.

A pattern example F of FIG. 43 shows a mist state in a case where the mist Sauter mean particle size is from 4 μm to 8 μm, and the temperature difference is 45° C. (the mist temperature is 60° C. and the room temperature before the start of the mist supply is 15° C.). In the pattern example F, the mist supplied from the mist supply unit forms the retention layer C having a high concentration in the virtual retaining space 58. Since the particle size of the mist is relatively small, the termination velocity is also relatively small, and the falling speed is slow. Furthermore, the ascending air current generated due to the temperature difference is slightly stronger as compared with a case of the temperature difference being 25° C. However, the force of the ascending air current generated due to the temperature difference to raise the mist is still not in excess of the weight of the mist, the falling of the mist is suppressed and the mist is retained relatively long. Since the ascending air current is slightly stronger, there is a portion in which the mist locally floats from the retention layer C, and as a whole, the mist retention layer C is continuously maintained. Therefore, the mist retention layer that forms the retaining boundary surface 66 on the upper surface in the virtual retaining space 58 is formed. Even if there is a portion in which the mist locally rises, it is considered that the retaining boundary surface 66 is formed in a case where the retaining boundary surface 66 is maintained in a region of a half or more of the virtual retaining space 58.

A pattern example G of FIG. 43 shows a mist state in a case where the mist Sauter mean particle size is 1.2 μm, and the temperature difference is 5° C. (the mist temperature is 20° C. and the room temperature before the start of the mist supply is 15° C.). In the pattern example G, the mist supplied from the mist supply unit 10 diffuses to float up in the virtual retaining space 58. The ascending air current generated due to the temperature difference is relatively small. However, since the particle size of the mist is further smaller, the termination velocity is smaller, and the falling speed is slower. Therefore, the weight of the mist is light, and the mist is diffused by a small ascending air current. Therefore, the mist retention layer C that forms the retaining boundary surface 66 on the upper surface in the virtual retaining space 58 is not formed.

A pattern example H of FIG. 43 shows a mist state in a case where the mist Sauter mean particle size is 1.2 μm, and the temperature difference is 25° C. (the mist temperature is 40° C. and the room temperature before the start of the mist supply is 15° C.). In the pattern example H, the mist supplied from the mist supply unit 10 diffuses to float up in the virtual retaining space 58. Since the particle size of the mist is further smaller, the termination velocity is also further smaller, and the falling speed is further slower. In addition, the ascending air current generated due to the temperature difference is further stronger. Therefore, the weight of the mist is light and the mist is diffused by the stronger ascending air current. Thus, the mist retention layer C that forms the retaining boundary surface 66 on the upper surface in the virtual retaining space 58 is not formed.

A pattern example I of FIG. 43 shows a mist state in a case where the mist Sauter mean particle size is 1.2 μm, and the temperature difference is 45° C. (the mist temperature is 60° C. and the room temperature before the start of the mist supply is 15° C.). In the pattern example I, the mist supplied from the mist supply unit 10 diffuses to float up in the virtual retaining space 58. Since the particle size of the mist is further smaller, the termination velocity is also further smaller, and the falling speed is further slower. In addition, the ascending air current generated due to the temperature difference is further stronger. Therefore, the weight of the mist is light and the mist is diffused by the stronger ascending air current. Thus, the mist retention layer C that forms the retaining boundary surface on the upper surface in the virtual retaining space 58 is not formed.

For example, as shown in the pattern example E of FIG. 43, in the state where the mist is retained in the retaining space 4, an internal transmittance decreases. On the other hand, the mist stays mainly in the retaining space 4, and an external transmittance measured above the retaining boundary surface 66 indicates a relatively high value. Therefore, the internal transmittance/the external transmittance<1, and it is determined that the mist is retained in the retaining space 4.

As shown in pattern example A of FIG. 43, in the state where the mist is not retained in the retaining space 4 and the mist mainly falls and disappears, both the internal transmittance and the external transmittance remain high. Therefore, the internal transmittance/the external transmittance=1, and it is not determined that the mist is retained in the retaining space 4.

As shown in the pattern example I of FIG. 43, in a state where the mist diffuses from the inside to the outside of the retaining space 4, it is considered that both the internal transmittance and the external transmittance similarly indicate a slightly lower value. Therefore, the internal transmittance/the external transmittance=1, and it is not determined that the mist is retained in the retaining space 4.

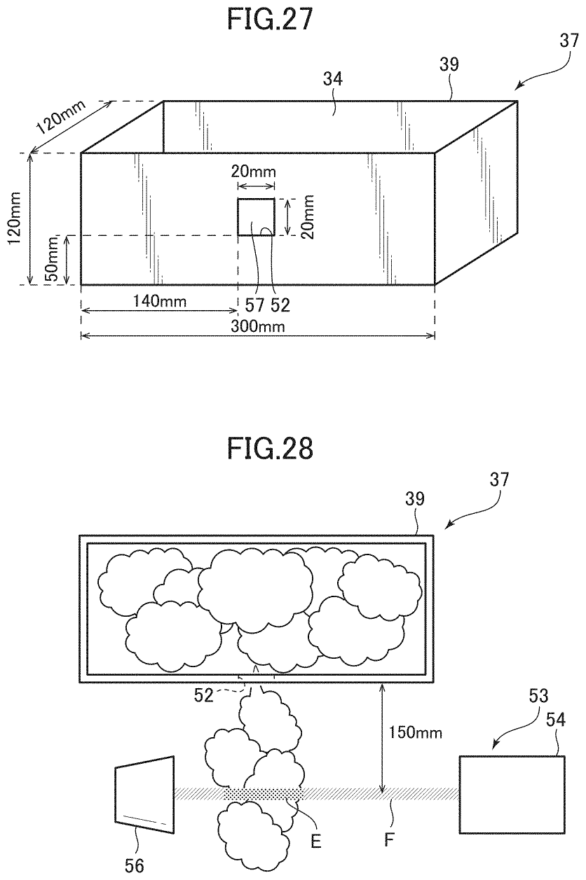

Next, description will be made as to a measuring apparatus and a measuring method of the particle size of the mist supplied from the mist supply unit 10 with reference to FIGS. 27 to 29.

A measuring apparatus 37 of the particle size of the mist includes a box-shaped device 39 that sets the virtual retaining space 34 having the same size and shape as described above, and a particle size distribution measuring device 53. In a sidewall of the box-shaped device 39, that is, in the vicinity of a center of a side wall of the virtual retaining space 34, an opening 52 having a square shape of 20 mm×20 mm is formed, and a lid 57 is attached to the opening 52. To measure the particle size of the mist, the measuring apparatus 37 of the particle size of the mist is disposed in place of the bathtub body 6 and the particle size of the mist is measured. The measuring apparatus 37 is disposed so that a positional relation between a lower end of the mist supply unit 10 and the measuring apparatus 37 is about the same as the positional relation between the mist supply unit 10 and the bathtub body 6, and the mist is supplied from the mist supply unit 10 to the measuring apparatus 37 in the same manner as in supplying the mist from the mist supply unit 10 to the bathtub body 6.

As shown in FIG. 28, the particle size distribution measuring device 53 includes a particle size measuring laser 54 disposed so that a measurement region E of the particle size measuring laser is located in the vicinity and front of the opening 52. The particle size measuring laser 54 is disposed so that in a top view, laser light of the particle size measuring laser 54 is parallel to a long side of the virtual retaining space 34. The measurement region E through which the laser light emitted from the particle size measuring laser 54 passes is located in front of the opening 52. The measurement region E is located at a distance of 150 mm from the opening 52. The particle size distribution measuring device 53 further includes a measuring lens 56 to detect diffracted/scattered light of the laser light.

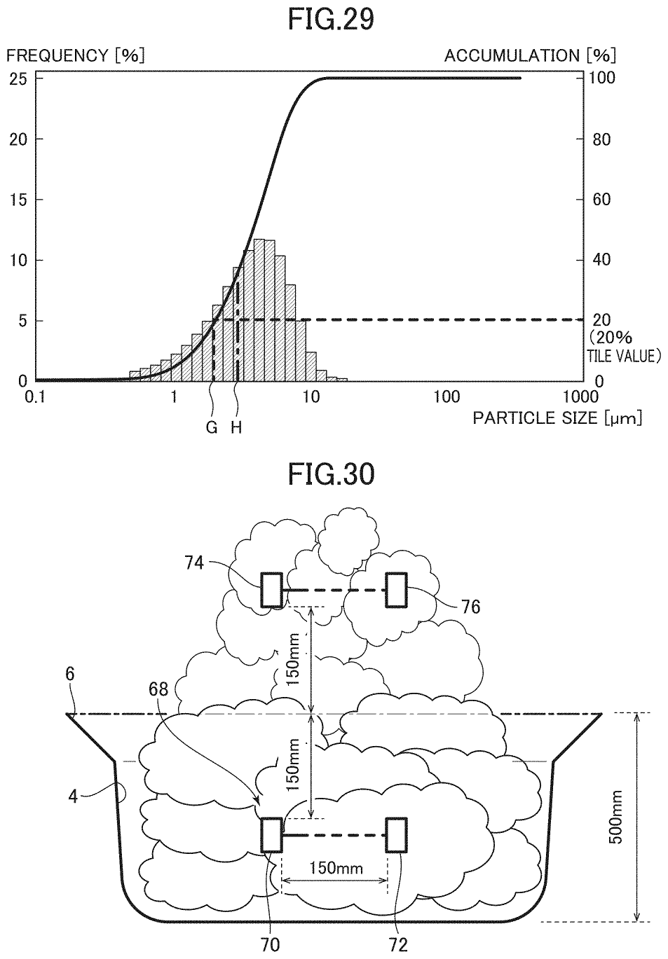

With the lid 57 attached to this opening, the supply of mist into the virtual retaining space 34 is started. A mist supply port from the mist supply unit 10 is not shown in the drawing. In one minute after the start of the mist supply, the lid 57 is opened and the mist is leaked toward the measurement region E of the particle size measuring laser 54. A scattered light distribution is measured with the measuring lens 56 in a state where the transmittance of the particle size measuring laser 54 is from 60% to 90%. For example, as the particle size measuring laser 54 and the measuring lens 56, LDSA-SPR1500A in Aerotrack LDSA-SPR series of a spray particle size distribution measuring device manufactured by MicrotracBEL Corp. is used. Particle size distribution data is measured 10 times, and this particle size distribution data is recorded in a personal computer (PC). Ten times of particle size distribution data are averaged in the PC. FIG. 29 shows an example of the particle size distribution data measured with the particle size distribution measuring device 53. In FIG. 29, a left vertical axis indicates a frequency [%], a right vertical axis indicates an accumulation [%], and a horizontal axis indicates a particle size [μm]. For example, the PC may analyze the particle size distribution data thus obtained, and may acquire, for example, a tile value particle size G of 20% of the particle size distribution data as particle size data, or, for example, a Sauter mean particle size H as the particle size data. The Sauter mean particle size indicates a particle size having a surface area to volume ratio that is the same as a total volume of all particles with respect to a total surface area of all the particles. By obtaining a mean particle size by the Sauter mean particle size, a measured value can be inhibited from being affected by a small number of particles having a large particle size. In this way, a main particle size (for example, a half or more) of the mist supplied from the mist supply unit 10 can be measured. The Sauter mean particle size H of the mist supplied from the mist device 1 in the present embodiment is 3.1 μm or more and 10 μm or less.

By changing an output of the ultrasonic vibrator 18 of the mist generation unit 8, changing a vibration frequency of the ultrasonic vibrator 18 or changing the mist generation means to the centrifuge or the like, the Sauter mean particle size H of the mist can be changed. For example, the Sauter mean particle size H of the mist supplied from the mist supply unit 10 can be changed and set in a range of 3.1 μm or more and 40 μm or less.

Next, with reference to FIG. 30, description will be made as to a determining device and a determining method for determining whether or not the mist is in the retained state (whether or not the mist retention layer C is formed) in the retaining space 4 of the bathtub body 6.

As shown in FIG. 30, the internal transmittance measured in the retaining space 4 of the bathtub body 6 and the external transmittance measured outside the retaining space 4 by use of a transmittance measuring device 68 are compared, and when the internal transmittance is lower than the external transmittance, it can be determined that the mist is retained in the retaining space 4. More specifically, when the internal transmittance/the external transmittance<1, it is determined that the mist is retained in the retaining space 4.

For example, in the state where the mist is retained in the retaining space 4 as shown in FIG. 15, the internal transmittance decreases. On the other hand, the mist stays mainly in the retaining space 4, and the external transmittance measured above the retaining boundary surface 66 indicates a relatively high value. Therefore, the internal transmittance/the external transmittance<1, and it is determined that the mist is retained in the retaining space 4. In addition, when the internal transmittance is in a range of 15% or less, it may be determined that the mist is retained in the retaining space 4.

Next, the transmittance measuring device 68 will be described with reference to FIG. 30.

It can be determined whether the retained state is formed, by placing the transmittance measuring device 68 in the bathtub body 6. The transmittance measuring device 68 includes a first laser device 70 including a measuring unit disposed in the retaining space 4, and a first transmittance measuring device 72 that receives laser. The first laser device 70 and the first transmittance measuring device 72 are arranged 150 mm away from each other in a horizontal direction at a position of 150 mm below an upper end of the retaining space 4 (for example, a depth position of about 30% with respect to a depth of the retaining space 4). The first laser device 70 and the first transmittance measuring device 72 are arranged in the vicinity of a center of the retaining space 4 in the top view. With respect to an intensity of the laser light oscillated from the first laser device 70, the intensity of the laser light measured with the first transmittance measuring device 72 is measured, to measure the internal transmittance.

The transmittance measuring device 68 further includes a second laser device 74 disposed outside the retaining space 4, and a second transmittance measuring device 76 that receives laser. The second laser device 74 and the second transmittance measuring device 76 are arranged away from each other in the horizontal direction at a position of 150 mm above the upper end of the retaining space 4 (for example, a position assumed to be above the retaining boundary surface 66 at an upper end of the retention layer C). The second laser device 74 and the second transmittance measuring device 76 are arranged in the vicinity of the center of the retaining space 4 in the top view. With respect to an intensity of the laser light oscillated from the second laser device 74, the intensity of the laser light measured with the second transmittance measuring device 76 is measured, to measure the external transmittance. Thus, the internal transmittance in the retaining space 4 and the external transmittance can be measured, respectively.

As a more specific device configuration of the measuring device 68, the laser light emitted from digital fiber amplifier FS-N11MN manufactured by Keyence Corporation is oscillated through FU-77TZ manufactured by the same company (first laser device 70 or second laser device 74) and received with FU-77TZ (first transmittance measuring device 72 or second transmittance measuring device 76) manufactured by the same company. The received light is returned to the fiber amplifier FS-N11MN, and a voltage of, for example, 1-5 V is output depending on an amount of light. The amount of light is, for example, from 1500 to 4500. The output voltage is measured with NR-HA08 in NR-500 series manufactured by the same company and scaled to a value of 0 to 100% on the PC. The transmittance data is measured, for example, in a sampling period of 100 ms. For example, after the mist starts to be almost quantitatively supplied and the retention layer C is formed, then, for example, the transmittance data for 30 seconds is averaged and calculated. For example, when determining and measuring a rising cloud state of the mist, the averaging calculation is not performed, and determination is made with the data over time.

Next, the effect of the configuration of the present embodiment will be described.

In one embodiment of the present invention including this configuration, the mist generation unit 8 includes the mist supply flow rate decrease suppression part 40 that suppresses the decrease in amount of the mist generated. Thereby, the decrease in amount of the mist generated to be retained in the retaining space 4 can be suppressed, and the retaining space 4 can be easily maintained in the state where the mist is retained therein.

In one embodiment of the present invention including the configuration, the mist generation unit 8 includes, as the mist supply flow rate decrease suppression part 40, the heater 20 that suppresses the drop in temperature of the water in the water storage part 12. Thereby, the drop in temperature of the water in the water storage part 12 can be suppressed, and the decrease in amount of the mist generated from the water in the water storage part 12 can be suppressed. Therefore, the decrease in amount of the mist generated can be suppressed and the decrease in amount of the mist supplied can be suppressed, so that the retaining space 4 can be easily maintained in the state where the mist is retained therein. If the temperature of the water in the water storage part 12 drops, for the same output of the ultrasonic vibrator 18, the amount of the mist generated from the water in the water storage part 12 decreases, and the amount of the mist supplied to the retaining space 4 decreases, which makes it difficult to maintain the retaining space 4 in the state where the mist is retained therein. According to the configuration of the present embodiment, this situation can be suppressed.

In one embodiment of the present invention including this configuration, the wall part 42 is formed so that the rippling due to the water supplied to the water supply side part 12a is less likely to be transmitted to the mist generation side part 12b. Thereby, the rippling due to the water supplied to the water supply side part 12a can be less likely to be transmitted to a mist generation unit 8 side, and it is possible to suppress the decrease in amount of the mist generated from the water in the mist generation side part 12b due to disturbance of the water surface in the mist generation side part 12b. Also, the wall part 42 inhibits the rippling from being easily transmitted to the mist generation unit 8 side, and the wall part 42 can inhibit the temperature of the water supplied to the water supply side part 12a from being easily transmitted to the mist generation unit 8 side, so that the drop in temperature of the water in the mist generation side part 12b can be suppressed, and the amount of the mist generated from the water in the water storage part 12 can be further inhibited from being decreased. Therefore, the decrease in amount of the mist generated can be further suppressed, and the decrease in amount of the mist supplied can be further suppressed, so that the retaining space 4 can be easily maintained in the state where the mist is retained therein.

In one embodiment of the present invention including this configuration, the volume of the water up to the water supply prescribed water level Q1 in the mist generation side part 12b is larger than the volume of the water up to the water supply prescribed water level Q1 in the water supply side part 12a. Consequently, the water in the mist generation side part 12b can be hardly affected by the drop in temperature of water in the mist generation side part 12b due to the cooling of the water on the mist generation side part 12b side with the generation of the mist in the mist generation side part 12b. Also, if water at a relatively low temperature is supplied to the water supply side part 12a during the water supply, the water on the mist generation side part 12b side can be hardly cooled, and the water in the mist generation side part 12b can be hardly affected by the drop in temperature.

In one embodiment of the present invention including this configuration, the heater 20 of the mist generation unit 8 is provided in at least the mist generation side part 12b. Thereby, it is possible to easily suppress the drop in temperature of the water in the mist generation side part 12b due to the cooling of the water on the mist generation side part 12b side with the generation of the mist in the mist generation side part 12b.

In one embodiment of the present invention including this configuration, the heater 20 of the mist generation unit 8 extends from the mist generation side part 12b to the water supply side part 12a. Thereby, the water supplied to the water supply side part 12a during the water supply can be heated from the water supply side part 12a by the heater 20. Therefore, the water on the mist generation side part 12b side can be hardly cooled by the water supplied to the water supply side part 12a during the water supply, and the water in the mist generation side part 12b can be hardly affected by the drop in temperature.

In one embodiment of the present invention including this configuration, the plurality of ultrasonic vibrators 18 are arranged, and the heater 20 extends in the arrangement direction of the plurality of ultrasonic vibrators 18. This can reduce unevenness in temperature of water around the plurality of ultrasonic vibrators 18 in the mist generation side part 12b. Therefore, the temperature of the water in the mist generation side part 12b can be entirely raised, and the mist generation efficiency can be increased.

In one embodiment of the present invention including this configuration, the wall part 42 is formed so that the rippling due to the water supplied to the water supply side part 12a is less likely to be transmitted to the mist generation side part 12b. Thereby, the rippling due to the water supplied to the water supply side part 12a can be less likely to be transmitted to the mist generation unit 8 side, and it is possible to suppress the decrease in amount of the mist generated from the water in the mist generation side part 12b due to the disturbance of the water surface in the mist generation side part 12b. Therefore, the decrease in amount of the mist generated can be further suppressed, and the decrease in amount of the mist supplied can be further suppressed, so that the retaining space 4 can be easily maintained in the state where the mist is retained therein.

Further, one embodiment of the present invention provides the water section equipment including the mist device of the embodiment of the present invention, and the bathtub body 6 that forms the retaining space 4 accepting the mist supplied from the mist supply unit 10 of the mist device 1.

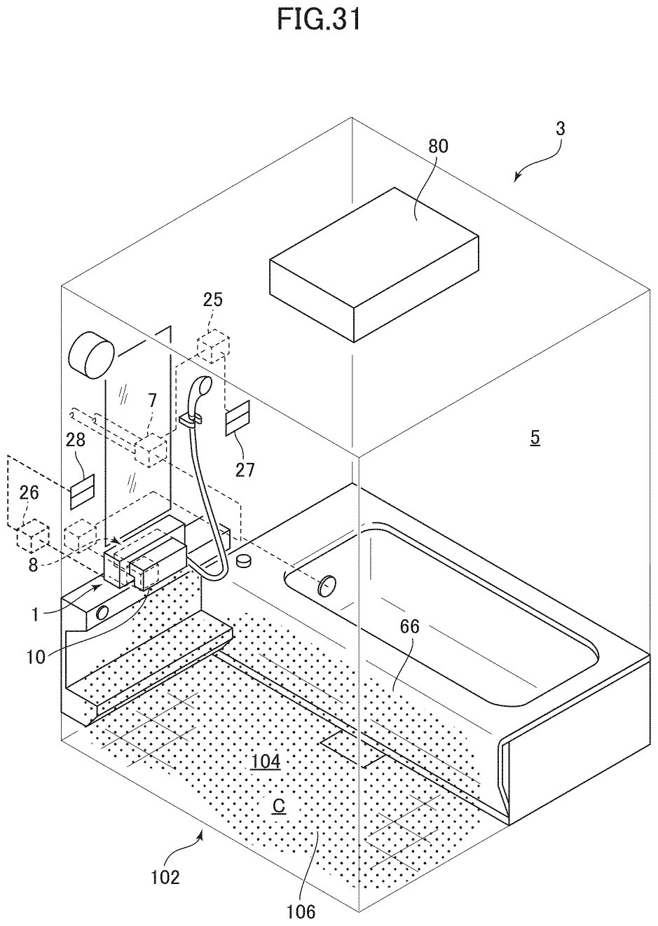

Next, with reference to FIG. 31, a wash place floor apparatus that is water receiving equipment (water section equipment) including a mist device according to a second embodiment of the present invention will be described. The second embodiment illustrates an example of applying the mist device according to the present invention to a wash place floor of a bathroom, FIG. 31 is a perspective view of the wash place floor apparatus including the mist device according to the second embodiment of the present invention.

The mist device according to the second embodiment includes a basic structure similar to that of the mist device according to the first embodiment described above, and hence only points of the second embodiment of the present invention that are different from the first embodiment will be described. Similar portions are denoted with the same reference signs or are not shown in the drawing and are not described. An operation (action) of the wash place floor apparatus, each measuring method and the like according to the second embodiment of the present invention are the same as the operation (action) of the mist system, each measuring method and the like according to the first embodiment and are not accordingly described.

As shown in FIG. 31, a wash place floor apparatus 102 that is water receiving equipment including a mist device 1 according to the second embodiment of the present invention is provided in a bathroom 3. The wash place floor apparatus 102 is provided with a supply device 7 that supplies water. The wash place floor apparatus 102 further includes a wash place floor body 106 that forms a retaining space 104 that accepts mist supplied from an after-mentioned mist supply unit 10 of the mist device 1. The wash place floor apparatus 102 is the water receiving equipment including a water receiving part that receives discharged water. A configuration of the mist device 1 is similar to the first embodiment, and hence an internal structure and the like of the mist device 1 are not shown in the drawing.

The wash place floor body 106 forms the retaining space 104 having an upper part opened toward a room space 5 in which the wash place floor apparatus 102 is used. The wash place floor body 106 is formed by a wall surface of the bathroom, an outer wall of a bathtub body, a door of the bathroom and others, and water can flow into the inner retaining space 104. According to this structure, in the wash place floor body 106, the mist is retained in the retaining space 104. A volume of the wash place floor body 106 is larger than a volume of a bathtub body 6. The retaining space 104 is formed, for example, up to an upper end portion of the bathtub body 6 that defines a wall of the wash place floor body 106.

The mist device 1 is for use in the wash place floor apparatus 102 that is the water receiving equipment. The mist device 1 includes a mist generation unit 8 and a mist supply unit 10. In the wash place floor apparatus 102 in which the mist device 1 is used, the mist supplied from the mist supply unit 10 is retained in the retaining space 104 of the wash place floor body 106. FIG. 31 illustrates a mist retention layer C that forms a retaining boundary surface 66 on an upper surface.

According to the structure of the second embodiment including this configuration, heated mist is retained in the retaining space 104 of the wash place floor body 106. For example, the heated mist can warm the wash place floor body 106 and heat the wash place floor and the retaining space 104. Also, the heated mist allows a user to take a mist bath in the retaining space 104. Furthermore, for example, with the heated mist, the wash place floor body 106 can be warmed, dirt adhered to the wash place floor body 106 can be cleaned with a relatively high cleaning performance, or the dirt can be easily removed.

The mist generation unit 8 of the mist device 1 includes a mist supply flow rate decrease suppression part 40 that suppresses a drop in temperature of the water in a water storage part 12. Thus, the mist supply flow rate decrease suppression part 40 of the mist generation unit 8 can suppress a decrease in amount of mist generated. Therefore, the retaining space 104 can be easily maintained in a state where the mist is retained therein.

Further, one embodiment of the present invention provides water receiving equipment, and the equipment includes a mist device of one embodiment of the present invention, and the wash place floor body 106 that forms the retaining space 104 accepting the mist supplied from the mist supply unit 10 of the mist device 1.

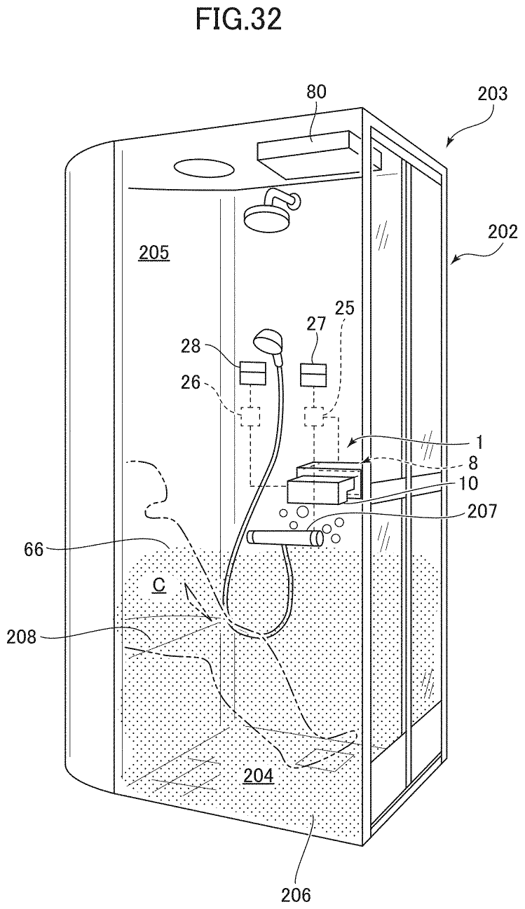

Next, with reference to FIG. 32, a shower room apparatus that is water receiving equipment (water section equipment) including a mist device according to a third embodiment of the present invention will be described. The third embodiment is an example of applying, to a shower room, the mist device according to the present invention. FIG. 32 is a perspective view of the shower room apparatus including the mist device according to the third embodiment of the present invention.

The mist device according to the third embodiment includes a basic structure similar to that of the mist device according to the first embodiment described above, and hence only points of the third embodiment of the present invention that are different from the first embodiment will be described. Similar portions are denoted with the same reference signs in the drawings or are not shown in the drawing and are not described. An operation (action) of the shower room apparatus, each measuring method and the like according to the third embodiment of the present invention are the same as the operation (action) of the mist system, each measuring method and the like according to the first embodiment and are not accordingly described.

As shown in FIG. 32, a shower room apparatus 202 that is water receiving equipment including a mist device 1 according to the third embodiment of the present invention is provided in a shower room 203. The shower room 203 is formed into a shape in which a semicircular region is added to a rectangular region having one side of about 0.8 m to 2 m in a top view and forms a relatively narrow space indoors. The shower room apparatus 202 includes a supply device 207 that supplies water. The shower room apparatus 202 further includes a shower room body 206 that forms a retaining space 204 accepting mist supplied from an after-mentioned mist supply unit 10 of the mist device 1. The shower room apparatus 202 is the water receiving equipment including a water receiving part that receives discharged water. Since a configuration of the mist device 1 is the same as that of the first embodiment, an internal structure of the mist device 1 and the like are not shown in the drawing. The shower room 203 is not limited to a room where the supply device 207 for shower is only disposed, and may be provided with a toilet, handwash equipment, a washstand, or a combination thereof.

The shower room body 206 forms the retaining space 204 having an upper part opened toward a room space 205 in which the shower room apparatus 202 is used. The shower room body 206 is formed by a wall surface of the shower room, a door of the shower room and the like, and water can flow into the inner retaining space 204. According to this structure, in the shower room body 206, mist is retained in the retaining space 204. In addition, according to the present embodiment, even if a boundary between the room space 205 and the retaining space 204 of the shower room 203 is not structurally clearly divided, the retaining space 204 can be defined. The boundary between the room space 205 and the retaining space 204 is set at a different position in consideration of a mist supply capacity of the mist device 1. The retaining space 204 can be arbitrarily set as a space to store mist in consideration of the mist supply capacity of the mist device 1. The retaining space 204 is a retaining space having an upper part opened toward the room space 205. Note that this configuration is not limited to the present embodiment, and even if the boundary between the room space 205 and the retaining space 204 is not clearly divided by the structure, the retaining space 204 may be set to the same effect. The retaining space 204 is formed, for example, approximately up to a height of a seated user's face (or, for example, a height of about one-third of an entire height of an internal space of the shower room).

The mist device 1 is for use in the shower room apparatus 202. The mist device 1 includes a mist generation unit 8 and the mist supply unit 10. The mist generation unit 8 and the mist supply unit 10 are configured so that a temperature difference between a temperature of mist supplied from the mist supply unit 10 to the retaining space 204 and a temperature of the room where the water section equipment is used before start of mist supply is 0° C. or more, and the mist supplied from the mist supply unit 10 is retained in the retaining space 204 of the shower room body 206. FIG. 32 illustrates a mist retention layer C that forms a retaining boundary surface 66 on an upper surface.

According to the structure of the third embodiment thus configured, heated mist is retained in the retaining space 204 of the shower room body 206. For example, the shower room body 206 can be warmed with the heated mist to heat a floor in the shower room and the retaining space 204. Also, the heated mist allows the user to take a mist bath in the retaining space 204. In addition, the heated mist is retained up to a relatively high position, so that the user can take a mist bath even in a seated state on an internal chair 208 or a standing state in the retaining space 204. For example, with the heated mist, the shower room body 206 is warmed, and dirt adhered to the shower room body 206 can be cleaned with a relatively high cleaning performance, or the dirt can be easily removed.

The mist generation unit 8 of the mist device 1 includes a mist supply flow rate decrease suppression part 40 that suppresses a drop in temperature of water in a water storage part 12. Thereby, the mist supply flow rate decrease suppression part 40 of the mist generation unit 8 can suppress a decrease in amount of mist generated. Therefore, the retaining space 204 can be easily maintained in a state where the mist is retained therein.

Further, one embodiment of the present invention provides the water receiving equipment, and the equipment includes the mist device of one embodiment of the present invention, and the shower room body 206 that forms the retaining space 204 accepting the mist supplied from the mist supply unit 10 of the mist device 1.

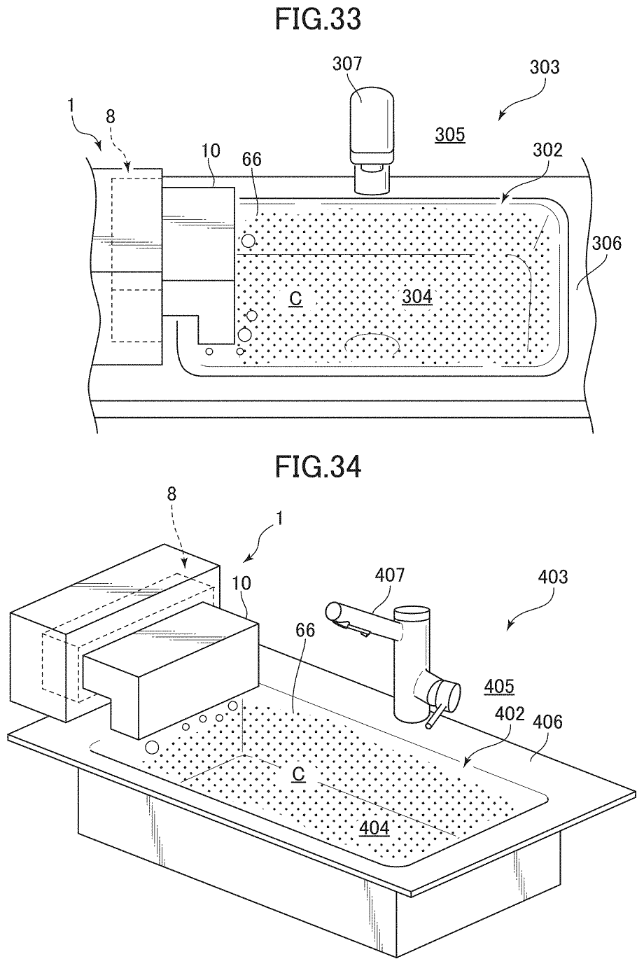

Next, with reference to FIG. 33, a washbasin apparatus that is water receiving equipment (water section equipment) including a mist device according to a fourth embodiment of the present invention will be described. The fourth embodiment illustrates an example of applying the mist device according to the present invention to the washbasin apparatus. FIG. 33 is a perspective view of the washbasin apparatus including the mist device according to the fourth embodiment of the present invention.

The mist device according to the fourth embodiment includes a basic structure similar to that of the mist device according to the first embodiment described above, and hence only points of the fourth embodiment of the present invention that are different from the first embodiment will be described. Similar portions are denoted with the same reference signs in the drawing or are not shown in the drawing and are not described. An operation (action) of the washbasin apparatus, each measuring method and the like according to the fourth embodiment of the present invention are the same as the operation (action) of the mist system, each measuring method and the like according to the first embodiment and are not accordingly described.

As shown in FIG. 33, a washbasin apparatus 302 that is water receiving equipment including a mist device 1 according to the fourth embodiment of the present invention is provided on a counter or the like in a washroom 303. The washbasin apparatus 302 is provided with a supply device 307 that supplies water. The washbasin apparatus 302 further includes a washbasin body 306 that forms a retaining space 304 accepting mist supplied from an after-mentioned mist supply unit 10 of the mist device 1. The washbasin apparatus 302 is water receiving equipment including a water receiving part that receives discharged water. Since a configuration of the mist device 1 is the same as that of the first embodiment, an internal structure of the mist device 1 and the like are not shown in the drawing. Also, a water supply controller 25 connected to the supply device 307, an operation unit 27 connected to the water supply controller 25 and the like are similarly arranged and are not shown in the drawing. Further, a mist device controller 26 in the mist device 1, a mist device operation unit 28 connected to the mist device controller 26 and the like are similarly arranged and are not shown in the drawing.

The washbasin body 306 forms the retaining space 304 having an upper part opened toward a room space 305 in which the washbasin apparatus 302 is used. In the washbasin body 306, water can be stored in the inner retaining space 304. According to this structure, in the washbasin body 306, mist is retained in the retaining space 304. The retaining space 304 is formed to an upper end portion of the washbasin body 306.

The mist device 1 is for use in the washbasin apparatus 302. The mist device 1 includes a mist generation unit 8 and the mist supply unit 10. The mist generation unit 8 and the mist supply unit 10 are configured so that a temperature difference between a temperature of mist supplied from the mist supply unit 10 to the retaining space 304 and a temperature of the room where the water section equipment is used before start of mist supply is 0° C. or more, and the mist supplied from the mist supply unit 10 is retained in the retaining space 304 of the washbasin body 306. FIG. 33 illustrates a mist retention layer C that forms a retaining boundary surface 66 on an upper surface.

According to the structure of the fourth embodiment thus configured, heated mist is retained in the retaining space 304 of the washbasin body 306. For example, the heated mist is retained in the retaining space 304 of the washbasin body 306, and a user exposes a part of a body such as a face, a hand, a foot or the like to the mist, so that moisturizing, improved cleansing performance, warm-bathing, beauty effect and the like can be obtained. Also, with the heated mist, the user can take a mist bath of a part of the body in the retaining space 304. For example, with the heated mist, the washbasin body 306 is warmed, and dirt adhered to the retaining space 304 of the washbasin body 306 can be cleaned with a relatively high cleaning performance, or the dirt can be easily removed.

The mist generation unit 8 of the mist device 1 includes a mist supply flow rate decrease suppression part 40 that suppresses a drop in temperature of water in a water storage part 12. Thereby, the mist supply flow rate decrease suppression part 40 of the mist generation unit 8 can suppress a decrease in amount of mist generated. Therefore, the retaining space 304 can be easily maintained in a state where the mist is retained therein.

Further, one embodiment of the present invention provides the water receiving equipment, and the equipment includes the mist device of one embodiment of the present invention, and the washbasin body 306 that forms the retaining space 304 accepting the mist supplied from the mist supply unit 10 of the mist device 1.

Next, with reference to FIG. 34, a kitchen sink apparatus that is water receiving equipment (water section equipment) including a mist device according to a fifth embodiment of the present invention will be described. The fifth embodiment is an example of applying the mist device according to the present invention to the kitchen sink apparatus. FIG. 34 is a perspective view of the kitchen sink apparatus including the mist device according to the fifth embodiment of the present invention.

The mist device according to the fifth embodiment includes a basic structure similar to that of the mist device according to the first embodiment described above, and hence only points of the fifth embodiment of the present invention that are different from the first embodiment will be described. Similar portions are denoted with the same reference signs in the drawing or are not shown in the drawing and are not described. An operation (action) of the kitchen sink apparatus, each measuring method and the like according to the fifth embodiment of the present invention are the same as the operation (action) of the mist system, each measuring method and the like according to the first embodiment and are not accordingly described.

As shown in FIG. 34, a kitchen sink apparatus 402 that is water section equipment including a mist device 1 according to the fifth embodiment of the present invention is provided in a washroom (kitchen) 403. The kitchen sink apparatus 402 is provided with a supply device 407 that supplies water. The kitchen sink apparatus 402 further includes a kitchen sink body 406 that forms a retaining space 404 accepting mist supplied from an after-mentioned mist supply unit 10 of the mist device 1. The kitchen sink apparatus 402 is water receiving equipment including a water receiving part that receives discharged water. Since a configuration of the mist device 1 is the same as that of the first embodiment, an internal structure of the mist device 1 and the like are not shown in the drawing. Also, a water supply controller 25 connected to the supply device 407, an operation unit 27 connected to the water supply controller 25 and the like are similarly arranged and are not shown in the drawing. Further, a mist device controller 26 in the mist device 1, a mist device operation unit 28 connected to the mist device controller 26 and the like are similarly arranged and are not shown in the drawing.

The kitchen sink body 406 forms the retaining space 404 having an upper part opened toward a room space 405 in which the kitchen sink apparatus 402 is used. In the kitchen sink body 406, water can be stored in the inner retaining space 404. According to this structure, in the kitchen sink body 406, mist is retained in the retaining space 404. The retaining space 404 is formed to an upper end portion of the kitchen sink body 406.

The mist device 1 is for use in the kitchen sink apparatus 402. The mist device 1 includes a mist generation unit 8 and the mist supply unit 10. The mist generation unit 8 and the mist supply unit 10 are configured so that a temperature difference between a temperature of mist supplied from the mist supply unit 10 to the retaining space 404 and a temperature of the room where the water section equipment is used before start of mist supply is 0° C. or more, and the mist supplied from the mist supply unit 10 is retained in the retaining space 404 of the kitchen sink body 406. FIG. 34 illustrates a mist retention layer C that forms a retaining boundary surface 66 on an upper surface.

According to the structure of the fifth embodiment thus configured, heated mist is retained in the retaining space 404 of the kitchen sink body 406. For example, the heated mist is retained in the retaining space 404 of the kitchen sink body 406, and tableware, equipment to be washed or the like is exposed to the mist, so that an object to be washed can be warmed, and adhered dirt can be cleaned with a relatively high cleaning performance. Also, when the heated mist is applied to the object to be washed, the object cannot be cleaned, but dirt can be easily removed. Also, the heated mist can be retained in the retaining space 404 of the kitchen sink body 406, and a user can work while warming user's hands and fingers in the kitchen sink body 406. For example, with the heated mist, the kitchen sink body 406 can be warmed, and dirt adhered to the retaining space 404 of the kitchen sink body 406 can be cleaned with a relatively high cleaning performance, or the dirt can be easily removed.

The mist generation unit 8 of the mist device 1 includes a mist supply flow rate decrease suppression part 40 that suppresses a drop in temperature of water in a water storage part 12. Thereby, the mist supply flow rate decrease suppression part 40 of the mist generation unit 8 can suppress a decrease in amount of mist generated. Therefore, the retaining space 404 can be easily maintained in a state where the mist is retained therein.

Further, one embodiment of the present invention provides the water receiving equipment, and the equipment includes the mist device of one embodiment of the present invention, and the kitchen sink body 406 that forms the retaining space 404 accepting the mist supplied from the mist supply unit 10 of the mist device 1.

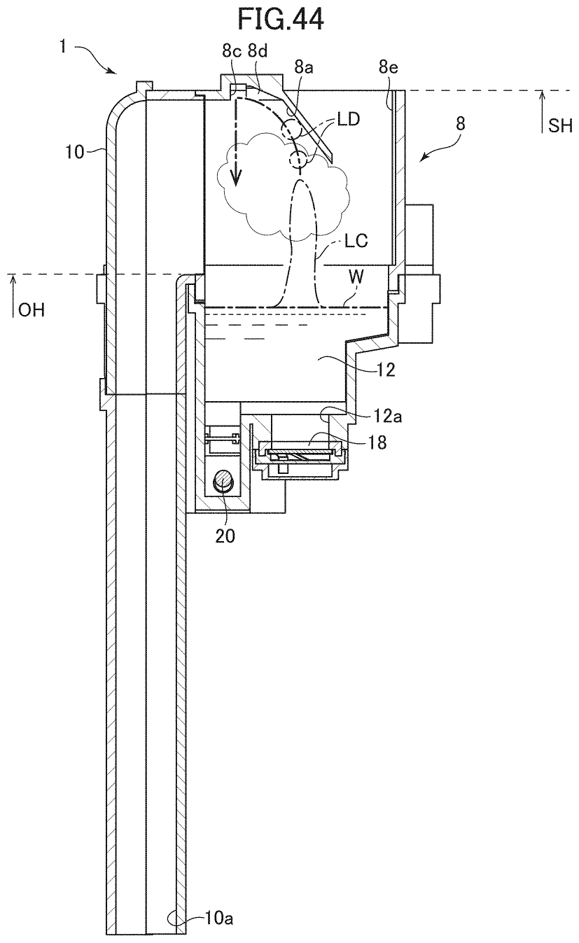

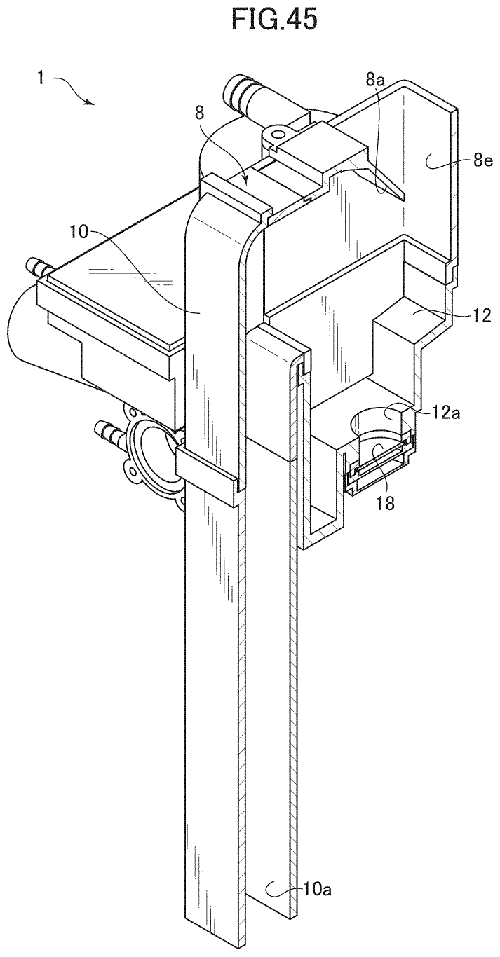

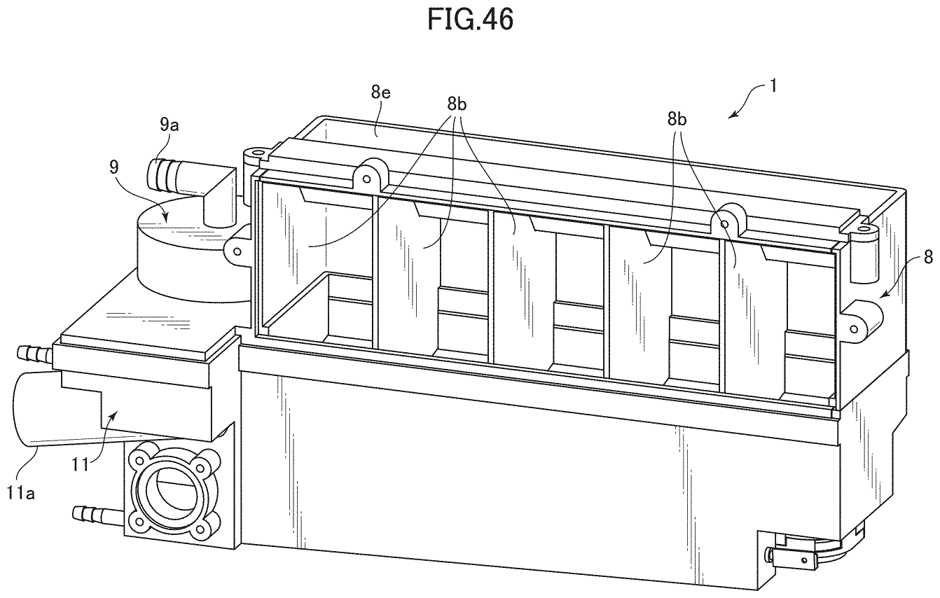

Next, with reference to FIGS. 44 to 50, a mist supply flow rate decrease suppression part of a mist generation unit of a mist device according to a sixth embodiment of the present invention will be described.

The mist device according to the sixth embodiment includes a basic structure similar to that of the mist device according to the first embodiment described above, and hence only points of the sixth embodiment of the present invention that are different from the first embodiment will be described. Similar portions are denoted with the same reference signs in the drawings or are not shown in the drawings and are not described. An operation (action) of the mist device, each measuring method and the like according to the sixth embodiment of the present invention are the same as the operation (action) of the mist device, each measuring method and the like according to the first embodiment and are not accordingly described.

An overflow portion 11c of a mist generation unit 8 functions as a mist supply flow rate decrease suppression part 40 and sets a water level of water introduced into a tank 12 via a water supply valve to an overflow water level.

Next, with reference to FIGS. 44 to 50, a specific structure of the mist generation unit 8 and a mist supply unit 10 of a mist device 1 according to the sixth embodiment of the present invention will be described.

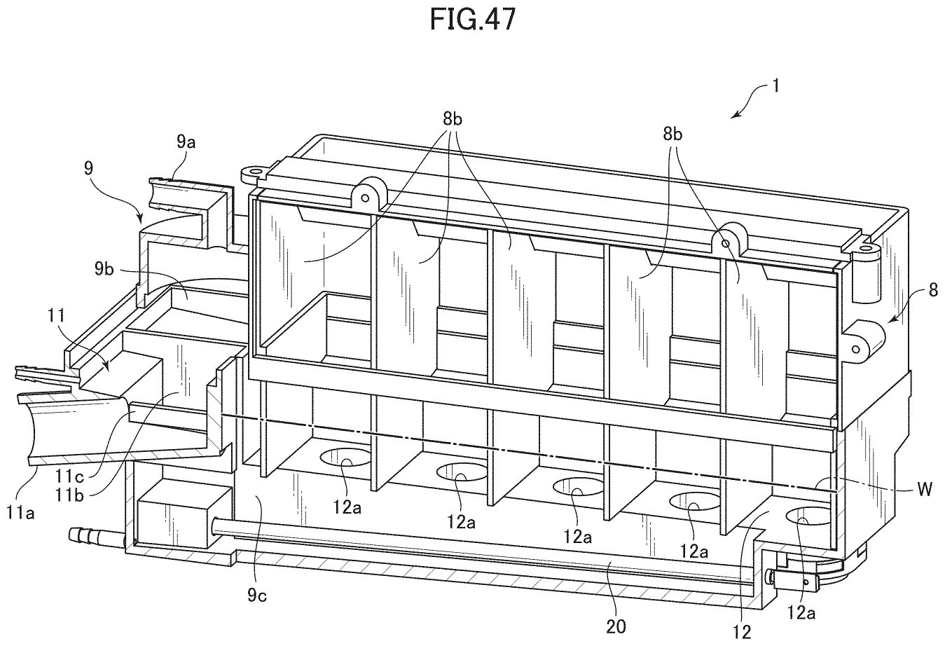

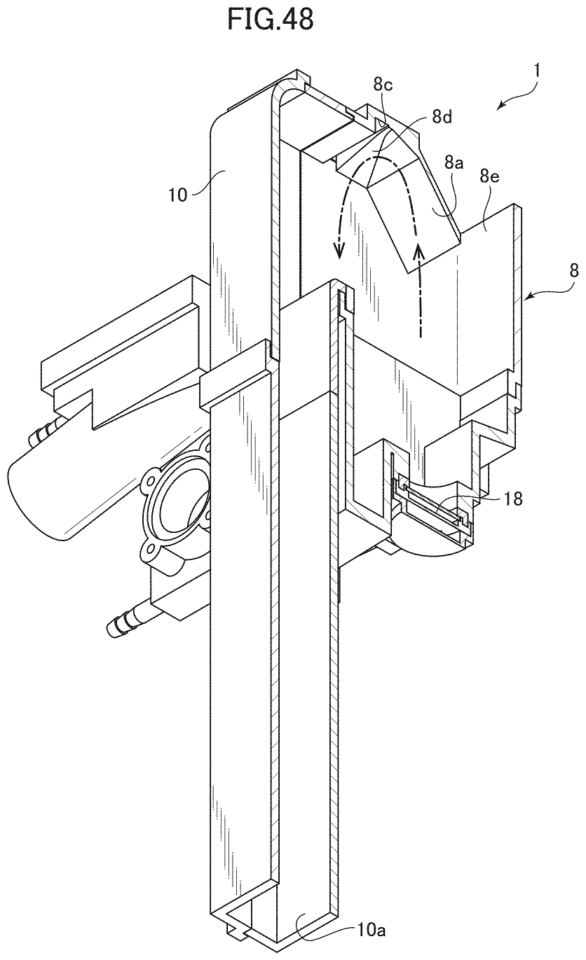

FIG. 44 is a longitudinal cross-sectional view of the mist generation unit 8 and the mist discharge passage 10 in the mist device 1 according to the present embodiment. FIG. 45 is a perspective cross-sectional view of the mist generation unit 8 and the mist supply unit 10. FIG. 46 is a perspective view showing the mist generation unit body 8 in a state where the mist supply unit 10 is removed. FIG. 47 is a perspective cross-sectional view showing an internal structure of the mist generation unit 8. FIG. 48 is a perspective cross-sectional view of the mist generation unit 8 and the mist supply unit 10 as seen obliquely from below.

As shown in FIGS. 44 and 45, the mist generation unit 8 of the mist device 1 is formed into a generally rectangular parallelepiped box shape, and in a lower part of the unit, a tank 12 that is the water storage part in which water to be misted is stored is provided. In a bottom of the tank 12, a concave portion 12a is provided, and in a bottom surface of the concave portion 12a, an ultrasonic vibrator 18 is mounted in a vertically upward orientation. According to this structure, the ultrasonic vibrator 18 irradiates, with ultrasonic waves, a water surface W of water stored in the tank 12, and a liquid column LC is formed on the water surface W vertically above the ultrasonic vibrator 18. Thus, the liquid column LC is formed on the water surface W of the tank 12 by the irradiation with ultrasonic waves, and mist is generated around the liquid column LC in an internal space of the mist generation unit 8.

As shown in FIG. 47, five concave portions 12a are arranged in a longitudinal direction of the mist generation unit 8 in a bottom portion of the tank 12, and ultrasonic vibrators 18 are provided in bottoms of the concave portions 12a, respectively. Specifically, in the bottom portion of the mist generation unit 8, five ultrasonic vibrators 18 are arranged in line. Further, between the respective concave portions 12a (ultrasonic vibrators 18), a partition wall 8b extending in a short side direction and dividing an interior of the mist generation unit body 8 is provided. Furthermore, in the bottom of the tank 12, a heater 20 is disposed to extend in the longitudinal direction of the mist generation unit 8. The heater 20 is disposed to extend parallel to an arrangement direction of the five ultrasonic vibrators 18. When the mist device 1 is operated, the water in the tank 12 is heated to a predetermined temperature with the heater 20.

Furthermore, as shown in FIG. 44, an opening is provided in an upper portion of one side surface of the mist generation unit 8, and the mist supply unit 10 is attached to cover the opening. The mist supply unit 10 includes a duct having a substantially rectangular cross section, which is attached to one side surface of the mist generation unit 8 and that extends vertically downward from the mist generation unit 8. The mist supply unit 10 has an upper end portion communicating with the interior of the mist generation unit 8 in the side surface, and has a lower end provided with a mist discharge port 10a directed vertically downward. Thereby, the mist generated in the internal space of the mist generation unit 8 flows into the mist supply unit 10 and is discharged from the mist discharge port 10a at the lower end of the mist supply unit 10.

On the other hand, an intake passage 8e is provided in an upper end of the mist generation unit 8 opposite to the mist supply unit 10. The intake passage 8e is formed in an upper surface of the mist generation unit 8 and opened vertically upward. Specifically, the internal space of the mist generation unit 8 communicates with outside air via the intake passage 8e. The intake passage 8e is provided in the upper surface of the mist generation unit 8, and a ceiling surface 8a is formed on a portion vertically above the ultrasonic vibrator 18. The ceiling surface 8a is inclined so as to be high on a side of the mist supply unit 10 in the mist generation unit 8 and low on a side of the intake passage 8e. Specifically, the ceiling surface 8a is configured to be inclined in the portion in which the liquid column LC is formed vertically above the ultrasonic vibrator 18 and is generally directed horizontally in the vicinity of the mist supply unit 10. Due to the inclination of the ceiling surface 8a, the mist generated in the mist generation unit 8 is guided toward the mist supply unit 10.

In addition, a step is provided between the inclined portion of the ceiling surface 8a and the portion that is generally directed horizontally, and this step forms a damming portion 8c. Specifically, when the liquid column LC formed on the water surface W and a liquid droplet LD separated from the liquid column LC strike the inclined ceiling surface 8a and water droplets adhere to the ceiling surface 8a, the damming portion 8c prevents the adhered water droplets from flowing toward the mist supply unit 10 (shown with an imaginary line in FIG. 44).

Furthermore, as shown in FIG. 48, a portion of the ceiling surface 8a that is adjacent to the damming portion 8c is provided with a guide wall portion 8d formed in a generally dome shape. The guide wall portion 8d is formed into a dome shape with a raised central portion and provided above each ultrasonic vibrator 18. Specifically, the water dammed by the damming unit 8c flows left and right along the guide wall portion 8d and flows through an inner wall surface of the mist generation unit 8 and the partition wall 8b (FIG. 47) into the tank 12 (shown with an imaginary line in FIG. 48). The water flowing down from the damming portion 8c along the partition wall 8b flows down between the ultrasonic vibrators 18 to inhibit the flowing water from interfering with the formation of the liquid column LC.

Next, as shown in FIGS. 46 and 47, a water supply part 9 and a discharge part 11 are provided in one end portion of the mist generation unit 8. The water supply part 9 includes a water supply channel connecting portion 9a to which a water supply channel 14 (FIG. 3) is connected, and a water supply chamber 9b into which water supplied from the water supply channel connecting portion 9a flows. The water flowing into the water supply chamber 9b flows into the tank 12 in the mist generation unit 8, and as shown in FIG. 47, the water supply chamber 9b and the tank 12 communicate through a lower communication passage 9c of the partition wall 8b provided adjacent to the water supply chamber 9b.

Since a lower end of the partition wall 8b is located below the water surface W of the tank 12, the lower communication passage 9c is always submerged during the operation of the mist generation device 1. Specifically, the water supply chamber 9b of the water supply part 9 communicates into the tank 12 through the lower communication passage 9c below the water surface W of the water storage part 12. Thus, the water supply part 9 communicates into the tank 12 through the lower communication passage 9c below the water surface W of the tank 12. For this reason, when water flows from the water supply channel connecting portion 9a into the water supply chamber 9b, the water surface W in the tank 12 can be inhibited from rippling.

Furthermore, as shown in FIGS. 46 and 47, the discharge part 11 includes a discharge passage connecting portion 11a connected to a discharge passage 16 (FIG. 3), a discharge chamber 11b provided adjacent to the discharge passage connecting portion 11a, and the overflow portion 11c provided between the discharge passage connecting portion 11a and the discharge chamber 11b. The discharge chamber 11b communicates into the tank 12 through a passage (not shown) below the water surface W. Also, the overflow portion 11c is a weir extending horizontally to divide the discharge chamber 11b and the discharge passage connecting portion 11a, and when a water level in the discharge chamber 11b is in excess of a height of the overflow portion 11c, water in the discharge chamber 11b is discharged to the discharge passage connecting portion 11a. Further, since the tank 12 and the discharge chamber 11b communicate through the passage below the water surface W, the highest water level in the tank 12 is prescribed by the height of the overflow portion 11c.

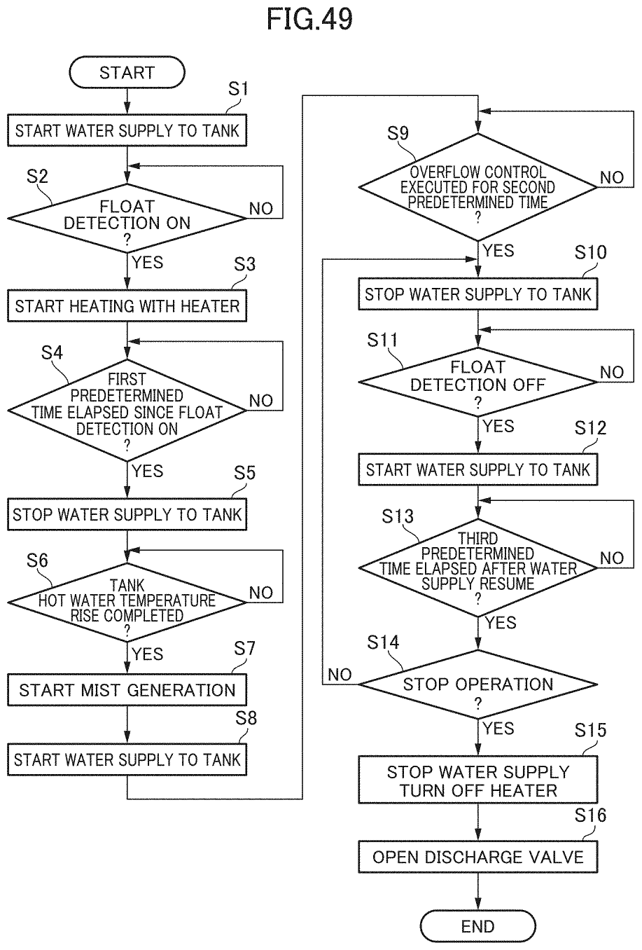

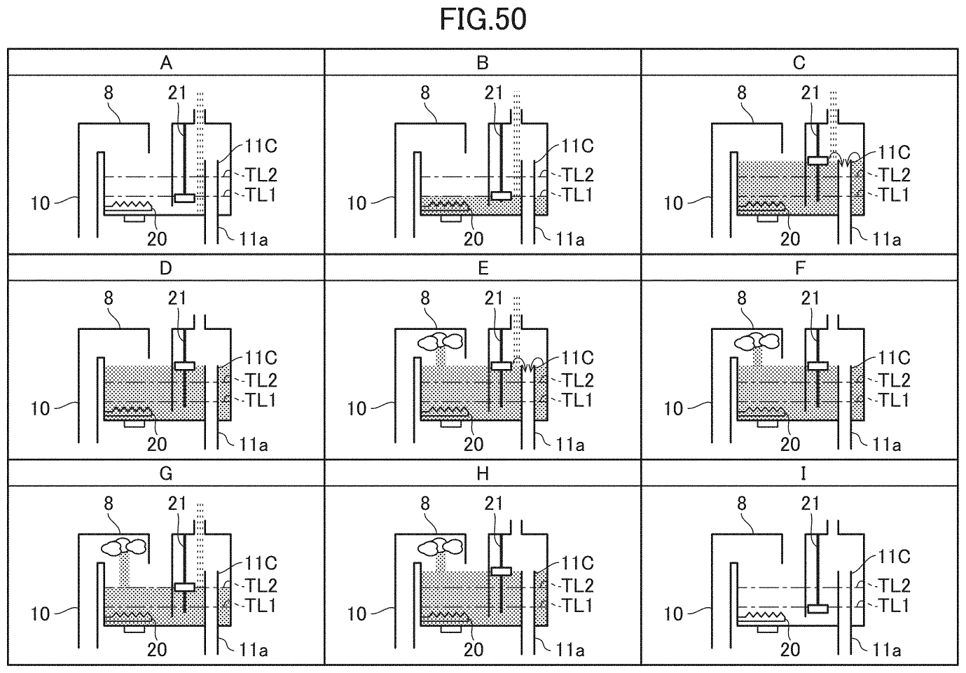

Next, with reference to FIGS. 49 and 50, control of a water supply channel on-off valve 30 by a controller 26 will be described.

FIG. 49 is a flowchart showing a control procedure of the water supply channel on-off valve 30 by the controller 26. FIG. 50 is a diagram showing states in the tank 12 in time series. The flowchart shown in FIG. 49 is executed by the controller 26, when the mist device 1 of the present embodiment is activated.

First, when an activation switch (not shown) of the mist device operation unit 28 (FIG. 1) is operated by the user, processing of the flowchart shown in FIG. 49 is started, and step 51 is executed. In step 51, the controller 26 sends a control signal to the water supply channel on-off valve 30 (FIG. 3) and opens this valve. When the water supply channel on-off valve 30 is opened, as shown in column A of FIG. 50, water passing through the water supply channel on-off valve 30 flows into the tank 12. On an upstream side of the water supply channel on-off valve 30, a fixed flow valve (not shown) is provided, and a flow rate (L/min) of water flowing into the tank 12 via the water supply channel on-off valve 30 is adjusted to a predetermined flow rate. When water flows into the tank 12, the water level in the tank 12 rises.

Next, in step S2, it is determined whether or not a float switch 21 (FIG. 3) detects a first water level TL1. The processing of step S2 is repeatedly executed until the float switch 21 detects the first water level TL1. As shown in column B of FIG. 50, when the water level in the tank 12 rises and the float switch 21 detects the first water level TL1, processing in the flowchart shown in FIG. 49 proceeds to step S3.

In step S3, the controller 26 starts energizing the heater 20 (FIG. 47). Specifically, the first water level TL1 is set to a water level at which the heater 20 disposed in the bottom portion of the tank 12 is sufficiently submerged in the water accumulated in the tank 12, which prevents the heater 20 from causing empty firing. After the float switch 21 detects the first water level TL1, when the water supply further continues, the float switch 21 detects a second water level TL2 higher than the first water level TL1 (column B in FIG. 50).

In step S4, after the float switch 21 detects the second water level TL2, it is determined whether or not a first predetermined time elapses. The processing in step S4 is repeatedly executed until the first predetermined time elapses after the float switch 21 detects the second water level TL2. The first predetermined time is set so that the water level in the tank 12 is in excess of the overflow water level defined by the height of the overflow portion 11c (FIG. 3) before the first predetermined time elapses after the float switch 21 detects the second water level TL2. Specifically, the water level in the tank 12 overflows in excess of the height of the overflow portion 11c as shown in column C of FIG. 50 before the elapse of the first predetermined time, and water is discharged from the discharge passage connecting portion 11a. For example, the second water level TL2 and the water flow rate may be set to ensure that the first predetermined time is about 10 seconds.

After the float switch 21 detects the second water level TL2, when the first predetermined time elapses, step S5 is executed. In step S5, the controller 26 sends a control signal to the water supply channel on-off valve 30 and closes this valve. As a result, the water level in the tank 12 is set to the overflow water level defined by the height of the overflow portion 11c. The height of the water surface W at this overflow water level corresponds to an appropriate water level at which mist can be most efficiently generated when the ultrasonic vibrator 18 is operated.

In the present embodiment, the water supply channel on-off valve 30 is controlled to close when the first predetermined time elapses after the float switch 21 detects the second water level TL2. On the other hand, as a modification, the present invention may be configured to close the water supply channel on-off valve 30 when the predetermined time elapses after the float switch 21 detects the first water level TL1. In this case, the predetermined time until the water supply channel on-off valve 30 is closed is set to be longer than the first predetermined time so that the water level in the tank 12 exceeds the overflow water level.

Next, in step S6, it is determined whether or not the water temperature in the tank 12 reaches a predetermined temperature (for example, 60° C.). Specifically, the controller 26 determines whether or not the water temperature in the tank 12 reaches the predetermined temperature based on a detection signal of the water temperature measuring instrument 22 (FIG. 3). The processing of step S6 is repeatedly executed until the water temperature in the tank 12 reaches the predetermined temperature, and when the predetermined temperature is reached, the processing in the flowchart proceeds to step S7 (column D in FIG. 50). Thereafter, the controller 26 controls the heater 20 during the mist generation, to always maintain the water temperature in the tank 12 near the predetermined temperature.

When the water temperature in the tank 12 reaches the predetermined temperature, the controller 26 executes step S7 to activate the ultrasonic vibrator 18 and starts the mist generation. Next, in step S8, the controller 26 sends a signal to the water supply channel on-off valve 30 and opens this valve. Here, the controller 26 executes overflow control in and after step S7, and in the overflow control, water keeps flowing out beyond the overflow portion 11c. Specifically, when the ultrasonic vibrator 18 is activated in step S7, the mist is generated, and hence the water in the tank 12 begins to reduce. Immediately after this step or at the same time, the controller 26 opens the water supply channel on-off valve 30 and allows water to flow into the tank 12. Here, the flow rate of water flowing in by opening the water supply channel on-off valve 30 is larger than an amount of water reduced by misting the water in the tank 12, and hence during the execution of the overflow control, the water in the tank 12 keeps flowing out from the discharge passage connecting portion 11a beyond the overflow portion 11c (column E in FIG. 50).

During the execution of the overflow control, the water in the tank 12 always keeps overflowing beyond the overflow portion 11c, and hence the water level in the tank 12 is accurately maintained at the overflow water level (height of the overflow portion 11c). Thereby, during the overflow control, the water level in the tank 12 is accurately maintained at the appropriate overflow water level for generating the mist, and hence mist can be most efficiently generated in the mist generation unit 8. For this reason, the mist device 1 can generate mist at a large flow rate immediately after activation, and the mist retaining space 4 in the bathtub body 6 in which mist is not retained can be filled with mist quickly. As a modification, the water supply channel on-off valve 30 is opened immediately before the ultrasonic vibrator 18 is activated, and accordingly the overflow control can be started. Also, in the configuration of the present invention, the overflow from the overflow portion 11c can be substantially continued by controlling the water supply channel on-off valve 30 to repeat opening and closing the valve by little (for example, about several seconds) during the overflow control.

Then, in step S9, it is determined whether or not a second predetermined time elapses after the ultrasonic vibrator 18 is activated and the mist generation is started in step S7, that is, whether or not the second predetermined time elapses after the start of overflow control. When the second predetermined time does not elapse, the processing in step S9 is repeated and the overflow control is continued. For example, the second predetermined time can be set to about three minutes. This second predetermined time may be set to a time for which the retaining space 4 (an interior of the bathtub body 6 in the present embodiment) can be sufficiently filled with mist after the mist device 1 is activated.

When the second predetermined time elapses, the processing in the flowchart proceeds to step S10, and in and after step S10, maintenance control is executed. In the maintenance control, the water level in the tank 12 is maintained in a predetermined range of the overflow water level and less.

In step S10, the controller 26 sends a signal to the water supply channel on-off valve 30 and closes this valve, to stop the water supply (column F in FIG. 50). Since the water supply is stopped, any water does not flow into the tank 12. On the other hand, the ultrasonic vibrator 18 is operated, the mist generation continues, and hence the water level in the tank 12 decreases.

Next, in step S11, it is determined whether or not the float switch 21 detects that the water level in the tank 12 lowers to the second water level TL2. When the water level in the tank 12 lowers to the second water level TL2, the processing proceeds to step S12, and when the water level does not lower, the processing of step S11 is repeated.

As shown in column G of FIG. 50, when the water level in the tank 12 drops to the second water level TL2, in step S12, the controller 26 opens the water supply channel on-off valve 30 and resumes the water supply.

Next, in step S13, after resuming the water supply in step S12, it is determined whether or not a third predetermined time elapses. The processing in step S13 is repeatedly executed until the third predetermined time elapses, and when the third predetermined time elapses, the processing of the flowchart proceeds to step S14. At this time, the water is supplied into the tank 12. The third predetermined time may be set to a time from a state where the water level in the tank 12 lowers to the second water level TL2 to a state where the water level rises close to the overflow water level. Thus, in the maintenance control in and after step S10, the water level in the tank 12 is maintained in a range between the overflow water level and the second water level TL2. Through the maintenance control, the water surface Win the tank 12 is maintained between the overflow water level and the second water level TL2, and hence mist can be relatively efficiently generated by operating the ultrasonic vibrator 18. Also, mist is generated with the highest efficiency by the overflow control, and a sufficient amount of mist is retained in the bathtub body 6. Therefore, even if the mist generation efficiency slightly decreases due to the maintenance control, the bathtub body 6 can be maintained in a state where the mist is sufficiently retained therein.

In practice, even during the maintenance control, the overflow from the overflow portion 11c might occur due to detection error of the second water level TL2 by the float switch 21, error of the flow rate of the water flowing into the tank 12 or the like. However, in the maintenance control, the water supply into the tank 12 is performed to such an extent that a large amount of overflow does not occur, and hence generation of wasted water can be suppressed.

In step S13, it is determined whether or not the third predetermined time elapses, by checking the elapse of time from the resuming of the water supply. However, elapse of time from when the float detection is changed from off to on may be checked. In this case, the predetermined time is set to a time until the water level rises close to the overflow water level.

When the third predetermined time elapses, the processing proceeds to step S14, and in step S14, it is determined whether or not an operation of stopping the mist device 1 is performed by the user. When the user does not perform the stopping operation, the processing returns to step S10 and the water supply into the tank 12 is stopped (column H in FIG. 50). Thereafter, steps S10, S11, S12, S13, S14 and S10 is repeatedly executed until the stopping operation by the user is performed, and the maintenance control continues.

On the other hand, while the maintenance control is continuing, the user performs the operation of stopping the mist device 1, and then the processing in the flowchart shifts from step S14 to S15.

In step S15, the controller 26 sends a control signal to the water supply channel on-off valve 30 to stop the water supply and stops energizing the heater 20.

Next, in step S16, the controller 26 sends a control signal to a discharge passage on-off valve 32 (FIG. 3) and opens this valve, to end the processing of the flowchart shown in FIG. 49. Thereby, the water stored in the tank 12 is discharged through the discharge passage on-off valve 32 to the discharge passage 16, and the mist device 1 returns to the initial state (column I in FIG. 50).

The mist device operation unit 28 (FIG. 1) is provided with a preparation mode setting switch (not shown). When this preparation mode setting switch is operated by the user and a preparation mode is set, the mist device controller 26 opens the water supply channel on-off valve 30 in a state where the ultrasonic vibrator 18 is not operated and allows water to flow out from the overflow portion 11c to set the water level in the tank 12 to the overflow water level. Specifically, when the preparation mode is set, the controller 26 puts the mist device 1 in standby in a state where the flowchart shown in FIG. 49 is executed up to step S6. Next, when the user operates the activation switch of the mist device 1, the processing in and after step S6 is executed, and mist is discharged from the mist device 1. This allows the user to enjoy the mist bath immediately after the activation of the mist device 1, without waiting for the water supply into the tank 12.

According to the mist device 1 of the first embodiment of the present invention, the controller 26 controls the water supply valve to maintain the water level of the water stored in the tank 12 that is the water storage part in the appropriate range (steps S10 to S13 in FIG. 49). Therefore, the height of the water surface W of the tank 12 is always maintained in an appropriate range, and mist can be efficiently generated by the ultrasonic vibrator 18. Thereby, a large amount of mist can be generated and the mist can be supplied to the water section equipment, without using a large-scaled apparatus.

Further, according to the mist device 1 of the present embodiment, the controller 26 controls the water supply channel on-off valve 30 that is the water supply valve so that the introduced water flows out from the overflow portion 11c (columns C and E in FIG. 50). Therefore, the water level in the tank 12 can be accurately set to the overflow water level by the height of the overflow portion 11c, and the water surface W of the tank 12 can be reliably set to an appropriate value.

Furthermore, according to the mist device 1 of the present embodiment, the controller 26 keeps water flowing out from the overflow portion 11c for a predetermined period of time (steps S7 to S9 in FIG. 49) in a state where mist is generated, so that even in a state where mist is generated, the water level in the tank 12 can be maintained at the appropriate value.

Further, according to the mist device 1 of the present embodiment, the controller 26 allows water to flow out from the overflow portion 11c during the activation of the ultrasonic vibrator 18 (steps S7 and S8 in FIG. 49), so that at the start of mist supply, the water level in the tank 12 is set to the appropriate water level, and a large amount of mist can be supplied at the start of the supply.

Furthermore, according to the mist device 1 of the present embodiment, the controller 26 executes the overflow control to keep water flowing out from the overflow portion 11c (steps S7 to S9 in FIG. 49) for the predetermined period of time, and then executes the maintenance control to maintain the water level in the tank 12 in the predetermined range (steps S10 to S13 in FIG. 49). Therefore, the mist device 1 executes the overflow control in an initial stage of the operation of the mist device 1 to enable the generation of the large amount of mist, and then executes the maintenance control to suppress the generation of wasted water.

Further, according to the mist device 1 of the present embodiment, a decrease in water level is detected by the float switch 21 that is a water level sensor, and hence even when the float switch 21 is not sufficiently accurate, the water level in the tank 12 can be prevented from being excessively lowered. Furthermore, according to the mist device 1 of the present embodiment, the decrease in water level is detected, and then the water supply channel on-off valve 30 is opened for the predetermined time to raise the water level in the tank 12, so that a water level after replenishing water can be relatively accurately set. Specifically, a predetermined time for opening the water supply channel on-off valve 30 is set to a time until the water level in the tank 12 rises approximately to the overflow water level. Therefore, even if the accuracy of the float switch 21 is not sufficient, variation in water level after replenishing water can be sufficiently suppressed.

Furthermore, according to the mist device 1 of the present embodiment, the controller 26 is configured to set the preparation mode. Therefore, the water level in the tank 12 can be set to the overflow water level before the ultrasonic vibrator 18 is operated, and a sufficient amount of mist can be generated immediately after the activation of the mist device 1.

As described above, the preferable embodiments of the present invention have been described, and the above-described embodiments can be variously modified.

### REFERENCE SIGNS LIST

1 mist device (mist generation device)
2 mist system (bathtub apparatus)
3 bathroom
4 retaining space (mist retaining space)
5 room space
6 bathtub body
6a upper end portion
6d long side part
6e short side part
6f discharge pan
8 mist generation unit (mist generation device body)
8a ceiling surface
8b partition wall
8c damming portion
8d guide wall portion
8e intake passage
9 water supply part
9a water supply channel connecting portion
9b water supply chamber
9c communication passage
10 mist supply unit (mist discharge passage)
10a mist discharge port
11 discharge part
11a discharge passage connecting portion
11b discharge chamber
11c overflow portion
12 water storage part (tank)
12a water supply side part (concave portion)
12b mist generation side part
14 water supply channel
18 ultrasonic vibrator
20 heater
21 (29) float switch (water level sensor)
22 water temperature measuring instrument
24 room temperature measuring instrument
26 controller
28 operation unit
30 water supply channel on-off valve (water supply valve)
32 discharge passage on-off valve
40 mist supply flow rate decrease suppression part
42 wall part
102 wash place floor apparatus
104 retaining space
106 wash place floor body
202 shower room apparatus
203 shower room
204 retaining space
206 shower room body
302 washbasin apparatus
303 washroom
304 retaining space
306 washbasin body
402 kitchen sink apparatus
403 washroom
404 retaining space
406 kitchen sink body
B water
C retention layer
W wall
X hot water layer

1. A mist device for use in water section equipment, the mist device comprising:
a mist generation unit that generates mist from stored water, and
a mist supply unit that supplies the mist generated by the mist generation unit to a retaining part that forms a retaining space having an upper part opened,
the mist device being configured so that the mist supplied from the mist supply unit is retained in the retaining space, wherein the mist generation unit comprises a mist supply flow rate decrease suppression part that suppresses a decrease in amount of mist generated.

2. The mist device according to claim 1, wherein the mist generation unit comprises:
a water storage part that stores water, and
an ultrasonic vibrator that oscillates ultrasonic waves to the water in the water storage part, to generate mist, and
the mist generation unit further comprises a heater that functions as the mist supply flow rate decrease suppression part to suppress a drop in temperature of the water in the water storage part.

3. The mist device according to claim 2, wherein the mist generation unit comprises a wall part provided between a mist generation side part in which the ultrasonic vibrator is disposed in the water storage part and a water supply side part to which a water supply passage that supplies water into the water storage part is connected, the wall part being configured to communicate water between the mist generation side part and the water supply side part, the wall part functioning as the mist supply flow rate decrease suppression part, the wall part being formed so that rippling due to the water supplied to the water supply side part is less likely to be transmitted to the mist generation side part.

4. The mist device according to claim 3, wherein the wall part of the mist generation unit is provided at a position at which a volume of water in the mist generation side part is larger than a volume of water in the water supply side part, when the water level in the water storage part is at a water supply prescribed water level.

5. The mist device according to claim 3, wherein the heater of the mist generation unit is provided in at least the mist generation side part.

6. The mist device according to claim 5, wherein the heater of the mist generation unit extends from the mist generation side part to the water supply side part.

7. The mist device according to claim 5, wherein a plurality of ultrasonic vibrators are arranged, and the heater extends in an arrangement direction of the plurality of ultrasonic vibrators.

8. The mist device according to claim 1, wherein the mist generation unit comprises a wall part provided between a mist generation side part in which an ultrasonic vibrator is disposed in a water storage part and a water supply side part in which a water supply device that supplies water into the water storage part is disposed, the wall part being configured to communicate water between the mist generation side part and the water supply side part, the wall part functioning as the mist supply flow rate decrease suppression part, the wall part being formed so that rippling due to water supplied to the water supply side part is less likely to be transmitted to the mist generation side part.

9. A water section equipment comprising:
the mist device according to claim 1, and
the retaining part that forms the retaining space accepting mist supplied from the mist supply unit of the mist device.

10. The mist device according to claim 1, further comprising:
a water storage part provided in the mist generation unit, to store water to be misted,
a water supply valve that controls supply and stop of water to the water storage part,
an ultrasonic vibrator provided in the water storage part, the ultrasonic vibrator irradiating, with ultrasonic waves, a water surface of water stored in the water storage part, to generate mist, and
a controller that controls the water supply valve and the ultrasonic vibrator, wherein
the mist generation unit includes an overflow portion, the overflow portion further functions as the mist supply flow rate decrease suppression part, and the controller controls the water supply valve so that water introduced through the water supply valve flows out from the overflow portion, to thereby set a water level in the water storage part to an overflow water level.

11. The mist device according to claim 10, wherein the controller maintains the water level in the water storage part at the overflow water level for a predetermined period of time, by keeping water flowing out from the overflow portion for the predetermined period of time, in a state where the ultrasonic vibrator is operated to generate mist in the mist generation unit.

12. The mist device according to claim 10, wherein the controller opens the water supply valve, to control water to flow out from the overflow portion, at a time of activation of the ultrasonic vibrator, or before the activation of the ultrasonic vibrator.

13. The mist device according to claim 10, wherein the controller is configured to execute overflow control to keep water flowing out from the overflow portion, and maintenance control to maintain the water level in the water storage part in a predetermined range from the overflow water level to a water level less than the overflow level, and the controller executes the overflow control for a predetermined period of time in a state where the ultrasonic vibrator is operated, and then executes the maintenance control.

14. The mist device according to claim 13, further comprising:
a water level sensor that detects the water level in the water storage part, wherein in the maintenance control, the controller opens the water supply valve for a predetermined time, to raise the water level in the water storage part, when the water level sensor detects that the water level in the water storage part lowers to a predetermined water level.

15. The mist device according to claim 10, wherein the controller is configured to set a preparation mode, and when the preparation mode is set, the controller opens the water supply valve in a state where the ultrasonic vibrator is not operated, controls water to flow out from the overflow portion and sets the water level in the water storage part to the overflow water level.

16. A mist generation system comprising:
the mist device according to claim 10, and
water section equipment including a retaining space in which mist discharged from the mist device is retained.
